(19) United States
(12) Patent Application Publication
(10) Pub. No.: US 2026/0176518 A1
(43) Pub. Date: Jun. 25, 2026

(54) HEAT TRANSFER FLUID COMPOSITION FOR BATTERY IMMERSION COOLING

(71) Applicant: Solstice Advanced Materials US, Inc., Morris Plains, NJ (US)

(72) Inventors: Nitin Karwa, Buffalo, NY (US); Sugun Inampudi, Buffalo, NY (US); Nilesh Purohit, Buffalo, NY (US); Ankit Sethi, Buffalo, NY (US)

(21) Appl. No.: 19/413,637

(22) Filed: Dec. 9, 2025

Related U.S. Application Data
(60) Provisional application No. 63/736,598, filed on Dec. 19, 2024.
(60) Provisional application No. 63/886,985, filed on Sep. 24, 2025.

(51) Int. Cl. C09K 5/10

(52) U.S. Cl. CPC C09K 5/10; C09K 2205/126; C09K 2205/22

(57) ABSTRACT

Heat transfer compositions consisting essentially of effective amounts of cis-1-chloro-2,3,3-trifluoropropene (HFO-1233yd(Z)) and a base fluid, and applications thereof as at least a coolant fluid in electronic vehicle (EV) battery thermal management systems (BTMSs)

### CROSS-REFERENCE TO RELATED APPLICATIONS

This application claims priority to U.S. Patent Application No. 63/736,598 entitled “HEAT TRANSFER FLUID COMPOSITION FOR BATTERY IMMERSION COOLING” filed on Dec. 19, 2024, and U.S. Provisional Patent Application No. 63/886,985 entitled “HEAT TRANSFER FLUID COMPOSITION FOR BATTERY IMMERSION COOLING”, filed on Sep. 24, 2025, the entire disclosures of which are incorporated by reference in their entireties.

### FIELD

The present disclosure relates to heat transfer fluid compositions, and particularly, heat transfer fluid compositions used as coolant for electric vehicle batteries.

### BACKGROUND

Electric vehicles (EVs) rely on efficient battery thermal management systems (BTMSs) to ensure optimal performance, safety, and longevity of the battery packs. One critical component of a BTMS is maintaining optimal battery temperature, as batteries generate significant heat during charge and discharge cycles. Overheating can degrade battery life, reduce efficiency, and pose safety risks.

To address these issues, various coolant technologies have been developed for use in EV BTMSs. These coolants are designed to efficiently transfer heat away from the battery cells and maintain uniform temperature across the battery pack. However, present coolant technologies are limited, particularly regarding thermal runaway scenarios, such as those encountered during rapid charging. Additionally, the coolants often suffer from high kinematic viscosity at low operating temperatures, impacting the time and effectiveness of the BTMS. What is needed is a high-performance coolant fluid that can accommodate the high thermal energy and kinematic viscosity demands of modern electric vehicles.

### SUMMARY

The present disclosure provides for heat transfer compositions which may be used as coolant fluids in the context of electronic vehicle (EV) battery management systems (BTMSs). The heat transfer composition includes a base fluid such as a heat transfer oil, and cis-1-chloro-2,3,3-trifluoropropene (HFO-1233yd(Z)). The heat transfer composition including the cis-1-chloro-2,3,3-trifluoropropene (HFO-1233yd(Z)) may outperform other known coolant fluids, and particularly as applied to EV BTMSs.

In one form thereof, the present disclosure provides a heat transfer composition comprising from about 5 wt. % to about 20 wt. % of cis-1-chloro-2,3,3-trifluoropropene (HFO-1233yd(Z)) and from about 80 wt. % to about 95 wt. % of at least one base fluid, as based upon the total weight of the cis-1-chloro-2,3,3-trifluoropropene (HFO-1233yd(Z)) and the v base fluid.

In one form thereof, the present disclosure provides a method of transferring heat from an electric vehicle battery comprising: providing a heat transfer composition consisting essentially of from about 5 wt. % to about 20 wt. % of and of cis-1-chloro-2,3,3-trifluoropropene (HFO-1233yd(Z)) and from about 80 wt. % to about 95 wt. % of at least one base fluid, as based upon the total weight of the cis-1-chloro-2,3,3-trifluoropropene (HFO-1233yd(Z)) and the base fluid; immersing the battery in the heat transfer composition; and during operation, transferring heat between the immersed battery and the heat transfer composition.

### BRIEF DESCRIPTION OF THE DRAWINGS

FIG. 1 is a schematic representation of an exemplary battery cooling circuit of an exemplary heat transfer system useful in the context of managing the thermal energy release of an electronic vehicle battery.

FIG. 2 is a schematic representation of an alternative battery cooling circuit of an exemplary heat transfer system useful in the context of managing the thermal energy release of an electronic vehicle battery, further including a secondary loop.

FIG. 3 is a schematic representation of an exemplary heat transfer system including an exemplary vapor compression circuit and battery cooling circuit useful in the context of managing the thermal energy release of an electronic vehicle battery.

### DETAILED DESCRIPTION

### I. Definitions

“Electronic Device”, and related word forms, means a device, or a component of a device, which is in the process of performing its intended function by receiving, and/or transmitting and/or producing electrical energy and/or electronic signals. Thus, the term “operating electronic device” as used herein includes, for example, a battery which is in the process of providing a source of electrical energy to another component and also a battery which is being charged or recharged, for example.

The term “Heat Transfer Composition” and related word forms means a composition in the form of a fluid (liquid or gas) which is used to transfer heat or energy from one fluid, article or device to another fluid, article or device, and thus includes for example refrigerants, thermal management fluids and working fluids for Rankine cycles. The heat transfer composition may include each of a base fluid and a refringent, as well as any other various additives/additional components as desired.

When a heat transfer composition is used in thermal management to keep a device or article within a particular temperature range (e.g., in electronic cooling), it is sometimes referred herein as a thermal management fluid.

The component(s) that are present in a heat transfer composition for the purpose of transferring heat (as opposed to, for example, providing lubrication or stabilization) in a heat transfer system (e.g., a vapor compression heat transfer system), that component or combination of components are sometimes referred to herein as a refrigerant.

“Operating Electronic Device”, and related word forms, means a device, or a component of a device, which is in the process of performing its intended function by receiving, and/or transmitting and/or producing electrical energy and/or electronic signals. Thus, the term “operating electronic device” as used herein includes, for example, a battery which is in the process of providing a source of electrical energy to another component and also a battery which is being charged or recharged.

“Thermal Conductivity” refers to the thermal conductivity in W/mK, as measured in accordance with ASTM D7896-19.

“Non-flammable” in the context of heat transfer compositions, including refrigerants and thermal management compositions, means compounds or compositions which do not have a flash point below 100° F. (37.8° C.) in accordance with NFPA 30: Flammable and Combustible Liquid Code. The flash point of a fluid refers the lowest temperature at which vapors of the composition will keep burning after the ignition source is removed as determined in accordance with ASTM D3828-16a.

“Global Warming Potential (“GWP”)” was developed to allow comparisons of the global warming impact of different gases. It is a measure of how much energy the emission of one ton of a gas will absorb over a given period of time, relative to the emission of one ton of carbon dioxide. The larger GWP, the more that a given gas warms the Earth compared to CO₂ over that time period. The time period usually used for GWP is 100 years. GWP provides a common measure, which allows analysts to add up emission estimates of different gasses.

“Low-GWP” refers to the GWP threshold whereas regulatory agencies, such as the European Union (EU) consider the substance to have a low global warming impact. A GWP of less than 150 is generally considered to be “low GWP” for applications including refrigerants.

“PFAS” means a perfluoroalkyl and polyfluoroalkyl molecule that contains at least one of the following structures: (i) R—(CF₂)—CF(R′)R″, where both the CF₂ and CF moieties are saturated carbons; (ii) R—CF₂OCF₂—R′, where R and R′ can be F, 0, or saturated carbons; or (iii) CF₃(CF₃)RR′, where R and R′ can be either F or saturated carbons.

“Non-PFAS” or “PFAS-Free” means a composition containing not more than 0.5% by weight of PFAS compounds.

As used herein, the singular forms “a”, “an”, and “the” include plural references unless the context clearly dictates otherwise.

As used herein, the recitation of numerical ranges by endpoints includes all numbers subsumed within that range (e.g., 1 to 5 includes 1, 1.5, 2, 2.75, 3, 3.8, 4, and 5).

Unless otherwise indicated, all numbers expressing quantities or ingredients, measurement of properties and so forth used in the specification and embodiments are to be understood as being modified in all instances by the term “about.” Accordingly, unless indicated to the contrary, the numerical parameters set forth in the foregoing specification and attached listing of embodiments can vary depending upon the desired properties sought to be obtained by those skilled in the art utilizing the teachings of the present invention. At the very least, and not as an attempt to limit the application of the doctrine of equivalents to the scope of the claimed embodiments, each numerical parameter should at least be construed in light of the number of reported significant digits and by applying ordinary rounding techniques.

As used herein, the phrase “within any range encompassed by any two of the foregoing values as endpoints” literally means that any range may be selected from any two of the values listed prior to such phrase regardless of whether the values are in the lower part of the listing or in the higher part of the listing. For example, a pair of values may be selected from two lower values, two higher values, or a lower value and a higher value.

### II. Battery Thermal Management System (BTMSs)

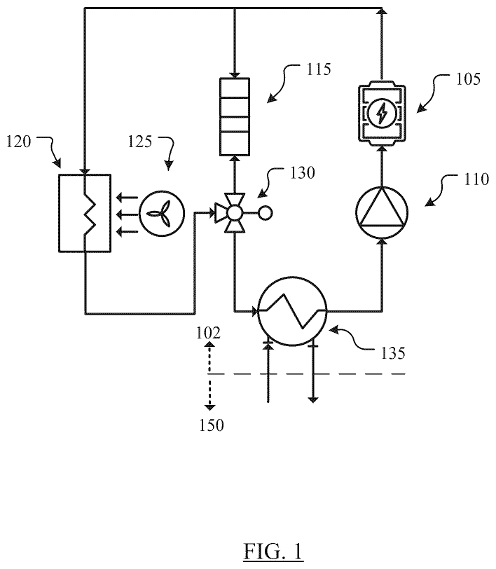

The present invention relates to heat transfer compositions useful as coolant fluids in the context of BTMSs, such as BTMS 100 as illustrated in FIG. 1. Here, BTMS 100 may be used in the context of automobiles, and particularly, operating electronic devices specific to electric vehicles (EVs), such as being designed to regulate the temperature of a battery pack of an automobile through cooling and/heating mechanisms, ensuring the battery remains functional, efficient, and safe under various operating conditions.

BTMS 100 may include both a battery coolant circuit 102 and a vapor compression circuit 150. However, in some cases, only a battery coolant circuit may be present (e.g., the present invention is not limited to the combined system only). Each of battery coolant circuit 102 and vapor compression circuit 150 can be operated in combination to both regulate the temperature of battery 105 as well as the ambient conditions of the interior space of the automobile, such as by providing heating or air conditioning to the interior space of the automobile.

As illustrated in FIG. 1, battery coolant circuit 102 includes include each of battery 105, battery coolant pump 110, battery coolant heater 115, external condenser/radiator 120, external condenser/radiator fan 125, 3-way valve 130, and battery coolant cooler/chiller 135. Here, a coolant, which may be a coolant fluid, is circulated through battery coolant circuit 102, and through each component associated therewith, to absorb and/or release heat that is generated by battery 105. Battery coolant pump 110 continuously circulates coolant throughout battery coolant circuit 102, such as through the battery compartment of battery 105. Here, the coolant contacts the cells of battery 105, which may be arranged in a pouch, cylindrical or prismatic orientation, absorbing the heat generated by battery 105 (or providing heat to battery 105 during low temperature conditions) enabling efficient, reliable, and safe operation of battery 105, as will be described in further detail herein. Depending on the BTMS 100's thermal demands, the coolant may be directed by three-way valve 130 to external condenser/radiator 120 which reduces the temperature of the coolant by convective heat transfer to the external environment (e.g., by external radiator/condenser fan 125 supplying air to the condenser). The coolant then flows through battery coolant chiller 135, which further reduces the temperature of the coolant. Alternatively, three-way valve 130 may direct flow of the coolant to electric heater 115, which may increase the temperature of the coolant, such as during low temperature conditions where the battery must be warmed, rather than cooled. In either the heating or cooling scenarios, battery coolant circuit 110 may cool and/or heat battery 105, to maintain a designated operational temperature/condition, ensuring the safe and efficient operation of battery 105.

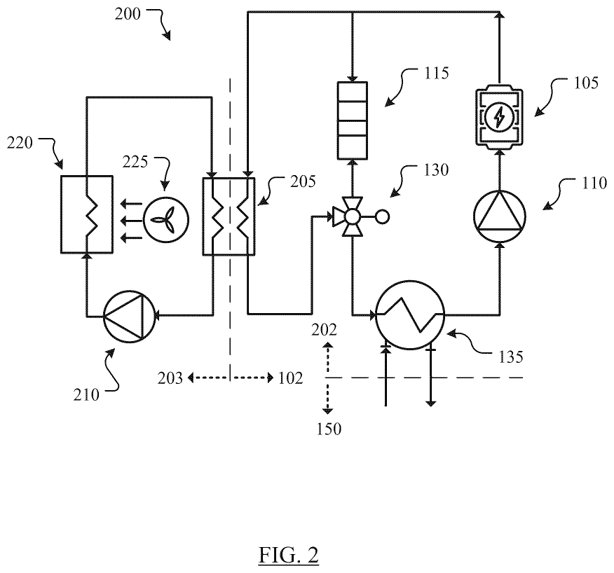

FIG. 2 illustrates an alternative arrangement of a BTMS 200. BTMS 200 includes a primary coolant circuit 202, which is substantially similar to coolant circuit 102 as illustrated and discussed in relation to FIG. 1, and BTMS 200 operates in a substantially similar fashion to BTMS 100, except that the primary coolant circuit 202 interacts with a secondary fluid circuit 203. fluid circuit 203 includes a secondary fluid pump 210 that circulates a secondary fluid through the secondary fluid circuit 203, such as through each of secondary fluid heat exchanger 205 and external condenser/radiator 220. The secondary fluid may be any suitable heat exchange fluid, such as propylene glycol, ethylene glycol, a mixture of water and propylene glycol, a mixture of water and ethylene glycol, etc.

External condenser/radiator 220 may be substantially similar to external condenser/radiator 120 as described in relation to FIG. 1, except that, rather than exchanging energy between the external environment and the coolant, a secondary fluid is used for convective and conductive heat exchange with the external environment. Here, the secondary fluid is heated or cooled via interaction with the coolant in secondary fluid heat exchanger 205 and expels thermal energy to the external environment via external condenser/radiator 220, for example by external radiator/condenser fan 225 supplying air to the condenser/radiator. In this way, secondary fluid heat exchanger 205 isolates coolant circuit 202 from secondary fluid circuit 203 while allowing heat exchange between the two fluids. Isolation of the battery coolant from the external environment may be preferred in EV battery applications since the radiator of the electric vehicle is often susceptible to physical damage or degradation, for example via contact with the external environment. If damage or failure occurs, the secondary fluid, rather than the primary battery coolant, will be affected, for example by leaking, spilling, or contaminating the primary battery coolant. This arrangement increases the overall safety of the BTMS, in that the battery will not lose contact with the coolant fluid if the radiator is damaged, helping to prevent thermal runaway scenarios and enhance, the overall safety of the BTMS.

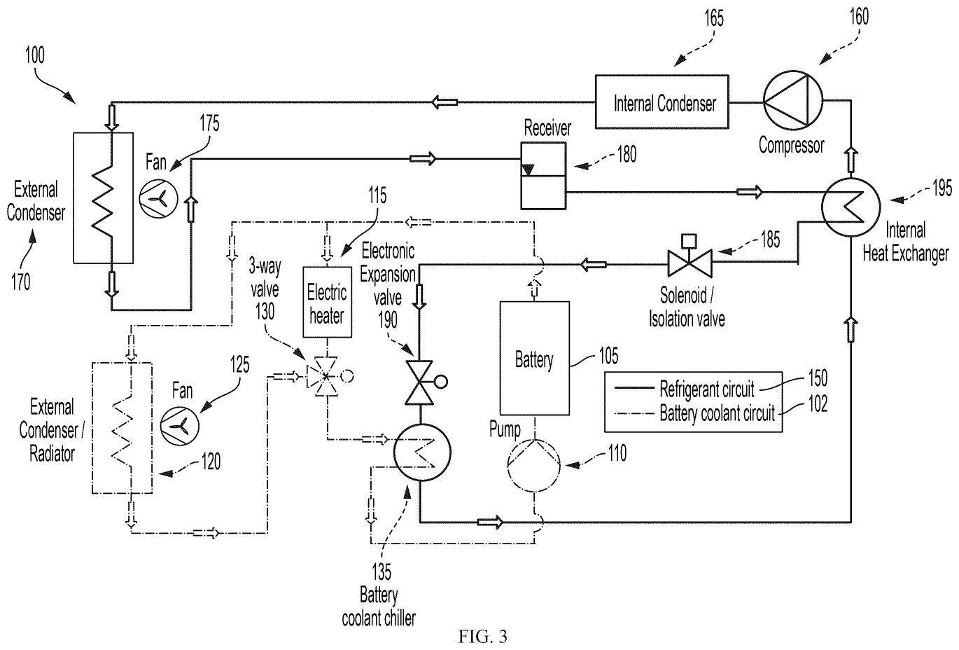

FIG. 3 illustrates a BTMS 300, which is substantially similar to BTMS 100, except that an exemplary arrangement of a vapor compression circuit 150 is illustrated. Here, vapor compression circuit 150 includes compressor 160, internal condenser 165, external condenser 170, external condenser fan 175, receiver 180, solenoid valve 185, electronic expansion valve 190, and internal heat exchanger 195. Here, a refrigerant, which may be selected from any suitable refrigerant used in automotive contexts (e.g., R-134a; R-1234yf; R-744; R-152a; R-290; HFO Blends; etc.) is circulated through vapor compression circuit 150 by compressor 160. Compressor 160 pressurizes the refrigerant to a high-pressure vapor, where compressed refrigerant flows to internal condenser 165. Internal condenser 165 acts as a space conditioning unit which heats or cools the interior space of the automobile. After passing through internal condenser 165, the refrigerant condenses to a high-pressure liquid or vapor-liquid mixture and flows to external condenser 170. External condenser fan 175 forces air over the surface of external condenser 170, providing convective cooling of the refrigerant, where liquid refrigerant then enters receiver 180, which stores the liquid refrigerant. Liquid refrigerant then flows to internal heat exchanger 195, which subcools the refrigerant before entering the electronic expansion valve 190. In some instances (such as when cooling of the battery 105 is not required), the solenoid valve 185 may isolate refrigerant flow from battery coolant chiller 135. Electronic expansion valve 190 reduces the pressure of the refrigerant, causing it to cool down and become a low-pressure, low-temperature liquid. The refrigerant then enters battery coolant chiller 135, providing additional cooling to the coolant as described with reference to battery coolant circuit 102. Refrigerant then flows through internal heat exchanger 195 again, cooling the refrigerant being supplied to electronic expansion valve 190 as described previously, and then reenters compressor 195.

BTMSs 100, 200, and/or 300 and particularly, battery coolant circuits 102/202 may be regarded as an immersion-type direct heat transfer method for thermally managing EV batteries. Direct immersion heat transfer thermal management is a marked improvement over existing thermal management technologies, such as indirect cooling methods including cold plate cooling, commonly used in EV contexts. Specifically, due to the direct contact of the coolant liquid with the battery 105, BTMSs 100/200 are able to absorb and remove a significantly higher amount of thermal energy during operation than indirect heat transfer methods. This allows for ultrafast battery charging rates, more reliable battery operation and life, and less instances of the EV battery catching fire (e.g., during charging, heavy operation, etc.).

However, the operational conditions of BTMSs 100/200 can be extreme. For instance, during initial startup of the EV, the system must operate between as low as −40° C. to as high as 50° C. (e.g., a temperature differential of up to 90° C.). Therefore, the coolant fluid selected for battery cooling circuit 102 must maintain high performance across a wide variety of operational conditions.

One important performance characteristic of a BTMS coolant is flowability. Flowability regards the ability for the coolant to maintain a flowable viscosity under various conditions. Many existing coolants, such as base fluids including synthetic oils (e.g., class IV and V oils) and/or mineral oils (e.g., paraffinic and naphthenic oils) have acceptable working viscosities at 20° C. but become 50-100 times more viscous at −30° C. or lower. High viscosity at low ambient conditions poses many drawbacks to the EVs. Specifically, high viscosity coolants require significantly more pumping power to circulate the coolant, resulting in a higher energy demand of the pumping system. The pumping system is powered by the EV battery itself, and therefore, the range of the EV as well as the overall battery life is decreased due to the increased energy demand. Furthermore, high viscosity coolant fluids do not maintain thermal performance at high viscosity, lowering the overall heat transfer effectiveness under such conditions, again, detrimentally effecting the EVs efficiency.

Another important performance characteristic of a BTMS is safety. A known issue with EV batteries is the concept of thermal runaway. Thermal runaway occurs when a battery cell overheats, causing a thermochemical chain reaction, where neighboring cells also overheat due to the overheating initial cell. Multiple overheating cells can eventually lead to an explosion and fire, posing a significant safety concern for EVs. Thermal runaway can be triggered by a variety of conditions, including physical damage and/or high operating temperatures, such as those encountered during rapid charging scenarios.

Direct contact immersion cooling significantly lowers the chances of thermal runaway in EV batteries. Direct-contact immersion cooling submerges the individual battery cells in the coolant, which directly absorbs heat from the individual cells. This method mitigates the runaway risk since the neighboring cells are protected from the heat generated by the failing cell by immersion in the coolant fluid.

Importantly, a failing cell generates a significant amount of heat, which can result in surface temperatures of the battery cells as high as 100° C. Therefore, in addition to the foregoing performance characteristics (e.g., heat transfer rate, low viscosity, etc.), in order to avoid thermal runaway scenarios, the battery coolant fluids must also maintain stability at temperatures as high as 100° C. A known problem with existing coolant fluids, such as THERMINOL® LT (e.g., a hydrocarbon-based coolant fluid) is a relatively low flash point, such as in the 50° C. to 60° C. range. A flash point lower than the 100° C. thermal runaway scenario results in the coolant fluid vaporizing, drastically increasing the pressure of the battery housing and leading to eventual failure.

Even if not encountering a runaway condition, the vapor pressure of the coolant fluid is still an important consideration regarding battery safety/design. Specifically, and as described previously, the maximum normal operational conditions of the BTMS is approximately 50° C. Therefore, the coolant fluid should have a relatively low vapor pressure, such that when high operational conditions are encountered, the fluid does not vaporize. Vaporizing coolant fluid, particularly in the context of direct cooling methods, increases the pressure of the battery compartment housing, which can lead to eventual swelling and/or failure of the battery. One way to combat this issue is to design the battery compartment to accommodate the increased pressure, such as by increasing the strength of the battery housing through increased thickness or stronger metallurgies. The former, however, increases the weight associated with the battery which again lowers the EVs efficiency (e.g., heaver battery results in increased vehicle weight, resulting in lower range/efficiency). The latter may be prohibitively expensive, as strong/light alloys (e.g., titanium) are significantly more expensive than commonly used materials (e.g., steel).

The present invention relates to heat transfer fluid compositions which can be used as a coolant fluid in the contexts of EV BTMSs (e.g., as described with reference to BTMSs 100, 200, and/or 300 in FIGS. 1-32, and particular battery coolant circuits 102/202), which outperform known coolant fluids in, particularly, immersion-type direct heat transfer systems (e.g., BTMSs 100, 200, and 300).

### III. Heat Transfer Fluid Compositions

The heat transfer composition of the present disclosure comprises a refrigerant and a base fluid. The heat transfer composition may optionally further comprise one or more additional components (e.g., additives). However, the additional components do not exceed 5 wt. % of the heat transfer composition.

The heat transfer composition comprises a refrigerant, such as cis-1-chloro-2,3,3-trifluoropropene (HFO-1233yd(Z)). It is to be understood that any refence herein to cis-1-chloro-2,3,3-trifluoropropene (HFO-1233yd(Z)) as a component of the heat transfer composition is meant to include a predominant amount to of cis-1-chloro-2,3,3-trifluoropropene (HFO-1233yd(Z)) and a impurity amount of trans-1-chloro-2,3,3-trifluoropropene (HFO-1233yd(E)). For instance, reference to cis-1-chloro-2,3,3-trifluoropropene (HFO-1233yd(Z)) may include from about 90.0 wt. % to about 99.0 wt. % cis-1-chloro-2,3,3-trifluoropropene (HFO-1233yd(Z)), and correspondingly, from about 10.0 wt. % to about 1.0 wt. % trans-1-chloro-2,3,3-trifluoropropene (HFO-1233yd(E)) as based upon the total weight of both the cis-1-chloro-2,3,3-trifluoropropene (HFO-1233yd(Z)) and the trans-1-chloro-2,3,3-trifluoropropene (HFO-1233yd(E)). The cis-1-chloro-2,3,3-trifluoropropene (HFO-1233yd(Z)) of the heat transfer composition may be present in an amount as little as about 1 wt. %, 3 wt. %, 5 wt. %, or 7.5 wt. %, to as much as about 10 wt. %, 12.5 wt. %, 15 wt. %, 17.5 wt. %, 20 wt. %, or 25 wt. %, or between any of the two forging values used as endpoints, such as from about 1 wt. % to about 25 wt. %, or about 5 wt. % to about 20 wt. %, or about 7.5 to 12.5 wt. %, or about 10 wt. %, as based upon the total weight of the refrigerant and base fluid of the heat transfer composition.

The heat transfer composition further comprises a base fluid. Suitable base fluids may be heat transfer oils. The heat transfer oils may be selected from any suitable oil possessing electrically insulative, thermally conductive, fluid mechanical, and/or moisture preventive properties, such as any one of, or combination of, mineral oils, synthetic oils in including polyalkylene glycol (PAG), vegetable oils, aromatic hydrocarbons such as alkylbenzenes, alkyldiphenylethanes, alkylnaphthalenes, methylpolyarylmethanes (and combination of the foregoing), poly(α-)olefin oils, polyol esters oil, paraffinic oils silicon-based oils, naphthenic oils, isoparaffinic oils, and cycloparaffinic oils. Specific examples of polyolefins (i.e., PAOs) include Spectra Syn PAO2, a low-viscosity polyalphaolefin (PAO) synthetic fluid manufactured by Exxon, and AC-110, a synthetic PAO oil manufactured by Ampcool. Specific examples of synthetic esters include Polyvinyl esters (PVEs) and/or Polyol esters (POEs), such as RPOE14-15, a synthetic polyol ester manufactured by BVA. Examples of paraffinic oils include GTL E5 TM410, manufactured by Shell. Examples of suitable naphthenic oils include naphthenic transformer oils and other refined naphthenic hydrocarbon oils. Examples of suitable isoparaffinic oils include refined isoparaffinic hydrocarbon fluids. Examples of suitable cycloparaffinic oils include hydrogenated cycloparaffinic hydrocarbon fluids derived from cycloalkane feedstocks. Examples of blended compositions comprising any combination of PAO, POE, PVE, and/or paraffinic synthetic fluids are EVOGEN TM1070, EVOGEN TM1100, and EVOGEN TM1150 manufactured by Lubrizol.

The base fluid of the heat transfer composition is present in an amount as low as about 75 wt., 80 wt. %, 85 wt. %, or 87.5 wt. %, to as much as about 90 wt. %, 92.5 wt. %, 95 wt. %, 97 wt. %, or 99 wt. %, such as between about 75 wt. % and about 99 wt. %, about 80 wt. % and 95 wt. %, about 87.5 wt. % to about 92.5 wt. %, or about 90 wt. %, to 12.5 wt. %, or about 10 wt. %, as based upon the total weight of the refrigerant and base fluid of the heat transfer composition.

Table 1 below defines preferred heat transfer compositions contemplated by the present disclosure, which either comprise, consist essentially of, or consist of the refrigerant cis-1-chloro-2,3,3-trifluoropropene (HFO-1233yd(Z)) as well as a selection of the base fluids, such as those described previously, and at particular weight percent ranges.

The first column of Table 1 below indicates the heat transfer composition number (e.g., A1 through A20 (A1-20); B1 through B20 (B1-20); C1 through C20; and D1 through D20 (D1-20)). In the second column, the abbreviations COMP, CEO and CO are used to identify the nature of the elements of the components of the heat transfer composition. In particular, the designation COMP in the second column indicates that the heat transfer composition comprises the base fluid in the third column and at the weight percent range of the fifth column, as well as the refrigerant in the fourth column and at the weight percent range in the sixth column. The designation CEO in the second column indicates that the heat transfer composition consists essentially of the base fluid in the third column and at the weight percent range of the fifth column, as well as the refrigerant in the fourth column and at the weight percent range in the sixth column. Finally, designation CO in the second column indicates that the heat transfer composition consists of the base fluid in the third column and at the weight percent range of the fifth column, as well as the refrigerant in the fourth column and at the weight percent range in the sixth column. It is intended that in the following table each value for weight percent is understood to be preceded by the term “about.”

TABLE 1
Heat Transfer Compositions
Heat Transfer Fluid Compositions
A1-A20: Poly(α-)olefin (PAO) and cis-1-chloro-2,3,3-trifluoropropene (HFO-1233yd(Z))

| | | | | Wt. % range | |
|---|---|---|---|---|---|
| Heat Transfer | Heat Transfer | | | Poly (α-) olefin | Wt. % range |
| Composition | Composition Nature | Base Fluid | Refrigerant | (PAO) | (HFO-1233yd(Z)) |
| A1 | COMP | Poly(α-)olefin | cis-1-chloro- | 99.0 to 75.0 | 25.0 to 1.0 |
| | | (PAO) | 2,3,3- | | |
| | | | trifluoropropene | | |
| | | | (HFO-1233yd(Z)) | | |
| A2 | COMP | Poly(α-)olefin | cis-1-chloro- | 97.0 to 75.0 | 25.0 to 3.0 |
| | | (PAO) | 2,3,3- | | |
| | | | trifluoropropene | | |
| | | | (HFO-1233yd(Z)) | | |
| A3 | COMP | Poly(α-)olefin | cis-1-chloro- | 95.0 to 75.0 | 25.0 to 5.0 |
| | | (PAO) | 2,3,3- | | |
| | | | trifluoropropene | | |
| | | | (HFO-1233yd(Z)) | | |
| A4 | COMP | Poly(α-)olefin | cis-1-chloro- | 92.5 to 75.0 | 25.0 to 7.5 |
| | | (PAO) | 2,3,3- | | |
| | | | trifluoropropene | | |
| | | | (HFO-1233yd(Z)) | | |
| A5 | COMP | Poly(α-)olefin | cis-1-chloro- | 90.0 to 75.0 | 25.0 to 10.0 |
| | | (PAO) | 2,3,3- | | |
| | | | trifluoropropene | | |
| | | | (HFO-1233yd(Z)) | | |
| A6 | COMP | Poly(α-)olefin | cis-1-chloro- | 87.5 to 75.0 | 25.0 to 12.5 |
| | | (PAO) | 2,3,3- | | |
| | | | trifluoropropene | | |
| | | | (HFO-1233yd(Z)) | | |
| A7 | COMP | Poly(α-)olefin | cis-1-chloro- | 85.0 to 75.0 | 25.0 to 15.0 |
| | | (PAO) | 2,3,3- | | |
| | | | trifluoropropene | | |
| | | | (HFO-1233yd(Z)) | | |
| A8 | COMP | Poly(α-)olefin | cis-1-chloro- | 82.5 to 75.0 | 25.0 to 17.5 |
| | | (PAO) | 2,3,3- | | |
| | | | trifluoropropene | | |
| | | | (HFO-1233yd(Z)) | | |
| A9 | COMP | Poly(α-)olefin | cis-1-chloro- | 80.0 to 75.0 | 25.0 to 20.0 |
| | | (PAO) | 2,3,3- | | |
| | | | trifluoropropene | | |
| | | | (HFO-1233yd(Z)) | | |
| A10 | COMP | Poly(α-)olefin | cis-1-chloro- | 77.5 to 75.0 | 25.0 to 22.5 |
| | | (PAO) | 2,3,3- | | |
| | | | trifluoropropene | | |
| | | | (HFO-1233yd(Z)) | | |
| A11 | COMP | Poly(α-)olefin | cis-1-chloro- | 75.0 | 25.0 |
| | | (PAO) | 2,3,3- | | |
| | | | trifluoropropene | | |
| | | | (HFO-1233yd(Z)) | | |
| A12 | COMP | Poly(α-)olefin | cis-1-chloro- | 99.0 to 97.0 | 3.0 to 1.0 |
| | | (PAO) | 2,3,3- | | |
| | | | trifluoropropene | | |
| | | | (HFO-1233yd(Z)) | | |
| A13 | COMP | Poly(α-)olefin | cis-1-chloro- | 99.0 to 95.0 | 5.0 to 1.0 |
| | | (PAO) | 2,3,3- | | |
| | | | trifluoropropene | | |
| | | | (HFO-1233yd(Z)) | | |
| A14 | COMP | Poly(α-)olefin | cis-1-chloro- | 99.0 to 92.5 | 7.5 to 1.0 |
| | | (PAO) | 2,3,3- | | |
| | | | trifluoropropene | | |
| | | | (HFO-1233yd(Z)) | | |
| A15 | COMP | Poly(α-)olefin | cis-1-chloro- | 99.0 to 90.0 | 10.0 to 1.0 |
| | | (PAO) | 2,3,3- | | |
| | | | trifluoropropene | | |
| | | | (HFO-1233yd(Z)) | | |
| A16 | COMP | Poly(α-)olefin | cis-1-chloro- | 99.0 to 87.5 | 12.5 to 1.0 |
| | | (PAO) | 2,3,3- | | |
| | | | trifluoropropene | | |
| | | | (HFO-1233yd(Z)) | | |
| A17 | COMP | Poly(α-)olefin | cis-1-chloro- | 99.0 to 85.0 | 15.0 to 1.0 |
| | | (PAO) | 2,3,3- | | |
| | | | trifluoropropene | | |
| | | | (HFO-1233yd(Z)) | | |
| A18 | COMP | Poly(α-)olefin | cis-1-chloro- | 99.0 to 82.5 | 17.5 to 1.0 |
| | | (PAO) | 2,3,3- | | |
| | | | trifluoropropene | | |
| | | | (HFO-1233yd(Z)) | | |
| A19 | COMP | Poly(α-)olefin | cis-1-chloro- | 99.0 to 80.0 | 20.0 to 1.0 |
| | | (PAO) | 2,3,3- | | |
| | | | trifluoropropene | | |
| | | | (HFO-1233yd(Z)) | | |
| A20 | COMP | Poly(α-)olefin | cis-1-chloro- | 99.0 to 77.5 | 22.5 to 1.0 |
| | | (PAO) | 2,3,3- | | |
| | | | trifluoropropene | | |
| | | | (HFO-1233yd(Z)) | | |
| A1 | CEO | Poly(α-)olefin | cis-1-chloro- | 99.0 to 75.0 | 25.0 to 1.0 |
| | | (PAO) | 2,3,3- | | |
| | | | trifluoropropene | | |
| | | | (HFO-1233yd(Z)) | | |
| A2 | CEO | Poly(α-)olefin | cis-1-chloro- | 97.0 to 75.0 | 25.0 to 3.0 |
| | | (PAO) | 2,3,3- | | |
| | | | trifluoropropene | | |
| | | | (HFO-1233yd(Z)) | | |
| A3 | CEO | Poly(α-)olefin | cis-1-chloro- | 95.0 to 75.0 | 25.0 to 5.0 |
| | | (PAO) | 2,3,3- | | |
| | | | trifluoropropene | | |
| | | | (HFO-1233yd(Z)) | | |
| A4 | CEO | Poly(α-)olefin | cis-1-chloro- | 92.5 to 75.0 | 25.0 to 7.5 |
| | | (PAO) | 2,3,3- | | |
| | | | trifluoropropene | | |
| | | | (HFO-1233yd(Z)) | | |
| A5 | CEO | Poly(α-)olefin | cis-1-chloro- | 90.0 to 75.0 | 25.0 to 10.0 |
| | | (PAO) | 2,3,3- | | |
| | | | trifluoropropene | | |
| | | | (HFO-1233yd(Z)) | | |
| A6 | CEO | Poly(α-)olefin | cis-1-chloro- | 87.5 to 75.0 | 25.0 to 12.5 |
| | | (PAO) | 2,3,3- | | |
| | | | trifluoropropene | | |
| | | | (HFO-1233yd(Z)) | | |
| A7 | CEO | Poly(α-)olefin | cis-1-chloro- | 85.0 to 75.0 | 25.0 to 15.0 |
| | | (PAO) | 2,3,3- | | |
| | | | trifluoropropene | | |
| | | | (HFO-1233yd(Z)) | | |
| A8 | CEO | Poly(α-)olefin | cis-1-chloro- | 82.5 to 75.0 | 25.0 to 17.5 |
| | | (PAO) | 2,3,3- | | |
| | | | trifluoropropene | | |
| | | | (HFO-1233yd(Z)) | | |
| A9 | CEO | Poly(α-)olefin | cis-1-chloro- | 80.0 to 75.0 | 25.0 to 20.0 |
| | | (PAO) | 2,3,3- | | |
| | | | trifluoropropene | | |
| | | | (HFO-1233yd(Z)) | | |
| A10 | CEO | Poly(α-)olefin | cis-1-chloro- | 77.5 to 75.0 | 25.0 to 22.5 |
| | | (PAO) | 2,3,3- | | |
| | | | trifluoropropene | | |
| | | | (HFO-1233yd(Z)) | | |
| A11 | CEO | Poly(α-)olefin | cis-1-chloro- | 75.0 | 25.0 |
| | | (PAO) | 2,3,3- | | |
| | | | trifluoropropene | | |
| | | | (HFO-1233yd(Z)) | | |
| A12 | CEO | Poly(α-)olefin | cis-1-chloro- | 99.0 to 97.0 | 3.0 to 1.0 |
| | | (PAO) | 2,3,3- | | |
| | | | trifluoropropene | | |
| | | | (HFO-1233yd(Z)) | | |
| A13 | CEO | Poly(α-)olefin | cis-1-chloro- | 99.0 to 95.0 | 5.0 to 1.0 |
| | | (PAO) | 2,3,3- | | |
| | | | trifluoropropene | | |
| | | | (HFO-1233yd(Z)) | | |
| A14 | CEO | Poly(α-)olefin | cis-1-chloro- | 99.0 to 92.5 | 7.5 to 1.0 |
| | | (PAO) | 2,3,3- | | |
| | | | trifluoropropene | | |
| | | | (HFO-1233yd(Z)) | | |
| A15 | CEO | Poly(α-)olefin | cis-1-chloro- | 99.0 to 90.0 | 10.0 to 1.0 |
| | | (PAO) | 2,3,3- | | |
| | | | trifluoropropene | | |
| | | | (HFO-1233yd(Z)) | | |
| A16 | CEO | Poly(α-)olefin | cis-1-chloro- | 99.0 to 87.5 | 12.5 to 1.0 |
| | | (PAO) | 2,3,3- | | |
| | | | trifluoropropene | | |
| | | | (HFO-1233yd(Z)) | | |
| A17 | CEO | Poly(α-)olefin | cis-1-chloro- | 99.0 to 85.0 | 15.0 to 1.0 |
| | | (PAO) | 2,3,3- | | |
| | | | trifluoropropene | | |
| | | | (HFO-1233yd(Z)) | | |
| A18 | CEO | Poly(α-)olefin | cis-1-chloro- | 99.0 to 82.5 | 17.5 to 1.0 |
| | | (PAO) | 2,3,3- | | |
| | | | trifluoropropene | | |
| | | | (HFO-1233yd(Z)) | | |
| A19 | CEC | Poly(α-)olefin | cis-1-chloro- | 99.0 to 80.0 | 20.0 to 1.0 |
| | | (PAO) | 2,3,3- | | |
| | | | trifluoropropene | | |
| | | | (HFO-1233yd(Z)) | | |
| A20 | CEO | Poly(α-)olefin | cis-1-chloro- | 99.0 to 77.5 | 22.5 to 1.0 |
| | | (PAO) | 2,3,3- | | |
| | | | trifluoropropene | | |
| | | | (HFO-1233yd(Z)) | | |
| A1 | CO | Poly(α-)olefin | cis-1-chloro- | 99.0 to 75.0 | 25.0 to 1.0 |
| | | (PAO) | 2,3,3- | | |
| | | | trifluoropropene | | |
| | | | (HFO-1233yd(Z)) | | |
| A2 | CO | Poly(α-)olefin | cis-1-chloro- | 97.0 to 75.0 | 25.0 to 3.0 |
| | | (PAO) | 2,3,3- | | |
| | | | trifluoropropene | | |
| | | | (HFO-1233yd(Z)) | | |
| A3 | CO | Poly(α-)olefin | cis-1-chloro- | 95.0 to 75.0 | 25.0 to 5.0 |
| | | (PAO) | 2,3,3- | | |
| | | | trifluoropropene | | |
| | | | (HFO-1233yd(Z)) | | |
| A4 | CO | Poly(α-)olefin | cis-1-chloro- | 92.5 to 75.0 | 25.0 to 7.5 |
| | | (PAO) | 2,3,3- | | |
| | | | trifluoropropene | | |
| | | | (HFO-1233yd(Z)) | | |
| A5 | CO | Poly(α-)olefin | cis-1-chloro- | 90.0 to 75.0 | 25.0 to 10.0 |
| | | (PAO) | 2,3,3- | | |
| | | | trifluoropropene | | |
| | | | (HFO-1233yd(Z)) | | |
| A6 | CO | Poly(α-)olefin | cis-1-chloro- | 87.5 to 75.0 | 25.0 to 12.5 |
| | | (PAO) | 2,3,3- | | |
| | | | trifluoropropene | | |
| | | | (HFO-1233yd(Z)) | | |
| A7 | CO | Poly(α-)olefin | cis-1-chloro- | 85.0 to 75.0 | 25.0 to 15.0 |
| | | (PAO) | 2,3,3- | | |
| | | | trifluoropropene | | |
| | | | (HFO-1233yd(Z)) | | |
| A8 | CO | Poly(α-)olefin | cis-1-chloro- | 82.5 to 75.0 | 25.0 to 17.5 |
| | | (PAO) | 2,3,3- | | |
| | | | trifluoropropene | | |
| | | | (HFO-1233yd(Z)) | | |
| A9 | CO | Poly(α-)olefin | cis-1-chloro- | 80.0 to 75.0 | 25.0 to 20.0 |
| | | (PAO) | 2,3,3- | | |
| | | | trifluoropropene | | |
| | | | (HFO-1233yd(Z)) | | |
| A10 | CO | Poly(α-)olefin | cis-1-chloro- | 77.5 to 75.0 | 25.0 to 22.5 |
| | | (PAO) | 2,3,3- | | |
| | | | trifluoropropene | | |
| | | | (HFO-1233yd(Z)) | | |
| A11 | CO | Poly(α-)olefin | cis-1-chloro- | 75.0 | 25.0 |
| | | (PAO) | 2,3,3- | | |
| | | | trifluoropropene | | |
| | | | (HFO-1233yd(Z)) | | |
| A12 | CO | Poly(α-)olefin | cis-1-chloro- | 99.0 to 97.0 | 3.0 to 1.0 |
| | | (PAO) | 2,3,3- | | |
| | | | trifluoropropene | | |
| | | | (HFO-1233yd(Z)) | | |
| A13 | CO | Poly(α-)olefin | cis-1-chloro- | 99.0 to 95.0 | 5.0 to 1.0 |
| | | (PAO) | 2,3,3- | | |
| | | | trifluoropropene | | |
| | | | (HFO-1233yd(Z)) | | |
| A14 | CO | Poly(α-)olefin | cis-1-chloro- | 99.0 to 92.5 | 7.5 to 1.0 |
| | | (PAO) | 2,3,3- | | |
| | | | trifluoropropene | | |
| | | | (HFO-1233yd(Z)) | | |
| A15 | CO | Poly(α-)olefin | cis-1-chloro- | 99.0 to 90.0 | 10.0 to 1.0 |
| | | (PAO) | 2,3,3- | | |
| | | | trifluoropropene | | |
| | | | (HFO-1233yd(Z)) | | |
| A16 | CO | Poly(α-)olefin | cis-1-chloro- | 99.0 to 87.5 | 12.5 to 1.0 |
| | | (PAO) | 2,3,3- | | |
| | | | trifluoropropene | | |
| | | | (HFO-1233yd(Z)) | | |
| A17 | CO | Poly(α-)olefin | cis-1-chloro- | 99.0 to 85.0 | 15.0 to 1.0 |
| | | (PAO) | 2,3,3- | | |
| | | | trifluoropropene | | |
| | | | (HFO-1233yd(Z)) | | |
| A18 | CO | Poly(α-)olefin | cis-1-chloro- | 99.0 to 82.5 | 17.5 to 1.0 |
| | | (PAO) | 2,3,3- | | |
| | | | trifluoropropene | | |
| | | | (HFO-1233yd(Z)) | | |
| A19 | CO | Poly(α-)olefin | cis-1-chloro- | 99.0 to 80.0 | 20.0 to 1.0 |
| | | (PAO) | 2,3,3- | | |
| | | | trifluoropropene | | |
| | | | (HFO-1233yd(Z)) | | |
| A20 | CO | Poly(α-)olefin | cis-1-chloro- | 99.0 to 77.5 | 22.5 to 1.0 |
| | | (PAO) | 2,3,3- | | |
| | | | trifluoropropene | | |
| | | | (HFO-1233yd(Z)) | | |

B1-B20: Paraffinic Oil and cis-1-chloro-2,3,3-trifluoropropene (HFO-1233yd(Z))

| Heat Transfer | Heat Transfer | | | Wt. % range | Wt. % range |
|---|---|---|---|---|---|
| Composition | Composition Nature | Base Fluid | Refrigerant | Paraffinic Oil | (HFO-1233yd(Z)) |
| B1 | COMP | Paraffinic Oil | cis-1-chloro- | 99.0 to 75.0 | 25.0 to 1.0 |
| | | | 2,3,3- | | |
| | | | trifluoropropene | | |
| | | | (HFO-1233yd(Z)) | | |
| B2 | COMP | Paraffinic Oil | cis-1-chloro- | 97.0 to 75.0 | 25.0 to 3.0 |
| | | | 2,3,3- | | |
| | | | trifluoropropene | | |
| | | | (HFO-1233yd(Z)) | | |
| B3 | COMP | Paraffinic Oil | cis-1-chloro- | 95.0 to 75.0 | 25.0 to 5.0 |
| | | | 2,3,3- | | |
| | | | trifluoropropene | | |
| | | | (HFO-1233yd(Z)) | | |
| B4 | COMP | Paraffinic Oil | cis-1-chloro- | 92.5 to 75.0 | 25.0 to 7.5 |
| | | | 2,3,3- | | |
| | | | trifluoropropene | | |
| | | | (HFO-1233yd(Z)) | | |
| B5 | COMP | Paraffinic Oil | cis-1-chloro- | 90.0 to 75.0 | 25.0 to 10.0 |
| | | | 2,3,3- | | |
| | | | trifluoropropene | | |
| | | | (HFO-1233yd(Z)) | | |
| B6 | COMP | Paraffinic Oil | cis-1-chloro- | 87.5 to 75.0 | 25.0 to 12.5 |
| | | | 2,3,3- | | |
| | | | trifluoropropene | | |
| | | | (HFO-1233yd(Z)) | | |
| B7 | COMP | Paraffinic Oil | cis-1-chloro- | 85.0 to 75.0 | 25.0 to 15.0 |
| | | | 2,3,3- | | |
| | | | trifluoropropene | | |
| | | | (HFO-1233yd(Z)) | | |
| B8 | COMP | Paraffinic Oil | cis-1-chloro- | 82.5 to 75.0 | 25.0 to 17.5 |
| | | | 2,3,3- | | |
| | | | trifluoropropene | | |
| | | | (HFO-1233yd(Z)) | | |
| B9 | COMP | Paraffinic Oil | cis-1-chloro- | 80.0 to 75.0 | 25.0 to 20.0 |
| | | | 2,3,3- | | |
| | | | trifluoropropene | | |
| | | | (HFO-1233yd(Z)) | | |
| B10 | COMP | Paraffinic Oil | cis-1-chloro- | 77.5 to 75.0 | 25.0 to 22.5 |
| | | | 2,3,3- | | |
| | | | trifluoropropene | | |
| | | | (HFO-1233yd(Z)) | | |
| B11 | COMP | Paraffinic Oil | cis-1-chloro- | 75.0 | 25.0 |
| | | | 2,3,3- | | |
| | | | trifluoropropene | | |
| | | | (HFO-1233yd(Z)) | | |
| B12 | COMP | Paraffinic Oil | cis-1-chloro- | 99.0 to 97.0 | 3.0 to 1.0 |
| | | | 2,3,3- | | |
| | | | trifluoropropene | | |
| | | | (HFO-1233yd(Z)) | | |
| B13 | COMP | Paraffinic Oil | cis-1-chloro- | 99.0 to 95.0 | 5.0 to 1.0 |
| | | | 2,3,3- | | |
| | | | trifluoropropene | | |
| | | | (HFO-1233yd(Z)) | | |
| B14 | COMP | Paraffinic Oil | cis-1-chloro- | 99.0 to 92.5 | 7.5 to 1.0 |
| | | | 2,3,3- | | |
| | | | trifluoropropene | | |
| | | | (HFO-1233yd(Z)) | | |
| B15 | COMP | Paraffinic Oil | cis-1-chloro- | 99.0 to 90.0 | 10.0 to 1.0 |
| | | | 2,3,3- | | |
| | | | trifluoropropene | | |
| | | | (HFO-1233yd(Z)) | | |
| B16 | COMP | Paraffinic Oil | cis-1-chloro- | 99.0 to 87.5 | 12.5 to 1.0 |
| | | | 2,3,3- | | |
| | | | trifluoropropene | | |
| | | | (HFO-1233yd(Z)) | | |
| B17 | COMP | Paraffinic Oil | cis-1-chloro- | 99.0 to 85.0 | 15.0 to 1.0 |
| | | | 2,3,3- | | |
| | | | trifluoropropene | | |
| | | | (HFO-1233yd(Z)) | | |
| B18 | COMP | Paraffinic Oil | cis-1-chloro- | 99.0 to 82.5 | 17.5 to 1.0 |
| | | | 2,3,3- | | |
| | | | trifluoropropene | | |
| | | | (HFO-1233yd(Z)) | | |
| B19 | COMP | Paraffinic Oil | cis-1-chloro- | 99.0 to 80.0 | 20.0 to 1.0 |
| | | | 2,3,3- | | |
| | | | trifluoropropene | | |
| | | | (HFO-1233yd(Z)) | | |
| B20 | COMP | Paraffinic Oil | cis-1-chloro- | 99.0 to 77.5 | 22.5 to 1.0 |
| | | | 2,3,3- | | |
| | | | trifluoropropene | | |
| | | | (HFO-1233yd(Z)) | | |
| B1 | CEO | Paraffinic Oil | cis-1-chloro- | 99.0 to 75.0 | 25.0 to 1.0 |
| | | | 2,3,3- | | |
| | | | trifluoropropene | | |
| | | | (HFO-1233yd(Z)) | | |
| B2 | CEO | Paraffinic Oil | cis-1-chloro- | 97.0 to 75.0 | 25.0 to 3.0 |
| | | | 2,3,3- | | |
| | | | trifluoropropene | | |
| | | | (HFO-1233yd(Z)) | | |
| B3 | CEO | Paraffinic Oil | cis-1-chloro- | 95.0 to 75.0 | 25.0 to 5.0 |
| | | | 2,3,3- | | |
| | | | trifluoropropene | | |
| | | | (HFO-1233yd(Z)) | | |
| B4 | CEO | Paraffinic Oil | cis-1-chloro- | 92.5 to 75.0 | 25.0 to 75.0 |
| | | | 2,3,3- | | |
| | | | trifluoropropene | | |
| | | | (HFO-1233yd(Z)) | | |
| B5 | CEO | Paraffinic Oil | cis-1-chloro- | 90.0 to 75.0 | 25.0 to 10.0 |
| | | | 2,3,3- | | |
| | | | trifluoropropene | | |
| | | | (HFO-1233yd(Z)) | | |
| B6 | CEO | Paraffinic Oil | cis-1-chloro- | 87.5 to 75.0 | 25.0 to 12.5 |
| | | | 2,3,3- | | |
| | | | trifluoropropene | | |
| | | | (HFO-1233yd(Z)) | | |
| B7 | CEO | Paraffinic Oil | cis-1-chloro- | 85.0 to 75.0 | 25.0 to 15.0 |
| | | | 2,3,3- | | |
| | | | trifluoropropene | | |
| | | | (HFO-1233yd(Z)) | | |
| B8 | CEO | Paraffinic Oil | cis-1-chloro- | 82.5 to 75.0 | 25.0 to 17.5 |
| | | | 2,3,3- | | |
| | | | trifluoropropene | | |
| | | | (HFO-1233yd(Z)) | | |
| B9 | CEO | Paraffinic Oil | cis-1-chloro- | 80.0 to 75.0 | 25.0 to 20.0 |
| | | | 2,3,3- | | |
| | | | trifluoropropene | | |
| | | | (HFO-1233yd(Z)) | | |
| B10 | CEO | Paraffinic Oil | cis-1-chloro- | 77.5 to 75.0 | 25.0 to 22.5 |
| | | | 2,3,3- | | |
| | | | trifluoropropene | | |
| | | | (HFO-1233yd(Z)) | | |
| B11 | CEO | Paraffinic Oil | cis-1-chloro- | 75.0 | 25.0 |
| | | | 2,3,3- | | |
| | | | trifluoropropene | | |
| | | | (HFO-1233yd(Z)) | | |
| B12 | CEO | Paraffinic Oil | cis-1-chloro- | 99.0 to 97.0 | 3.0 to 1.0 |
| | | | 2,3,3- | | |
| | | | trifluoropropene | | |
| | | | (HFO-1233yd(Z)) | | |
| B13 | CEO | Paraffinic Oil | cis-1-chloro- | 99.0 to 95.0 | 5.0 to 1 |
| | | | 2,3,3- | | |
| | | | trifluoropropene | | |
| | | | (HFO-1233yd(Z)) | | |
| B14 | CEO | Paraffinic Oil | cis-1-chloro- | 99.0 to 92.5 | 7.5 to 1.0 |
| | | | 2,3,3- | | |
| | | | trifluoropropene | | |
| | | | (HFO-1233yd(Z)) | | |
| B15 | CEO | Paraffinic Oil | cis-1-chloro- | 99.0 to 90.0 | 10.0 to 1.0 |
| | | | 2,3,3- | | |
| | | | trifluoropropene | | |
| | | | (HFO-1233yd(Z)) | | |
| B16 | CEO | Paraffinic Oil | cis-1-chloro- | 99.0 to 87.5 | 12.5 to 1.0 |
| | | | 2,3,3- | | |
| | | | trifluoropropene | | |
| | | | (HFO-1233yd(Z)) | | |
| B17 | CEO | Paraffinic Oil | cis-1-chloro- | 99.0 to 85.0 | 15.0 to 1.0 |
| | | | 2,3,3- | | |
| | | | trifluoropropene | | |
| | | | (HFO-1233yd(Z)) | | |
| B18 | CEO | Paraffinic Oil | cis-1-chloro- | 99.0 to 82.5 | 17.5 to 1.0 |
| | | | 2,3,3- | | |
| | | | trifluoropropene | | |
| | | | (HFO-1233yd(Z)) | | |
| B19 | CEO | Paraffinic Oil | cis-1-chloro- | 99.0 to 80.0 | 20.0 to 1.0 |
| | | | 2,3,3- | | |
| | | | trifluoropropene | | |
| | | | (HFO-1233yd(Z)) | | |
| B20 | CEO | Paraffinic Oil | cis-1-chloro- | 99.0 to 77.5 | 22.5 to 1.0 |
| | | | 2,3,3- | | |
| | | | trifluoropropene | | |
| | | | (HFO-1233yd(Z)) | | |
| B1 | CO | Paraffinic Oil | cis-1-chloro- | 99.0 to 75.0 | 25.0 to 1.0 |
| | | | 2,3,3- | | |
| | | | trifluoropropene | | |
| | | | (HFO-1233yd(Z)) | | |
| B2 | CO | Paraffinic Oil | cis-1-chloro- | 97.0 to 75.0 | 25.0 to 3.0 |
| | | | 2,3,3- | | |
| | | | trifluoropropene | | |
| | | | (HFO-1233yd(Z)) | | |
| B3 | CO | Paraffinic Oil | cis-1-chloro- | 95.0 to 75.0 | 25.0 to 5.0 |
| | | | 2,3,3- | | |
| | | | trifluoropropene | | |
| | | | (HFO-1233yd(Z)) | | |
| B4 | CO | Paraffinic Oil | cis-1-chloro- | 92.5 to 75.0 | 25.0 to 7.5 |
| | | | 2,3,3- | | |
| | | | trifluoropropene | | |
| | | | (HFO-1233yd(Z)) | | |
| B5 | CO | Paraffinic Oil | cis-1-chloro- | 90.0 to 75.0 | 25.0 to 10.0 |
| | | | 2,3,3- | | |
| | | | trifluoropropene | | |
| | | | (HFO-1233yd(Z)) | | |
| B6 | CO | Paraffinic Oil | cis-1-chloro- | 87.5 to 75.0 | 25.0 to 12.5 |
| | | | 2,3,3- | | |
| | | | trifluoropropene | | |
| | | | (HFO-1233yd(Z)) | | |
| B7 | CO | Paraffinic Oil | cis-1-chloro- | 85.0 to 75.0 | 25.0 to 15.0 |
| | | | 2,3,3- | | |
| | | | trifluoropropene | | |
| | | | (HFO-1233yd(Z)) | | |
| B8 | CO | Paraffinic Oil | cis-1-chloro- | 82.5 to 75.0 | 25.0 to 17.5 |
| | | | 2,3,3- | | |
| | | | trifluoropropene | | |
| | | | (HFO-1233yd(Z)) | | |
| B9 | CO | Paraffinic Oil | cis-1-chloro- | 80.0 to 75.0 | 25.0 to 20.0 |
| | | | 2,3,3- | | |
| | | | trifluoropropene | | |
| | | | (HFO-1233yd(Z)) | | |
| B10 | CO | Paraffinic Oil | cis-1-chloro- | 77.5 to 75.0 | 25.0 to 22.5 |
| | | | 2,3,3- | | |
| | | | trifluoropropene | | |
| | | | (HFO-1233yd(Z)) | | |
| B11 | CO | Paraffinic Oil | cis-1-chloro- | 75.0 | 25.0 |
| | | | 2,3,3- | | |
| | | | trifluoropropene | | |
| | | | (HFO-1233yd(Z)) | | |
| B12 | CO | Paraffinic Oil | cis-1-chloro- | 99.0 to 97.0 | 3.0 to 1.0 |
| | | | 2,3,3- | | |
| | | | trifluoropropene | | |
| | | | (HFO-1233yd(Z)) | | |
| B13 | CO | Paraffinic Oil | cis-1-chloro- | 99.0 to 95.0 | 5.0 to 1.0 |
| | | | 2,3,3- | | |
| | | | trifluoropropene | | |
| | | | (HFO-1233yd(Z)) | | |
| B14 | CO | Paraffinic Oil | cis-1-chloro- | 99.0 to 92.5 | 7.5 to 1.0 |
| | | | 2,3,3- | | |
| | | | trifluoropropene | | |
| | | | (HFO-1233yd(Z)) | | |
| B15 | CO | Paraffinic Oil | cis-1-chloro- | 99.0 to 90.0 | 10.0 to 1.0 |
| | | | 2,3,3- | | |
| | | | trifluoropropene | | |
| | | | (HFO-1233yd(Z)) | | |
| B16 | CO | Paraffinic Oil | cis-1-chloro- | 99.0 to 87.5 | 12.5 to 1.0 |
| | | | 2,3,3- | | |
| | | | trifluoropropene | | |
| | | | (HFO-1233yd(Z)) | | |
| B17 | CO | Paraffinic Oil | cis-1-chloro- | 99.0 to 85.0 | 15.0 to 1.0 |
| | | | 2,3,3- | | |
| | | | trifluoropropene | | |
| | | | (HFO-1233yd(Z)) | | |
| B18 | CO | Paraffinic Oil | cis-1-chloro- | 99.0 to 82.5 | 17.5 to 1.0 |
| | | | 2,3,3- | | |
| | | | trifluoropropene | | |
| | | | (HFO-1233yd(Z)) | | |
| B19 | CO | Paraffinic Oil | cis-1-chloro- | 99.0 to 80.0 | 20.0 to 1.0 |
| | | | 2,3,3- | | |
| | | | trifluoropropene | | |
| | | | (HFO-1233yd(Z)) | | |
| B20 | CO | Paraffinic Oil | cis-1-chloro- | 99.0 to 77.5 | 22.5 to 1.0 |
| | | | 2,3,3- | | |
| | | | trifluoropropene | | |
| | | | (HFO-1233yd(Z)) | | |
| Heat Transfer | Heat Transfer | | | Wt. % range | Wt. % range |
| Composition | Composition Nature | Base fluid | Refrigerant | Polyol ester | (HFO-1233yd(Z)) |

C1-C20: Polyol ester and cis-1-chloro-2,3,3-trifluoropropene (HFO-1233yd(Z))

| | | | | | |
|---|---|---|---|---|---|
| C1 | COMP | Polyol ester | cis-1-chloro- | 99.0 to 75.0 | 25.0 to 1.0 |
| | | (POE) | 2,3,3- | | |
| | | | trifluoropropene | | |
| | | | (HFO-1233yd(Z)) | | |
| C2 | COMP | Polyol ester | cis-1-chloro- | 97.0 to 75.0 | 25.0 to 3.0 |
| | | (POE) | 2,3,3- | | |
| | | | trifluoropropene | | |
| | | | (HFO-1233yd(Z)) | | |
| C3 | COMP | Polyol ester | cis-1-chloro- | 95.0 to 75.0 | 25.0 to 5.0 |
| | | (POE) | 2,3,3- | | |
| | | | trifluoropropene | | |
| | | | (HFO-1233yd(Z)) | | |
| C4 | COMP | Polyol ester | cis-1-chloro- | 92.5 to 75.0 | 25.0 to 7.5 |
| | | (POE) | 2,3,3- | | |
| | | | trifluoropropene | | |
| | | | (HFO-1233yd(Z)) | | |
| C5 | COMP | Polyol ester | cis-1-chloro- | 90.0 to 75.0 | 25.0 to 10.0 |
| | | (POE) | 2,3,3- | | |
| | | | trifluoropropene | | |
| | | | (HFO-1233yd(Z)) | | |
| C6 | COMP | Polyol ester | cis-1-chloro- | 87.5 to 75.0 | 25.0 to 12.5 |
| | | (POE) | 2,3,3- | | |
| | | | trifluoropropene | | |
| | | | (HFO-1233yd(Z)) | | |
| C7 | COMP | Polyol ester | cis-1-chloro- | 85.0 to 75.0 | 25.0 to 15.0 |
| | | (POE) | 2,3,3- | | |
| | | | trifluoropropene | | |
| | | | (HFO-1233yd(Z)) | | |
| C8 | COMP | Polyol ester | cis-1-chloro- | 82.5 to 75.0 | 25.0 to 17.5 |
| | | (POE) | 2,3,3- | | |
| | | | trifluoropropene | | |
| | | | (HFO-1233yd(Z)) | | |
| C9 | COMP | Polyol ester | cis-1-chloro- | 80.0 to 75.0 | 25.0 to 20.0 |
| | | (POE) | 2,3,3- | | |
| | | | trifluoropropene | | |
| | | | (HFO-1233yd(Z)) | | |
| C10 | COMP | Polyol ester | cis-1-chloro- | 77.5 to 75.0 | 25.0 to 22.5 |
| | | (POE) | 2,3,3- | | |
| | | | trifluoropropene | | |
| | | | (HFO-1233yd(Z)) | | |
| C11 | COMP | Polyol ester | cis-1-chloro- | 75.0 | 25.0 |
| | | (POE) | 2,3,3- | | |
| | | | trifluoropropene | | |
| | | | (HFO-1233yd(Z)) | | |
| C12 | COMP | Polyol ester | cis-1-chloro- | 99.0 to 97.0 | 3.0 to 1.0 |
| | | (POE) | 2,3,3- | | |
| | | | trifluoropropene | | |
| | | | (HFO-1233yd(Z)) | | |
| C13 | COMP | Polyol ester | cis-1-chloro- | 99.0 to 95.0 | 5.0 to 1.0 |
| | | (POE) | 2,3,3- | | |
| | | | trifluoropropene | | |
| | | | (HFO-1233yd(Z)) | | |
| C14 | COMP | Polyol ester | cis-1-chloro- | 99.0 to 92.5 | 7.5 to 1.0 |
| | | (POE) | 2,3,3- | | |
| | | | trifluoropropene | | |
| | | | (HFO-1233yd(Z)) | | |
| C15 | COMP | Polyol ester | cis-1-chloro- | 99.0 to 90.0 | 10.0 to 1.0 |
| | | (POE) | 2,3,3- | | |
| | | | trifluoropropene | | |
| | | | (HFO-1233yd(Z)) | | |
| C16 | COMP | Polyol ester | cis-1-chloro- | 99.0 to 87.5 | 12.5 to 1.0 |
| | | (POE) | 2,3,3- | | |
| | | | trifluoropropene | | |
| | | | (HFO-1233yd(Z)) | | |
| C17 | COMP | Polyol ester | cis-1-chloro- | 99.0 to 85.0 | 15.0 to 1.0 |
| | | (POE) | 2,3,3- | | |
| | | | trifluoropropene | | |
| | | | (HFO-1233yd(Z)) | | |
| C18 | COMP | Polyol ester | cis-1-chloro- | 99.0 to 82.5 | 17.5 to 1.0 |
| | | (POE) | 2,3,3- | | |
| | | | trifluoropropene | | |
| | | | (HFO-1233yd(Z)) | | |
| C19 | COMP | Polyol ester | cis-1-chloro- | 99.0 to 80.0 | 20.0 to 1.0 |
| | | (POE) | 2,3,3- | | |
| | | | trifluoropropene | | |
| | | | (HFO-1233yd(Z)) | | |
| C20 | COMP | Polyol ester | cis-1-chloro- | 99.0 to 77.5 | 22.5 to 1.0 |
| | | (POE) | 2,3,3- | | |
| | | | trifluoropropene | | |
| | | | (HFO-1233yd(Z)) | | |
| C1 | CEO | Polyol ester | cis-1-chloro- | 99.0 to 75.0 | 25.0 to 1.0 |
| | | (POE) | 2,3,3- | | |
| | | | trifluoropropene | | |
| | | | (HFO-1233yd(Z)) | | |
| C2 | CEO | Polyol ester | cis-1-chloro- | 97.0 to 75.0 | 25.0 to 3.0 |
| | | (POE) | 2,3,3- | | |
| | | | trifluoropropene | | |
| | | | (HFO-1233yd(Z)) | | |
| C3 | CEO | Polyol ester | cis-1-chloro- | 95.0 to 75.0 | 25.0 to 5.0 |
| | | (POE) | 2,3,3- | | |
| | | | trifluoropropene | | |
| | | | (HFO-1233yd(Z)) | | |
| C4 | CEO | Polyol ester | cis-1-chloro- | 92.5 to 75.0 | 25.0 to 7.5 |
| | | (POE) | 2,3,3- | | |
| | | | trifluoropropene | | |
| | | | (HFO-1233yd(Z)) | | |
| C5 | CEO | Polyol ester | cis-1-chloro- | 90.0 to 75.0 | 25.0 to 10.0 |
| | | (POE) | 2,3,3- | | |
| | | | trifluoropropene | | |
| | | | (HFO-1233yd(Z)) | | |
| C6 | CEO | Polyol ester | cis-1-chloro- | 87.5 to 75.0 | 25.0 to 12.5 |
| | | (POE) | 2,3,3- | | |
| | | | trifluoropropene | | |
| | | | (HFO-1233yd(Z)) | | |
| C7 | CEO | Polyol ester | cis-1-chloro- | 85.0 to 75.0 | 25.0 to 15.0 |
| | | (POE) | 2,3,3- | | |
| | | | trifluoropropene | | |
| | | | (HFO-1233yd(Z)) | | |
| C8 | CEO | Polyol ester | cis-1-chloro- | 82.5 to 75.0 | 25.0 to 17.5 |
| | | (POE) | 2,3,3- | | |
| | | | trifluoropropene | | |
| | | | (HFO-1233yd(Z)) | | |
| C9 | CEO | Polyol ester | cis-1-chloro- | 80.0 to 75.0 | 25.0 to 20.0 |
| | | (POE) | 2,3,3- | | |
| | | | trifluoropropene | | |
| | | | (HFO-1233yd(Z)) | | |
| C10 | CEO | Polyol ester | cis-1-chloro- | 77.5 to 75.0 | 25.0 to 22.5 |
| | | (POE) | 2,3,3- | | |
| | | | trifluoropropene | | |
| | | | (HFO-1233yd(Z)) | | |
| C11 | CEO | Polyol ester | cis-1-chloro- | 75.0 | 25.0 |
| | | (POE) | 2,3,3- | | |
| | | | trifluoropropene | | |
| | | | (HFO-1233yd(Z)) | | |
| C12 | CEO | Polyol ester | cis-1-chloro- | 99.0 to 97.0 | 3.0 to 1.0 |
| | | (POE) | 2,3,3- | | |
| | | | trifluoropropene | | |
| | | | (HFO-1233yd(Z)) | | |
| C13 | CEO | Polyol ester | cis-1-chloro- | 99.0 to 95.0 | 5.0 to 1.0 |
| | | (POE) | 2,3,3- | | |
| | | | trifluoropropene | | |
| | | | (HFO-1233yd(Z)) | | |
| C14 | CEO | Polyol ester | cis-1-chloro- | 99.0 to 92.5 | 7.5 to 1.0 |
| | | (POE) | 2,3,3- | | |
| | | | trifluoropropene | | |
| | | | (HFO-1233yd(Z)) | | |
| C15 | CEO | Polyol ester | cis-1-chloro- | 99.0 to 90.0 | 10.0 to 1.0 |
| | | (POE) | 2,3,3- | | |
| | | | trifluoropropene | | |
| | | | (HFO-1233yd(Z)) | | |
| C16 | CEO | Polyol ester | cis-1-chloro- | 99.0 to 87.5 | 12.5 to 1.0 |
| | | (POE) | 2,3,3- | | |
| | | | trifluoropropene | | |
| | | | (HFO-1233yd(Z)) | | |
| C17 | CEO | Polyol ester | cis-1-chloro- | 99.0 to 85.0 | 15.0 to 1.0 |
| | | (POE) | 2,3,3- | | |
| | | | trifluoropropene | | |
| | | | (HFO-1233yd(Z)) | | |
| C18 | CEO | Polyol ester | cis-1-chloro- | 99.0 to 82.5 | 17.5 to 1.0 |
| | | (POE) | 2,3,3- | | |
| | | | trifluoropropene | | |
| | | | (HFO-1233yd(Z)) | | |
| C19 | CEO | Polyol ester | cis-1-chloro- | 99.0 to 80.0 | 20.0 to 1.0 |
| | | (POE) | 2,3,3- | | |
| | | | trifluoropropene | | |
| | | | (HFO-1233yd(Z)) | | |
| C20 | CEO | Polyol ester | cis-1-chloro- | 99.0 to 77.5 | 22.5 to 1.0 |
| | | (POE) | 2,3,3- | | |
| | | | trifluoropropene | | |
| | | | (HFO-1233yd(Z)) | | |
| C1 | CO | Polyol ester | cis-1-chloro- | 99.0 to 75.0 | 25.0 to 1.0 |
| | | (POE) | 2,3,3- | | |
| | | | trifluoropropene | | |
| | | | (HFO-1233yd(Z)) | | |
| C2 | CO | Polyol ester | cis-1-chloro- | 97.0 to 75.0 | 25.0 to 3.0 |
| | | (POE) | 2,3,3- | | |
| | | | trifluoropropene | | |
| | | | (HFO-1233yd(Z)) | | |
| C3 | CO | Polyol ester | cis-1-chloro- | 95.0 to 75.0 | 25.0 to 5.0 |
| | | (POE) | 2,3,3- | | |
| | | | trifluoropropene | | |
| | | | (HFO-1233yd(Z)) | | |
| C4 | CO | Polyol ester | cis-1-chloro- | 92.5 to 75.0 | 25.0 to 7.5 |
| | | (POE) | 2,3,3- | | |
| | | | trifluoropropene | | |
| | | | (HFO-1233yd(Z)) | | |
| C5 | CO | Polyol ester | cis-1-chloro- | 90.0 to 75.0 | 25.0 to 10.0 |
| | | (POE) | 2,3,3- | | |
| | | | trifluoropropene | | |
| | | | (HFO-1233yd(Z)) | | |
| C6 | CO | Polyol ester | cis-1-chloro- | 87.5 to 75.0 | 25.0 to 12.5 |
| | | (POE) | 2,3,3- | | |
| | | | trifluoropropene | | |
| | | | (HFO-1233yd(Z)) | | |
| C7 | CO | Polyol ester | cis-1-chloro- | 85.0 to 75.0 | 25.0 to 15.0 |
| | | (POE) | 2,3,3- | | |
| | | | trifluoropropene | | |
| | | | (HFO-1233yd(Z)) | | |
| C8 | CO | Polyol ester | cis-1-chloro- | 82.5 to 75.0 | 25.0 to 17.5 |
| | | (POE) | 2,3,3- | | |
| | | | trifluoropropene | | |
| | | | (HFO-1233yd(Z)) | | |
| C9 | CO | Polyol ester | cis-1-chloro- | 80.0 to 75.0 | 25.0 to 20.0 |
| | | (POE) | 2,3,3- | | |
| | | | trifluoropropene | | |
| | | | (HFO-1233yd(Z)) | | |
| C10 | CO | Polyol ester | cis-1-chloro- | 77.5 to 75.0 | 25.0 to 22.5 |
| | | (POE) | 2,3,3- | | |
| | | | trifluoropropene | | |
| | | | (HFO-1233yd(Z)) | | |
| C11 | CO | Polyol ester | cis-1-chloro- | 75.0 | 25.0 |
| | | (POE) | 2,3,3- | | |
| | | | trifluoropropene | | |
| | | | (HFO-1233yd(Z)) | | |
| C12 | CO | Polyol ester | cis-1-chloro- | 99.0 to 97.0 | 3.0 to 1.0 |
| | | (POE) | 2,3,3- | | |
| | | | trifluoropropene | | |
| | | | (HFO-1233yd(Z)) | | |
| C13 | CO | Polyol ester | cis-1-chloro- | 99.0 to 95.0 | 5.0 to 1.0 |
| | | (POE) | 2,3,3- | | |
| | | | trifluoropropene | | |
| | | | (HFO-1233yd(Z)) | | |
| C14 | CO | Polyol ester | cis-1-chloro- | 99.0 to 92.5 | 7.5 to 1.0 |
| | | (POE) | 2,3,3- | | |
| | | | trifluoropropene | | |
| | | | (HFO-1233yd(Z)) | | |
| C15 | CO | Polyol ester | cis-1-chloro- | 99.0 to 90.0 | 10.0 to 1.0 |
| | | (POE) | 2,3,3- | | |
| | | | trifluoropropene | | |
| | | | (HFO-1233yd(Z)) | | |
| C16 | CO | Polyol ester | cis-1-chloro- | 99.0 to 87.5 | 12.5 to 1.0 |
| | | (POE) | 2,3,3- | | |
| | | | trifluoropropene | | |
| | | | (HFO-1233yd(Z)) | | |
| C17 | CO | Polyol ester | cis-1-chloro- | 99.0 to 85.0 | 15.0 to 1.0 |
| | | (POE) | 2,3,3- | | |
| | | | trifluoropropene | | |
| | | | (HFO-1233yd(Z)) | | |
| C18 | CO | Polyol ester | cis-1-chloro- | 99.0 to 82.5 | 17.5 to 1.0 |
| | | (POE) | 2,3,3- | | |
| | | | trifluoropropene | | |
| | | | (HFO-1233yd(Z)) | | |
| C19 | CO | Polyol ester | cis-1-chloro- | 99.0 to 80.0 | 20.0 to 1.0 |
| | | (POE) | 2,3,3- | | |
| | | | trifluoropropene | | |
| | | | (HFO-1233yd(Z)) | | |
| C20 | CO | Polyol ester | cis-1-chloro- | 99.0 to 77.5 | 22.5 to 1.0 |
| | | (POE) | 2,3,3- | | |
| | | | trifluoropropene | | |
| | | | (HFO-1233yd(Z)) | | |

D1-D11: Blend and cis-1-chloro-2,3,3-trifluoropropene (HFO-1233yd(Z))

| | | | | | |
|---|---|---|---|---|---|
| D1 | COMP | Blend | cis-1-chloro- | 99.0 to 75.0 | 25.0 to 1.0 |
| | | | 2,3,3- | | |
| | | | trifluoropropene | | |
| | | | (HFO-1233yd(Z)) | | |
| D2 | COMP | Blend | cis-1-chloro- | 97.0 to 75.0 | 25.0 to 3.0 |
| | | | 2,3,3- | | |
| | | | trifluoropropene | | |
| | | | (HFO-1233yd(Z)) | | |
| D3 | COMP | Blend | cis-1-chloro- | 95.0 to 75.0 | 25.0 to 5.0 |
| | | | 2,3,3- | | |
| | | | trifluoropropene | | |
| | | | (HFO-1233yd(Z)) | | |
| D4 | COMP | Blend | cis-1-chloro- | 92.5 to 75.0 | 25.0 to 7.5 |
| | | | 2,3,3- | | |
| | | | trifluoropropene | | |
| | | | (HFO-1233yd(Z)) | | |
| D5 | COMP | Blend | cis-1-chloro- | 90.0 to 75.0 | 25.0 to 10.0 |
| | | | 2,3,3- | | |
| | | | trifluoropropene | | |
| | | | (HFO-1233yd(Z)) | | |
| D6 | COMP | Blend | cis-1-chloro- | 87.5 to 75.0 | 25.0 to 12.5 |
| | | | 2,3,3- | | |
| | | | trifluoropropene | | |
| | | | (HFO-1233yd(Z)) | | |
| D7 | COMP | Blend | cis-1-chloro- | 85.0 to 75.0 | 25.0 to 15.0 |
| | | | 2,3,3- | | |
| | | | trifluoropropene | | |
| | | | (HFO-1233yd(Z)) | | |
| D8 | COMP | Blend | cis-1-chloro- | 82.5 to 75.0 | 25.0 to 17.5 |
| | | | 2,3,3- | | |
| | | | trifluoropropene | | |
| | | | (HFO-1233yd(Z)) | | |
| D9 | COMP | Blend | cis-1-chloro- | 80.0 to 75.0 | 25.0 to 20.0 |
| | | | 2,3,3- | | |
| | | | trifluoropropene | | |
| | | | (HFO-1233yd(Z)) | | |
| D10 | COMP | Blend | cis-1-chloro- | 77.5 to 75.0 | 25.0 to 22.5 |
| | | | 2,3,3- | | |
| | | | trifluoropropene | | |
| | | | (HFO-1233yd(Z)) | | |
| D11 | COMP | Blend | cis-1-chloro- | 75.0 | 25.0 |
| | | | 2,3,3- | | |
| | | | trifluoropropene | | |
| | | | (HFO-1233yd(Z)) | | |
| D12 | COMP | Blend | cis-1-chloro- | 99.0 to 97.0 | 3.0 to 1.0 |
| | | | 2,3,3- | | |
| | | | trifluoropropene | | |
| | | | (HFO-1233yd(Z)) | | |
| D13 | COMP | Blend | cis-1-chloro- | 99.0 to 95.0 | 5.0 to 1.0 |
| | | | 2,3,3- | | |
| | | | trifluoropropene | | |
| | | | (HFO-1233yd(Z)) | | |
| D14 | COMP | Blend | cis-1-chloro- | 99.0 to 92.5 | 7.5 to 1.0 |
| | | | 2,3,3- | | |
| | | | trifluoropropene | | |
| | | | (HFO-1233yd(Z)) | | |
| D15 | COMP | Blend | cis-1-chloro- | 99.0 to 90.0 | 10.0 to 1.0 |
| | | | 2,3,3- | | |
| | | | trifluoropropene | | |
| | | | (HFO-1233yd(Z)) | | |
| D16 | COMP | Blend | cis-1-chloro- | 99.0 to 87.5 | 12.5 to 1.0 |
| | | | 2,3,3- | | |
| | | | trifluoropropene | | |
| | | | (HFO-1233yd(Z)) | | |
| D17 | COMP | Blend | cis-1-chloro- | 99.0 to 85.0 | 15.0 to 1.0 |
| | | | 2,3,3- | | |
| | | | trifluoropropene | | |
| | | | (HFO-1233yd(Z)) | | |
| D18 | COMP | Blend | cis-1-chloro- | 99.0 to 82.5 | 17.5 to 1.0 |
| | | | 2,3,3- | | |
| | | | trifluoropropene | | |
| | | | (HFO-1233yd(Z)) | | |
| D19 | COMP | Blend | cis-1-chloro- | 99.0 to 80.0 | 20.0 to 1.0 |
| | | | 2,3,3- | | |
| | | | trifluoropropene | | |
| | | | (HFO-1233yd(Z)) | | |
| D20 | COMP | Blend | cis-1-chloro- | 99.0 to 77.5 | 22.5 to 1.0 |
| | | | 2,3,3- | | |
| | | | trifluoropropene | | |
| | | | (HFO-1233yd(Z)) | | |
| D1 | CEO | Blend | cis-1-chloro- | 99.0 to 75.0 | 25.0 to 1.0 |
| | | | 2,3,3- | | |
| | | | trifluoropropene | | |
| | | | (HFO-1233yd(Z)) | | |
| D2 | CEO | Blend | cis-1-chloro- | 97.0 to 75.0 | 25.0 to 3.0 |
| | | | 2,3,3- | | |
| | | | trifluoropropene | | |
| | | | (HFO-1233yd(Z)) | | |
| D3 | CEO | Blend | cis-1-chloro- | 95.0 to 75.0 | 25.0 to 5.0 |
| | | | 2,3,3- | | |
| | | | trifluoropropene | | |
| | | | (HFO-1233yd(Z)) | | |
| D4 | CEO | Blend | cis-1-chloro- | 92.5 to 75.0 | 25.0 to 7.5 |
| | | | 2,3,3- | | |
| | | | trifluoropropene | | |
| | | | (HFO-1233yd(Z)) | | |
| D5 | CEO | Blend | cis-1-chloro- | 90.0 to 75.0 | 25.0 to 10.0 |
| | | | 2,3,3- | | |
| | | | trifluoropropene | | |
| | | | (HFO-1233yd(Z)) | | |
| D6 | CEO | Blend | cis-1-chloro- | 87.5 to 75.0 | 25.0 to 12.5 |
| | | | 2,3,3- | | |
| | | | trifluoropropene | | |
| | | | (HFO-1233yd(Z)) | | |
| D7 | CEO | Blend | cis-1-chloro- | 85.0 to 75.0 | 25.0 to 15.0 |
| | | | 2,3,3- | | |
| | | | trifluoropropene | | |
| | | | (HFO-1233yd(Z)) | | |
| D8 | CEO | Blend | cis-1-chloro- | 82.5 to 75.0 | 25.0 to 17.5 |
| | | | 2,3,3- | | |
| | | | trifluoropropene | | |
| | | | (HFO-1233yd(Z)) | | |
| D9 | CEO | Blend | cis-1-chloro- | 80.0 to 75.0 | 25.0 to 20.0 |
| | | | 2,3,3- | | |
| | | | trifluoropropene | | |
| | | | (HFO-1233yd(Z)) | | |
| D10 | CEO | Blend | cis-1-chloro- | 77.5 to 75.0 | 25.0 to 22.5 |
| | | | 2,3,3- | | |
| | | | trifluoropropene | | |
| | | | (HFO-1233yd(Z)) | | |
| D11 | CEO | Blend | cis-1-chloro- | 75.0 | 25.0 |
| | | | 2,3,3- | | |
| | | | trifluoropropene | | |
| | | | (HFO-1233yd(Z)) | | |
| D12 | CEO | Blend | cis-1-chloro- | 99.0 to 97.0 | 3.0 to 1.0 |
| | | | 2,3,3- | | |
| | | | trifluoropropene | | |
| | | | (HFO-1233yd(Z)) | | |
| D13 | CEO | Blend | cis-1-chloro- | 99.0 to 95.0 | 5.0 to 1 |
| | | | 2,3,3- | | |
| | | | trifluoropropene | | |
| | | | (HFO-1233yd(Z)) | | |
| D14 | CEO | Blend | cis-1-chloro- | 99.0 to 92.5 | 7.5 to 1.0 |
| | | | 2,3,3- | | |
| | | | trifluoropropene | | |
| | | | (HFO-1233yd(Z)) | | |
| D15 | CEO | Blend | cis-1-chloro- | 99.0 to 90.0 | 10.0 to 1.0 |
| | | | 2,3,3- | | |
| | | | trifluoropropene | | |
| | | | (HFO-1233yd(Z)) | | |
| D16 | CEO | Blend | cis-1-chloro- | 99.0 to 87.5 | 12.5 to 1.0 |
| | | | 2,3,3- | | |
| | | | trifluoropropene | | |
| | | | (HFO-1233yd(Z)) | | |
| D17 | CEO | Blend | cis-1-chloro- | 99.0 to 85.0 | 15.0 to 1.0 |
| | | | 2,3,3- | | |
| | | | trifluoropropene | | |
| | | | (HFO-1233yd(Z)) | | |
| D18 | CEO | Blend | cis-1-chloro- | 99.0 to 82.5 | 17.5 to 1.0 |
| | | | 2,3,3- | | |
| | | | trifluoropropene | | |
| | | | (HFO-1233yd(Z)) | | |
| D19 | CEO | Blend | cis-1-chloro- | 99.0 to 80.0 | 20.0 to 1.0 |
| | | | 2,3,3- | | |
| | | | trifluoropropene | | |
| | | | (HFO-1233yd(Z)) | | |
| D20 | CEO | Blend | cis-1-chloro- | 99.0 to 77.5 | 22.5 to 1.0 |
| | | | 2,3,3- | | |
| | | | trifluoropropene | | |
| | | | (HFO-1233yd(Z)) | | |
| D1 | CO | Blend | cis-1-chloro- | 99.0 to 75.0 | 25.0 to 1.0 |
| | | | 2,3,3- | | |
| | | | trifluoropropene | | |
| | | | (HFO-1233yd(Z)) | | |
| D2 | CO | Blend | cis-1-chloro- | 97.0 to 75.0 | 25.0 to 3.0 |
| | | | 2,3,3- | | |
| | | | trifluoropropene | | |
| | | | (HFO-1233yd(Z)) | | |
| D3 | CO | Blend | cis-1-chloro- | 95.0 to 75.0 | 25.0 to 5.0 |
| | | | 2,3,3- | | |
| | | | trifluoropropene | | |
| | | | (HFO-1233yd(Z)) | | |
| D4 | CO | Blend | cis-1-chloro- | 92.5 to 75.0 | 25.0 to 7.5 |
| | | | 2,3,3- | | |
| | | | trifluoropropene | | |
| | | | (HFO-1233yd(Z)) | | |
| D5 | CO | Blend | cis-1-chloro- | 90.0 to 75.0 | 25.0 to 10.0 |
| | | | 2,3,3- | | |
| | | | trifluoropropene | | |
| | | | (HFO-1233yd(Z)) | | |
| D6 | CO | Blend | cis-1-chloro- | 87.5 to 75.0 | 25.0 to 12.5 |
| | | | 2,3,3- | | |
| | | | trifluoropropene | | |
| | | | (HFO-1233yd(Z)) | | |
| D7 | CO | Blend | cis-1-chloro- | 85.0 to 75.0 | 25.0 to 15.0 |
| | | | 2,3,3- | | |
| | | | trifluoropropene | | |
| | | | (HFO-1233yd(Z)) | | |
| D8 | CO | Blend | cis-1-chloro- | 82.5 to 75.0 | 25.0 to 17.5 |
| | | | 2,3,3- | | |
| | | | trifluoropropene | | |
| | | | (HFO-1233yd(Z)) | | |
| D9 | CO | Blend | cis-1-chloro- | 80.0 to 75.0 | 25.0 to 20.0 |
| | | | 2,3,3- | | |
| | | | trifluoropropene | | |
| | | | (HFO-1233yd(Z)) | | |
| D10 | CO | Blend | cis-1-chloro- | 77.5 to 75.0 | 25.0 to 22.5 |
| | | | 2,3,3- | | |
| | | | trifluoropropene | | |
| | | | (HFO-1233yd(Z)) | | |
| D11 | CO | Blend | cis-1-chloro- | 75.0 | 25.0 |
| | | | 2,3,3- | | |
| | | | trifluoropropene | | |
| | | | (HFO-1233yd(Z)) | | |
| D12 | CO | Blend | cis-1-chloro- | 99.0 to 97.0 | 3.0 to 1.0 |
| | | | 2,3,3- | | |
| | | | trifluoropropene | | |
| | | | (HFO-1233yd(Z)) | | |
| D13 | CO | Blend | cis-1-chloro- | 99.0 to 95.0 | 5.0 to 1.0 |
| | | | 2,3,3- | | |
| | | | trifluoropropene | | |
| | | | (HFO-1233yd(Z)) | | |
| D14 | CO | Blend | cis-1-chloro- | 99.0 to 92.5 | 7.5 to 1.0 |
| | | | 2,3,3- | | |
| | | | trifluoropropene | | |
| | | | (HFO-1233yd(Z)) | | |
| D15 | CO | Blend | cis-1-chloro- | 99.0 to 90.0 | 10.0 to 1.0 |
| | | | 2,3,3- | | |
| | | | trifluoropropene | | |
| | | | (HFO-1233yd(Z)) | | |
| D16 | CO | Blend | cis-1-chloro- | 99.0 to 87.5 | 12.5 to 1.0 |
| | | | 2,3,3- | | |
| | | | trifluoropropene | | |
| | | | (HFO-1233yd(Z)) | | |
| D17 | CC | Blend | cis-1-chloro- | 99.0 to 85.0 | 15.0 to 1.0 |
| | | | 2,3,3- | | |
| | | | trifluoropropene | | |
| | | | (HFO-1233yd(Z)) | | |
| D18 | CO | Blend | cis-1-chloro- | 99.0 to 82.5 | 17.5 to 1.0 |
| | | | 2,3,3- | | |
| | | | trifluoropropene | | |
| | | | (HFO-1233yd(Z)) | | |
| D19 | CC | Blend | cis-1-chloro- | 99.0 to 80.0 | 20.0 to 1.0 |
| | | | 2,3,3- | | |
| | | | trifluoropropene | | |
| | | | (HFO-1233yd(Z)) | | |
| D20 | CO | Blend | cis-1-chloro- | 99.0 to 77.5 | 22.5 to 1.0 |
| | | | 2,3,3- | | |
| | | | trifluoropropene | | |
| | | | (HFO-1233yd(Z)) | | |

Although describe in relation to poly(α)olefin (PAO), paraffinic, polyol ester (POE) and blended base fluids (e.g., A1-20; B1-20; C1-20, and D1-20 respectively), the disclosure is nonlimiting. Specifically, it is possible that other heat transfer oils/materials may perform similarly to those identified in Table 1 (e.g., with the addition of between 5% and 25 wt. % (HFO-1233yd(Z)). Specifically, each of the additional/alternative base fluid of mineral oils, polyalkylene glycol (PAG), PVE, and silicon Oil materials are expected to exhibit similar results to the materials identified in Table 1, and therefore, are contemplated by the disclosure.

Optionally, the heat transfer composition may include one or more additional additives including nanoparticles. The nanoparticles may be formed of metal oxides such as CuO, TiO2, ZnO, Al2O3, Fe2O3; carbon/silicon based compounds such as SiO2, SiC, CNT, MWCNT; or graphene and graphene oxide. The nanoparticles may have an average particle size of from 1 to 100 nm, as measured by ASTM E2859. The nanoparticles may be present in an amount between 0.1 vol % to 3.0 vol. % of the overall heat transfer composition. It has been surprisingly found that, with the addition of the nanoparticles, the heat transfer coefficient of the heat transfer fluid is increased by between 10% and 15%, such as between 12% and 14%, as compared to a heat transfer composition absent the nanoparticles. Therefore, the addition of the nanoparticles may enhance the overall heat transfer rate and corresponding thermal performance of the heat transfer composition.

### II. Performance

The heat transfer compositions of at least A1-20; B1-20; C-20; and D1-20 of the present invention comprise desirable performance characteristics, to be described in further detail herein, including any one of, or combination of: a) a kinematic viscosity at least 30% below the base fluid alone, b) a heat transfer coefficient at least 3% great than the base fluid alone; c) a liquid density less than 10% greater than the second fluid alone; d) associated pumping power at least 25% less than the base fluid alone; e) a figure of merit (FOM) greater than the base fluid alone; f) a pour point of below −40° C.; g) achieve and maintain a single liquid phase at temperatures less than 90° C.; h) a flash point of at least 120° C.; i) a normal boiling point of greater than 80° C.; j) maintaining complete miscibility in the associated base fluid between −30° C. to about 60° C., k) being PFAS free, and/or l) being low GWP. Such desirable performance characteristics make the heat transfer compositions of the present invention particularly suitable for BTMS applications, each of which will be described in further detail here.

a. Kinematic Viscosity

As described previously, during low temperature operating conditions, such as temperatures at or below 0° C., such as low as −20° C., the kinematic viscosity (cSt) of the coolant fluid may increase to unacceptably high levels, such as to at, or above, 100 cSt. Here, high kinematic viscosity of the coolant fluid contributes to two issues effecting the performance of the coolant fluid. Firstly, higher kinematic viscosity slows fluid flow and thickens the thermal boundary layer, reducing convective heat transfer and lowering the overall heat transfer coefficient of the coolant fluid. Secondly, higher viscosities increase the pumping power associated with the fluid, leading to higher parasitic energy losses associated with pumping of the coolant fluid. It has been surprisingly found that, by adding HFO-1233yd(Z) to the base fluid, the kinematic viscosity of the resulting heat transfer composition may decrease significantly, such as from about 30% to around 76%, and particularly, by more than 30%, or more than 50%, as compared to the base fluid alone.

For instance, in the case where a base polyalphaolefin (i.e., PAOs) heat transfer oil is used (e.g., Oil 1), such as Spectra Syn PAO2, the kinematic viscosity, as determined by ASTM D7483-21, is as low as about 16 cSt to as high as about 40 cSt at −20° C., as based upon a heat transfer composition comprising between about 5 wt. % and about 20 wt. % HFO-1233yd(Z) of the total heat transfer composition, as compared to 57 cSt for the PAO alone. This results in an about 30% to about 75% kinematic viscosity reduction via the addition of the 5 wt. % to 20 wt. % HFO-1233yd(Z), over the paraffinic oil alone, as shown in Tables 2 and 3 below:

TABLE 2
Kinematic Viscosity of PAO Oil with between
5 wt. % to 20 wt. % HFO-1233yd(Z).

| | Kinematic viscosity [cSt] | | | | | | | | |
|---|---|---|---|---|---|---|---|---|---|
| | | Oil 1 + | | Oil 1 + | | Oil 1 + | | Oil 1 + | |
| | | 5% | % | 10% | % | 15% | % | 20% | % |
| Temp | PAO | HFO- | Red. | HFO- | Red. | HFO- | Red. | HFO- | Red |
| [° C.] | Oil 1 | 1233yd(Z) | (1) | 1233yd(Z) | (2) | 1233yd(Z) | (3) | 1233yd(Z) | (4) |
| −20 | 57 | 40 | 30 | 27.4 | 52 | 21.2 | 63 | 16.2 | 72 |
| 0 | 19 | 15 | 30 | 11.1 | 42 | 9 | 53 | 7.2 | 62 |
| 20 | 8.8 | 7.3 | 21 | 5.6 | 36 | 4.8 | 45 | 3.9 | 56 |
| 40 | 5 | 4.2 | 17 | 3.3 | 34 | 2.9 | 42 | 2.4 | 52 |
| 60 | 3.2 | 2.6 | 16 | 2.2 | 31 | 1.9 | 41 | 1.8 | 44 |

In the case where a paraffinic oil heat transfer oil is used (e.g., Oil 2), such as Shell GTL E5 TM 410, the kinematic viscosity, as determined by ASTM D7483-21 is as low as about 41 cSt to as high as about 108 cSt at −20° C., as based upon a heat transfer composition comprising between about 5 wt. % and about 20 wt. % HFO-1233yd(Z) of the total heat transfer composition, as compared to 174 cSt for the paraffinic oil alone. This results in an about 38% to about 76% kinematic viscosity reduction via the addition of the 5 wt. % and 20 wt. % HFO-1233yd(Z), over the paraffinic oil alone, as shown in Table 3 below:

TABLE 3
Kinematic Viscosity of Paraffinic Oil with
between 5 wt. % to 20 wt. % HFO-1233yd(Z).

| | Kinematic viscosity [cSt] | | | | | | | | |
|---|---|---|---|---|---|---|---|---|---|
| | | 5% | % | 10% | % | 15% | % | 20% | % |
| Temp | Paraffinic | HFO- | Red. | HFO- | Red. | HFO- | Red. | HFO- | Red. |
| [° C.] | Oil 2 | 1233yd(Z) | (1) | 1233yd(Z) | (2) | 1233yd(Z) | (3) | 1233yd(Z) | (4) |
| −20 | 174 | 108 | 38 | 80 | 54 | 50.9 | 71 | 41.1 | 76 |
| 0 | 48.2 | 32.7 | 32 | 26.1 | 46 | 18 | 63 | 15.9 | 67 |
| 20 | 19.1 | 14.1 | 26 | 11.6 | 39 | 8.4 | 56 | 7.3 | 62 |
| 40 | 9.8 | 7 | 29 | 6 | 39 | 4.5 | 54 | 3.9 | 60 |
| 60 | 5.8 | 3.9 | 33 | 3.5 | 40 | 2.5 | 57 | 2.4 | 59 |

In another case where a polyalphaolefin bae oil (PAO) is used (e.g., Oil 3), such as Ampcool AC-110, the kinematic viscosity is about 57 cSt at −20° C., as based upon a heat transfer composition comprising about 10 wt. % HFO-1233yd(Z) of the total heat transfer composition, as compared to 122 cSt for the PAO oil alone. This results in an about 54% kinematic viscosity reduction via the addition of 10 wt. % HFO-1233yd(Z), over the PAO oil alone, as shown in Table 4 below.

TABLE 4
Kinematic Viscosity of PAO with between
5 wt. % to 20 wt. % HFO-1233yd(Z).

| | Kinematic viscosity [cSt] | | |
|---|---|---|---|
| Temp | PAO | Oil 3 + 10% | % Reduction |
| [° C.] | Oil 3 | HFO-1233yd(Z) | (1) |
| −20 | 122 | 56.7 | 54 |
| 0 | 41.1 | 21 | 49 |
| 20 | 16.1 | 9.1 | 43 |
| 40 | 8.1 | 4.8 | 41 |

In still another case where a blended oil base is used (e.g., Oil 4), such as EVOGEN TM1070, EVOGEN TM1100, and/or EVOGEN TM1150, the kinematic viscosity is reduced by about 30% or more via the addition of the 5 wt. % and 20 wt. % HFO-1233yd(Z), over the base blended oils alone, as shown in Tables 5, 6, and 7 below. Here, the base fluid may have a kinematic viscosity as little as about 5 cSt, 6.5 cSt, or about 9.2 cSt at −20° C. whereas the reduction of about 30% or more is observed.

TABLE 5
Kinematic viscosity reduction of EVOGEN TM1070 (Oil-5) at −20°
C. with the addition of various HFO-1233yd(Z) compositions.

| | | % Reduction in Kinematic viscosity [cSt] | | | |
|---|---|---|---|---|---|
| | | Oil 5 + | Oil 5 + | Oil 5 + | Oil 5 + |
| Temper- | Blended | 5% | 10% | 15% | 20% |
| ature | Oil 5 | HFO- | HFO- | HFO- | HFO- |
| [° C.] | [cSt] | 1233yd(Z) | 1233yd(Z) | 1233yd(Z) | 1233yd(Z) |
| −20 | 6.5 | >30% | >30% | >30% | >30% |

TABLE 6
Kinematic viscosity reduction of EVOGEN TM1100 (Oil-6) at −20°
C. with the addition of various HFO-1233yd(Z) compositions.

| | | % Reduction in Kinematic viscosity [cSt] | | | |
|---|---|---|---|---|---|
| | | Oil 6 + | Oil 6 + | Oil 6 + | Oil 6 + |
| Temper- | Blended | 5% | 10% | 15% | 20% |
| ature | Oil 6 | HFO- | HFO- | HFO- | HFO- |
| [° C.] | [cSt] | 1233yd(Z) | 1233yd(Z) | 1233yd(Z) | 1233yd(Z) |
| −20 | 9.2 | >30% | >30% | >30% | >30% |

TABLE 7
Kinematic viscosity reduction of EVOGEN TM1150 (Oil-7) at −20°
C. with the addition of various HFO-1233yd(Z) compositions.

| | | % Reduction in Kinematic viscosity [cSt] | | | |
|---|---|---|---|---|---|
| | | Oil 7 + | Oil 7 + | Oil 7 + | Oil 7 + |
| Temper- | Blended | 5% | 10% | 15% | 20% |
| ature | Oil 7 | HFO- | HFO- | HFO- | HFO- |
| [° C.] | [cSt] | 1233yd(Z) | 1233yd(Z) | 1233yd(Z) | 1233yd(Z) |
| −20 | 50.0 | >30% | >30% | >30% | >30% |

Accordingly, the kinematic viscosity of the heat transfer compositions A1-20 may be as little as about 15 cSt, 20 cSt, or 25 cSt, or as high as about 30 cSt, 40 cSt, or 45 cSt, or between any two values used as endpoints, such as about 15 cSt to about 45 cSt, about 15 cSt to about 40 cSt, or about 14 cSt to about 30 cSt, at −20° C. for a polyolefin oil (e.g., Spectra Syn PAO2) base composition; for heat transfer compositions B1-20, as little as about 40 cSt, 45 cSt, or 50 cSt, or as high as about 80 cSt, 90 cSt, or 110 cSt, or between any two values used as endpoints, such as about 40 cSt to about 90 cSt, about 40 cSt to about 90 cSt, or about 40 cSt to about 80 cSt, at −20° C. for a paraffinic oil (e.g., Shell GTL E5 TM 410) base composition, about 120 St for a polyolefin oil (PAO) (e.g., Ampcool AC-110) base composition, and about 5 cSt to about 50 cSt for a blended base fluid (e.g., EVOGEN TM 1070, TM 1100, TM1150). Additionally, each of compositions A1-20, B1-20, C1-20 and D1-20 may have kinematic viscosities at least about 30 wt. % or greater, less than the kinematic viscosity of the base fluid alone. In other words, compositions A1-20, B1-20, C1-20 and D1-20 may have viscosity reductions of at least 30% or more as compared to the base fluid alone.

b. Heat Transfer Coefficient:

As described previously, during low temperature operating conditions, such as temperatures at or below 0° C., such as low as −20° C., the heat transfer coefficient of the coolant fluid may decrease to unacceptably low levels. This may be due to a variety of factors such as increasing kinematic viscosity at lower temperatures (e.g., as described previously), reduced turbulence and mixing of the fluid at lower temperatures (e.g., as resulting from a higher viscosity of the fluid); a lower thermal conductivity of the coolant fluid itself, and/or phase changes induced by low temperature (e.g., partial solidification or gas releases, disrupting the uniformity and efficiency of heat transfer).

Here, it has been surprisingly found that, with the addition of between 5 wt. % and 20 wt. % of HFO-1233yd(Z), the heat transfer coefficient increases over the reference fluid, at both a normal temperature and a low temperature operating condition, such as illustrated in Tables 8, 9, and 10 below:

TABLE 8
Heat transfer coefficient of Exxon Spectra Syn PAO2 (Oil 1) at
different temperatures with various HFO-1233yd(Z) composition

| | Heat transfer coefficient [%] | | | | |
|---|---|---|---|---|---|
| Temper- | | Oil 1 + | Oil 1 + | Oil 1 + | Oil 1 + |
| ature | | 5% HFO- | 10% HFO- | 15% HFO- | 20% HFO- |
| [° C.] | Oil 1 | 1233yd(Z) | 1233yd(Z) | 1233yd(Z) | 1233yd(Z) |
| 20 | 100% | 105% | 112% | 117% | 123% |
| −20 | 60% | 63% | 70% | 75% | 80% |

TABLE 9
Heat transfer coefficient of Shell GTL E5 TM 410 (Oil 2) at
different temperatures with various HFO-1233yd(Z) composition

| | Heat transfer coefficient [%] | | | | |
|---|---|---|---|---|---|
| Temper- | | Oil 2 + | Oil 2 + | Oil 2 + | Oil 2 + |
| ature | | 5% HFO- | 10% HFO- | 15% HFO- | 20% HFO- |
| [° C.] | Oil 2 | 1233yd(Z) | 1233yd(Z) | 1233yd(Z) | 1233yd(Z) |
| 20 | 100% | 108% | 114% | 124% | 129% |
| −20 | 74% | 75% | 75% | 74% | 77% |

TABLE 10
Heat transfer coefficient of Ampcool AC-110 (Oil 3) at different
temperatures with various HFO-1233yd(Z) composition

| | |
|---|---|
| Temperature | Heat transfer coefficient [%] |

| [° C.] | Oil 3 | Oil 3 + 10% HFO-1233yd(Z) |
|---|---|---|
| 20 | 100% | 114% |
| −20 | 68% | 69% |

Here, the reference base fluid of Oil 1 is based upon a polyolefin oil (i.e., PAO), such as Spectra Syn PAO2, the reference base fluid of oil 2 is based upon a paraffinic oil, such as Shell GTL E5 TM 410, and the reference base fluid of oil 3 is based upon a polyolefin oil (i.e., PAO) such as and AMP COOL AC-110. In each case, the addition of the between 5 wt. % and 20 wt. % HFO-1233yd(Z) increases the heat transfer coefficient, as compared to the base fluid alone.

Specifically, as relating to the PAO Oil 1, the heat transfer coefficient increases by between 5% and 23% (e.g., 105% to 123%, respectively) at the 20° C. operating condition, and by 3% to 20% (e.g., 63% and 80% respectively) at the low operating condition (e.g., −20° C.), as based upon the inclusion of between 5 wt. % and 20 wt. % HFO-1233yd(Z), versus the base oil alone.

Similarly, as relating to the paraffinic oil 2, the heat transfer coefficient increases by between 8% and 29% (e.g., 108% to 129%, respectively) at the 20° C. operating condition, and by 1% to 3% (e.g., 74% and 77% respectively) at the low operating condition (e.g., −20°), as based upon the inclusion of between 5 wt. % and 20 wt. % HFO-1233yd(Z), versus the base oil alone.

Additionally, as relating to the PAO oil 3, the heat transfer coefficient increases by 14% (e.g., 1114%) at the 20° C. operating condition, and by 11% (e.g., 69%) at the low operating condition (e.g., −20°), as based upon the inclusion of 10 wt. % HFO-1233yd(Z), versus the base oil alone.

Therefore, the heat transfer coefficient of the present invention may be as little as about 105% 110%, or 115%, or as high as about 120%, or 125% or between any two values used as endpoints, such as about 105% to about 125%, about 105% to about 120%, or about 110% to 120% for a polyolefin oil (e.g., Spectra Syn PAO2) base composition, as little as about 105%, 110%, or 115%, or as high as about 120%, 125%, or 130%, or between any two values used as endpoints, such as about 105% to about 130%, about 110% to about 130%, or about 120% to about 125% for a paraffinic oil (e.g., Shell GTL E5 TM 410) base composition and/or about 30% for a polyolefin oil (PAO) (e.g., Ampcool AC-110) base composition.

c. Liquid Density:

Another important performance characteristic of a BTMS coolant fluid is liquid density. Liquid density of the coolant composition can be adversely effected by the addition of a refrigerant. Here, refrigerants often have densities significantly higher than the base fluid, that once combined, results in a higher heat transfer liquid density. Higher liquid density can lead to performance determinants, such as higher pumping power. It has been surprisingly found that the addition of the 5 wt. % and 20 wt. % of HFO-1233yd(Z) to the base fluid does not detrimentally impact the overall liquid density of the heat transfer composition, mitigating the impacts to BTMS 100's performance. Tables 8, 9 and 10 below show the effect on liquid density on the resulting heat transfer composition by the addition of the between 5 wt. % and 20 wt. % of HFO-1233yd(Z), calculated as based upon ASTM D4052-22.

TABLE 11
Liquid density of PAO base composition with between 5 wt. %
to 20 wt. % HFO-1233yd(Z).

| | Liquid density [g/cc] | | | | | | | | |
|---|---|---|---|---|---|---|---|---|---|
| | | Oil 1 + | | Oil 1 + | | Oil 1 + | | Oil 1 + | |
| | | 5% | | 10% | | 15% | | 20% | |
| | | HFO- | | HFO- | % | HFO- | % | HFO- | % |
| Tempe | Oil | 1233yd | % Inc. | 1233yd | Inc. | 1233yd | Inc. | 1233yd | Inc. |
| [° C.] | 1 | (Z) | (1) | (Z) | (2) | (Z) | (3) | (Z) | (4) |
| −20 | 0.82 | 0.83 | 1.22 | 0.85 | 3.66 | 0.87 | 6.10 | 0.89 | 8.54 |
| 0 | 0.8 | 0.82 | 2.50 | 0.84 | 5.00 | 0.86 | 7.50 | 0.88 | 10.00 |
| 20 | 0.79 | 0.8 | 1.27 | 0.82 | 3.80 | 0.84 | 6.33 | 0.86 | 8.86 |
| 40 | 0.77 | 0.79 | 2.60 | 0.81 | 5.19 | 0.82 | 6.49 | 0.84 | 9.09 |
| 60 | 0.76 | 0.78 | 2.63 | 0.79 | 3.95 | 0.81 | 6.58 | 0.83 | 9.21 |

TABLE 12
Liquid density of paraffinic oil base composition with between
5 wt. % to 20 wt. % HFO-1233yd(Z).

| | Liquid density [g/cc] | | | | | | | | |
|---|---|---|---|---|---|---|---|---|---|
| | | Oil 2 + | | Oil 2 + | | | | Oil 2 + | |
| | | 5% | | 10% | | Oil 2 + | | 20% | |
| | | HFO- | % | HFO- | % | 15% | % | HFO- | % |
| Temp | | 1233yd | Inc. | 1233yd | Inc. | HFO- | Inc. | 1233yd | Inc. |
| [° C.] | Oil 2 | (Z) | (1) | (Z) | (2) | 1233yd(Z) | (3) | (Z) | (4) |
| −20 | 0.83 | 0.85 | 2.41 | 0.86 | 3.61 | 0.89 | 7.23 | 0.9 | 8.43 |
| 0 | 0.82 | 0.84 | 2.44 | 0.85 | 3.66 | 0.87 | 6.10 | 0.88 | 7.32 |
| 20 | 0.81 | 0.82 | 1.23 | 0.84 | 3.70 | 0.86 | 6.17 | 0.87 | 7.41 |
| 40 | 0.79 | 0.81 | 2.53 | 0.82 | 3.80 | 0.84 | 6.33 | 0.85 | 7.59 |
| 60 | 0.78 | 0.8 | 2.56 | 0.81 | 3.85 | 0.83 | 6.41 | 0.84 | 7.69 |

TABLE 13
Liquid density of PAO base composition with
between 5 wt. % to 20 wt. % HFO-1233yd(Z)

| | Liquid density [g/cc] | | |
|---|---|---|---|
| | | Oil 3 + | |
| | | 10% | |
| Temp | | HFO- | % |
| [° C.] | Oil 3 | 1233yd(Z) | Red. |
| −15 | 0.83 | 0.86 | 3.61 |
| 0 | 0.82 | 0.85 | 3.66 |
| 20 | 0.8 | 0.84 | 5.00 |
| 40 | 0.79 | 0.82 | 3.80 |

Here, the reference base fluid of Oil 1 is based upon a polyolefin oil (i.e., PAO), such as Spectra Syn PAO2, the reference base fluid of oil 2 is based upon a paraffinic oil, such as Shell GTL E5 TM 410, and the reference base fluid of oil 3 is based upon a polyolefin oil (i.e., PAO) such as and AMP COOL AC-110. In each case, the addition of the between 5 wt. % and 20 wt. % of HFO-1233yd(Z) leads to an increase in liquid density ((g/cc). However, in view of the figure of merit of section (e), to be described herein, the increase in liquid density does not result in a lower figure of merit, indicating that the slightly higher liquid density does not detrimentally impact the BTMS performance.

Specifically, as relating to the PAO oil 1, the liquid density increased by between 1.3% and 8.9% at the 20° C. operating condition, and by 1.2% and 8.5% at the low operating condition (e.g., −20° C.), as based upon the inclusion of between 5 wt. % and 20 wt. % HFO-1233yd(Z), versus the base oil alone.

Similarly, as relating to the paraffinic oil 2, the liquid density increased by between 1.2% and 7.4% at the 20° C. operating condition, and by 2.4% and 8.4% at the low operating condition (e.g., −20° C.), as based upon the inclusion of between 5 wt. % and 20 wt. % HFO-1233yd(Z), versus the base oil alone.

Additionally, as relating to the PAO oil 3, the liquid density increased by 5.0% at the 20° C. operating condition, and by 3,6% at the low operating condition (e.g., −15° C.), as based upon the inclusion of 10 wt. % HFO-1233yd(Z), versus the base oil alone.

Therefore, the liquid density change of the present invention may be as little as about 1.2% or 1.3%, or as high as about 8.5%, or 8.9% or between any two values used as endpoints, such as about 1.2% % to about 8.9%, about 1.2% to about 8.5%, or about 1.3% to 8.5% for a polyolefin oil (e.g., Spectra Syn PAO2) base composition, as little as about 1.2% or 2.4%, or as high as about 7.4% or 8.4% %, or between any two values used as endpoints, such as about 1.2% to about 8.4%, about 1.2% to about 7.4%, or about 1.2% to about 7.4% for a paraffinic oil (e.g., Shell GTL E5 TM 410) base composition and/or about 5% for a polyolefin oil (PAO) (e.g., s Ampcool AC-110) base composition.

d. Pumping Power

Another important performance characteristic of a BTMS coolant fluid is pumping power. Pumping power of a base fluid alone is typically relatively high. Here, it has been found that, with the addition of between 5 wt. % and 20 wt. % of HFO-1233yd(Z), the pumping power decreases over the reference base fluid alone, at both normal temperature and low operating temperature conditions, and particularly at the low operating condition, such as illustrated in Tables 11, 12, and 13 below:

TABLE 14
Pumping power of Exxon Spectra Syn PAO2 (Oil 1) at different
temperatures with various HFO-1233yd(Z) composition

| | Pumping power [%] | | | | |
|---|---|---|---|---|---|
| Temper- | | Oil 1 + | Oil 1 + | Oil 1 + | Oil 1 + |
| ature | | 5% HFO- | 10% HFO- | 15% HFO- | 20% HFO- |
| [° C.] | Oil 1 | 1233yd(Z) | 1233yd(Z) | 1233yd(Z) | 1233yd(Z) |
| 20 | 100% | 90% | 92% | 93% | 93% |
| −20 | 205% | 176% | 154% | 145% | 139% |

TABLE 15
Pumping power of Shell GTL E5 TM 410 (Oil 2) at different
temperatures with various HFO-1233yd(Z) composition

| | Pumping power [%] | | | | |
|---|---|---|---|---|---|
| Temper- | | Oil 2 + | Oil 2 + | Oil 2 + | Oil 2 + |
| ature | | 5% HFO- | 10% HFO- | 15% HFO- | 20% HFO- |
| [° C.] | Oil 2 | 1233yd(Z) | 1233yd(Z) | 1233yd(Z) | 1233yd(Z) |
| 20 | 100% | 92% | 93% | 79% | 78% |
| −20 | 331% | 244% | 203% | 156% | 148% |

TABLE 16
Pumping power of Ampcool AC-110 (Oil 3) at different
temperatures with various HFO-1233yd(Z) composition

| | |
|---|---|
| Temperature | Pumping power [%] |

| [° C.] | Oil 3 | Oil 3 + 10% HFO-1233yd(Z) |
|---|---|---|
| 20 | 100% | 84% |
| −20 | 262% | 173% |

Here, the reference base fluid of Oil 1 is based upon a polyolefin oil (i.e., PAO), such as Spectra Syn PAO2, the reference base fluid of oil 2 is based upon a paraffinic oil, such as Shell GTL E5 TM 410, and the reference base fluid of oil 3 is based upon a polyolefin oil (i.e., PAO) such as and AMP COOL AC-110. In each case, the addition of the between 5 wt. % and 20 wt. % HFO-1233yd(Z) decreases the pumping power, as compared to the case base oil alone.

Specifically, as relating to the PAO Oil 1, the pumping power decreases by between 7% and 10% (e.g., 93% and 90% %, respectively) at the 20° C. operating condition, and by 29% to 66% (e.g., 176% and 139% respectively) at the low operating condition (e.g., −20° C.), as based upon the inclusion of between 5 wt. % and 20 wt. % HFO-1233yd(Z), versus the base oil alone.

Similarly, as relating to the paraffinic oil 2, the pumping power decreases by between 8% and 22% (e.g., 92% and 78%, respectively) at the 20° C. operating condition, and by 87% to 183% (e.g., 30% and 148% respectively) at the low operating condition (e.g., −20°), as based upon the inclusion of between 5 wt. % and 20 wt. % HFO-1233yd(Z), versus the base oil alone.

Additionally, as relating to the PAO Oil 3, the pumping power decreased by 16% (e.g., 130%) at the 20° C. operating condition, and by 89% (e.g., 148%) at the low operating condition (e.g., −20°), as based upon the inclusion of 10 wt. % HFO-1233yd(Z), versus the base oil alone.

Therefore, the pumping power of the present invention may decrease by as little as 29% or 51% to as much as 60% or 66%, or between any of the foregoing values used as endpoints, such as 29% to 66%, or at least 25% for a polyolefin oil (e.g., Spectra Syn PAO2) base composition at −20° C., by as little as about 87% or 128%, or as much as 175% or 183%, or between any two values used as endpoints, such as about 87% to about 128%, or at least 25%, for a paraffinic oil (e.g., Shell GTL E5 TM 410) base composition at 20° C., and/or about 89%, or at least 25%, for a polyolefin oil (PAO) (e.g., s Ampcool AC-110) base composition at −20° C.

e. Figure of Merit (FOM)

One measurement of the overall coolant liquids performance as relating to a BTMS is by a Figure of Merit (FOM). A FOM evaluates the coolant fluid's overall BTMS performance, as based upon multiple variables including heat transfer coefficient, pumping power, and liquid density, as described previously. A higher figure of merit indicates superior coolant fluid performance, and particularly, relates to superior cooling performance for single-phase direct immersion cooling system. Here the FOM of the present invention is defined by Formula (1):

$$FOM = \frac{Heat transfer coefficient}{P u mping power \times Density}$$

The FOM of a coolant fluid is evaluated against the FOM of a reference fluid at standard temperature (e.g., ambient temperature, such as 20° C.) to determine if the coolant outperforms the reference coolant fluid. The Figure of Merit calculation incorporates those calefactions and values discussed in sections b, c, and d previously. Here, it has been surprisingly found that, with the addition of between 5 wt. % and 20 wt. % of HFO-1233yd(Z), the figure of merit increases over the reference fluid, at both a normal temperature and a low temperature operating condition, such as illustrated in Tables 17, 18, and 19 below:

TABLE 17
FOM of PAO base composition with between
5 wt. % to 20 wt. % HFO-1233yd(Z).

| | FOM [%] | | | | |
|---|---|---|---|---|---|
| Temper- | | Oil 1 + | Oil 1 + | Oil 1 + | Oil 1 + |
| ature | | 5% HFO- | 10% HFO- | 15% HFO- | 20% HFO- |
| [° C.] | Oil 1 | 1233yd(Z) | 1233yd(Z) | 1233yd(Z) | 1233yd(Z) |
| 20 | 100% | 108% | 117% | 118% | 122% |
| −20 | 28% | 34% | 42% | 46% | 51% |

TABLE 18
FOM of paraffinic oil base composition with
between 5 wt. % to 20 wt. % HFO-1233yd(Z).

| | FOM [%] | | | | |
|---|---|---|---|---|---|
| Temper- | | Oil 2 + | Oil 2 + | Oil 2 + | Oil 2 + |
| ature | | 5% HFO- | 10% HFO- | 15% HFO- | 20% HFO- |
| [° C.] | Oil 2 | 1233yd(Z) | 1233yd(Z) | 1233yd(Z) | 1233yd(Z) |
| 20 | 100% | 115% | 118% | 148% | 153% |
| −20 | 22% | 30% | 35% | 43% | 47% |

TABLE 19
FOM of PAO base composition with between
5 wt. % to 20 wt. % HFO-1233yd(Z)

| | |
|---|---|
| Temperature | Kinematic viscosity [cSt] |

| [° C.] | Oil 3 | Oil 3 + 10% HFO-1233yd(Z) |
|---|---|---|
| 20 | 100% | 130% |
| −20 | 25% | 37% |

Here, the reference base fluid of Oil 1 is based upon a polyolefin oil (i.e., PAO), such as Spectra Syn PAO2, the reference base fluid of oil 2 is based upon a paraffinic oil, such as Shell GTL E5 TM 410, and the reference base fluid of oil 3 is based upon a polyolefin oil (i.e., PAO) such as and AMP COOL AC-110. In each case, the addition of the between 5 wt. % and 20 wt. % HFO-1233yd(Z) increases the FOM, as compared to the base fluid alone.

Specifically, as relating to the PAO Oil 1, the FOM increases by between 8% and 22% (e.g., 108% to 122%, respectively) at the 20° C. operating condition, and by 6% to 23% (e.g., 34% and 51% respectively) at the low operating condition (e.g., −20° C.), as based upon the inclusion of between 5 wt. % and 20 wt. % HFO-1233yd(Z), versus the base oil alone.

Similarly, as relating to the paraffinic oil 2, the FOM increases by between 15% and 53% (e.g., 115% to 153%, respectively) at the 20° C. operating condition, and by 8% to 25% (e.g., 30% and 47% respectively) at the low operating condition (e.g., −20°), as based upon the inclusion of between 5 wt. % and 20 wt. % HFO-1233yd(Z), versus the base oil alone.

Additionally, as relating to the PAO Oil 3, the FOM increases by 30% (e.g., 130%) at the 20° C. operating condition, and by 12% (e.g., 37%) at the low operating condition (e.g., −20°), as based upon the inclusion of 10 wt. % HFO-1233yd(Z), versus the base oil alone.

Therefore, the FOM of the present invention may be as little as about 105% 110%, or 115%, or as high as about 120%, or 125% or between any two values used as endpoints, such as about 105% to about 125%, about 105% to about 120%, or about 110% to 120% for a polyolefin oil (e.g., Spectra Syn PAO2) base composition, as little as about 115%, 125%, or 130%, or as high as about 140%, 150%, or 155%, or between any two values used as endpoints, such as about 115% to about 155%, about 115% to about 130%, or about 115% to about 125% for a paraffinic oil (e.g., Shell GTL E5 TM 410) base composition and/or about 130%, for a polyolefin oil (PAO) (e.g., s Ampcool AC-110) base composition.

f. Pour Point

Another important performance characteristic of a BTMS coolant fluid is pour point. Pour point refers to the lowest temperature at which the coolant liquid remains flowable. A low pour point is beneficial to a BTMS, as it ensures fluids stay flowable at lower temperatures, preventing blockages and enabling reliable operation in cold environments. Here, refrigerants often have relatively high pour points, and therefore, may detrimentally effect the overall BTMS performance of the system under cold operational condition. It has been surprisingly found that, with the addition of between 5 wt. % and 20 wt. % of HFO-1233yd(Z), the pour point is maintained at around −38° C. (±3), which exceeds the pour point performance for other heat transfer compositions. Pour point is determined as based upon ASTM D97-17b (2022).

Tables 20 through 23 below illustrate pour points for a reference oil alone and heat transfer composition including between 5 wt. % and 20 wt. % of HFO-1233yd(Z):

TABLE 20
Pour point of Exxon Spectra Syn PAO2 (Oil
1) with various HFO-1233yd(Z) composition

| Oil 1 and HFO-1233yd(Z) composition | Pour point [° C.] |
|---|---|
| Oil 1 | −66 |
| Oil 1 + 5% HFO-1233yd(Z) | <−38 ± 3 |
| Oil 1 + 10% HFO-1233yd(Z) | <−38 ± 3 |
| Oil 1 + 15% HFO-1233yd(Z) | <−38 ± 3 |
| Oil 1 + 20% HFO-1233yd(Z) | <−38 ± 3 |

TABLE 21
Pour point of Shell GTL E5 TM 410 (Oil 2)
with various HFO-1233yd(Z) composition

| Oil 2 and HFO-1233yd(Z) composition | Pour point [° C.] |
|---|---|
| Oil 2 | −60 |
| Oil 2 + 5% HFO-1233yd(Z) | <−38 ± 3 |
| Oil 2 + 10% HFO-1233yd(Z) | <−38 ± 3 |
| Oil 2 + 15% HFO-1233yd(Z) | <−38 ± 3 |
| Oil 2 + 20% HFO-1233yd(Z) | <−38 ± 3 |

TABLE 22
Boiling point of Ampcool AC-110 (Oil 3)
with various HFO-1233yd(Z) composition

| Oil 3 and HFO-1233yd(Z) composition | Pour point [° C.] |
|---|---|
| Oil 3 | −57 |
| Oil 3 + 5% HFO-1233yd(Z) | <−38 ± 3 |
| Oil 3 + 10% HFO-1233yd(Z) | <−38 ± 3 |
| Oil 3 + 15% HFO-1233yd(Z) | <−38 ± 3 |
| Oil 3 + 20% HFO-1233yd(Z) | <−38 ± 3 |

TABLE 23
Boiling point of BVA RPOE14-15 (Oil 4)
with various HFO-1233yd(Z) composition

| Oil 4 and HFO-1233yd(Z) composition | Pour point [° C.] |
|---|---|
| Oil 4 | −57 |
| Oil 4 + 5% HFO-1233yd(Z) | <−38 ± 3 |
| Oil 4 + 10% HFO-1233yd(Z) | <−38 ± 3 |
| Oil 4 + 15% HFO-1233yd(Z) | <−38 ± 3 |
| Oil 4 + 20% HFO-1233yd(Z) | <−38 ± 3 |

Here, the reference base fluid of Oil 1 is based upon a polyolefin oil (i.e., PAO), such as Spectra Syn PAO2, the reference base fluid of oil 2 is based upon a paraffinic oil, such as Shell GTL E5 TM 410, and the reference base fluid of oil 3 is based upon a polyolefin oil (i.e., PAO) such as and AMP COOL AC-110, and refence base fluid 4 is based upon a polyol ester oil POE such as BVA RPOE14-15 (Oil 4). It has been surprising found that, with the addition of the between 5 wt. % and 20 wt. % HFO-1233yd(Z), the pour point, although did decrease, only decreased to approximately −38° C., indicating that the heat transfer compositions including HFO-1233yd(Z) maintain flowability at low temperatures and are suitable for low temperature BTMS applications.

g. Vapor Pressure (Single-Phase Heat Transfer Composition)

Another important performance characteristic of a BTMS coolant fluid is vapor pressure. As described previously, a lower vapor pressure avoids the swelling and eventual damage that higher operating conditions (e.g., at or above 50° C.) can cause due to the coolant fluid vaporizing and pressurizing the battery compartment. Higher operating conditions can also lead to cavitation of the coolant fluid in the coolant pump, causing damage to the pump and eventual failure.

It has been surprisingly found that the addition of HFO-1233yd(Z) to a base fluid results in an acceptably low vapor pressure under high temperature conditions (e.g., at or above 50° C.), where the heat transfer composition maintains a single-phase during operation (e.g., is regarded as a single-phase heat transfer composition). Specifically, a vapor pressure less than 1 bar may be regarded as acceptably low, and substantially avoids the heat transfer composition from vaporizing, avoiding the cavitation issues associated with the coolant pump/battery sell issues. Such values are shown below in Tables 24 and 25 below, where vapor pressure is determined based upon ASTM D5191-22 (2022):

TABLE 24
Vapor Pressure of PAO base composition with 10
wt. % HFO-1233yd(E) vs. 10 wt. % HFO-1233yd(Z)

Vapor pressure [bar]

| Temperature | Oil 1 + 10% | Oil 1 + 10% |
|---|---|---|
| [° C.] | HFO-1233zd(E) | HFO-1233yd(Z) |
| 30 | 0.58 | 0.24 |
| 53.7 | 1 | 0.40 |
| 90.3 | 1.65 | 1 |

TABLE 25
Vapor Pressure of paraffinic oil and PAO
Oil with between 10 wt. % HFO-1233yd(Z).

Vapor pressure [bar]

| Temperature | Oil 3 + 10% | Oil 2 + 10% |
|---|---|---|
| [° C.] | HFO-1233yd(Z) | HFO-1233yd(Z) |
| 30 | 0.25 | 0.15 |
| 86 | 1 | 0.92 |
| 91 | 1.07 | 1 |

Here, the reference fluid of Oil 1 is based upon a polyolefin oil (i.e., PAO), such as Spectra Syn PAO2, the reference fluid of oil 2 is based upon a paraffinic oil, such as Shell GTL E5 TM 410, and the reference fluid of oil 3 is based upon a polyolefin oil (i.e., PAO) such as AMP COOL AC-110. In each case, the addition of the between 5 wt. % and 20 wt. % HFO-1233yd(Z) increases the FOM, as compared to the base base fluid alone.

Specifically, as relating to the PAO oil 1, the vapor pressure of the 10% HFO-1233yd(Z) was acceptably low at 53.7° C. and 90.3° C. at 0.4 bar and 1 bar respectively, where the 10% HFO-1233zd(E) was unacceptably high (e.g., 1 bar and 1.65 bar respectively). Therefore, with the addition of the 10% HFO-1233yd(Z), the vapor pressure was significantly less than the HFO-1233zd(E). Similarly, the vapor pressure of the PAO oil 2 and 10% HFO-1233yd(Z) was acceptably low at 30° C., 86° C., and 91° C. at 0.15 bar, 0.92 bar, and 1.0 bar respectively, and PAO oil 3 and 10% HFO-1233yd(Z) was acceptably low at 30° C. and 86° C. at 0.25 bar and 1 bar respectively.

Therefore, the vapor pressure of the present invention may be as little as about 0.20 bar, 0.25 bar, or 0.4 bar, to as high as 0.5 bar, 0.8 bar, or 1.0 bar, or between any of the values used as endpoints, such as between 0.2 bar and 1.0 bar, 0.4 bar and 0.8 bar, and 0.3 bar and 0.5 bar an temperature ranges between 30° C. and 90.3° C. for a polyolefin oil (e.g., Spectra Syn PAO2) base composition, as little as about 0.1 bar, 0.25 bar, or 0.4 bar, to as high as 0.5 bar, 0.8 bar, or 1.0 bar, or between any of the values used as endpoints, such as between 0.2 bar and 1.00 bar, 0.4 bar and 0.8 bar, and 0.3 bar and 0.5 bar within a temperature range between 30° C. and 91.0° C. for a paraffinic oil (e.g., Shell GTL E5 TM 410) base composition and/or as little as about 0.20 bar, 0.25 bar, or 0.4 bar, to as high as 0.5 bar, 0.9 bar, or 1.1 bar, or between any of the values used as endpoints, such as between 0.2 bar and 1.1 bar, 0.4 bar and 0.8 bar, and 0.3 bar and 0.5 bar within a temperature range between 3° and 91.0° C. a polyolefin oil (PAO) (e.g., s Ampcool AC-110) base composition.

h. Flash Point

Yet another important performance characteristic of a BTMS coolant fluid is flash point. Flash point refers to the lowest temperature at which a liquid produces enough vapor to ignite when exposed to an ignition source. A high flash point is beneficial to a BTMS as it ensures that the fluid does not ignite and become a fire risk/hazard, which could potentially lead to an explosion and failure of the BTMS. Importantly, some refrigerants have relatively low flash points, making them a fire/explosion risk. Here, it has been surprisingly found that, with the addition of between 5 wt. % and 20 wt. % of HFO-1233yd(Z), the flash point of the heat transfer composition is acceptably high, at or above 100° C., and in some cases at or above 120° C. or 160° C., indicating that such heat transfer compositions including HFO-1233yd(Z) avoid the explosion risks of other heat transfer compositions. Flash point is determined based upon ASTM D3828-16a (2021).

Tables 26 through 32 below illustrate flash points for a reference oil alone and heat transfer composition including between 5 wt. % and 20 wt. % of HFO-1233yd(Z):

TABLE 26
Flash point of Exxon Spectra Syn PAO2 (Oil
1) with various HFO-1233yd(Z) composition

| Oil 1 and HFO-1233yd(Z) composition | Flash point [° C.] |
|---|---|
| Oil 1 | 191 |
| Oil 1 + 5% HFO-1233yd(Z) | >120 |
| Oil 1 + 10% HFO-1233yd(Z) | >120 |
| Oil 1 + 15% HFO-1233yd(Z) | >120 |
| Oil 1 + 20% HFO-1233yd(Z) | >120 |

TABLE 27
Flash point of Shell GTL E5 TM 410 (Oil
2) with various HFO-1233yd(Z) composition

| Oil 2 and HFO-1233yd(Z) composition | Flash point [° C.] |
|---|---|
| Oil 2 | 157 |
| Oil 2 + 5% HFO-1233yd(Z) | >120 |
| Oil 2 + 10% HFO-1233yd(Z) | >120 |
| Oil 2 + 15% HFO-1233yd(Z) | >120 |
| Oil 2 + 20% HFO-1233yd(Z) | >120 |

TABLE 28
Flash point of Ampcool AC-110 (Oil 3)
with various HFO-1233yd(Z) composition

| Oil 3 and HFO-1233yd(Z) composition | Flash point [° C.] |
|---|---|
| Oil 3 | 193 |
| Oil 3 + 5% HFO-1233yd(Z) | >120 |
| Oil 3 + 10% HFO-1233yd(Z) | >120 |
| Oil 3 + 15% HFO-1233yd(Z) | >120 |
| Oil 3 + 20% HFO-1233yd(Z) | >120 |

TABLE 29
Flash point of BVA RPOE14-15 (Oil 4) with
various HFO-1233yd(Z) composition

| Oil 4 and HFO-1233yd(Z) composition | Flash point [° C.] |
|---|---|
| Oil 4 | 240 |
| Oil 4 + 5% HFO-1233yd(Z) | >120 |
| Oil 4 + 10% HFO-1233yd(Z) | >120 |
| Oil 4 + 15% HFO-1233yd(Z) | >120 |
| Oil 4 + 20% HFO-1233yd(Z) | >120 |

TABLE 30
Flash point of Lubrizol EVOGEN TM1070 (Oil
5) with various HFO-1233yd(Z) composition

| Oil 5 and HFO-1233yd(Z) composition | Flash point [° C.] |
|---|---|
| Oil 5 | 78 |
| Oil 5 + 5% HFO-1233yd(Z) | >100 |
| Oil 5 + 10% HFO-1233yd(Z) | >100 |
| Oil 5 + 15% HFO-1233yd(Z) | >100 |
| Oil 5 + 20% HFO-1233yd(Z) | >100 |

TABLE 31
Flash point of Lubrizol EVOGEN TM1100 (Oil
6) with various HFO-1233yd(Z) composition

| Oil 6 and HFO-1233yd(Z) composition | Flash point [° C.] |
|---|---|
| Oil 6 | 100 |
| Oil 6 + 5% HFO-1233yd(Z) | >120 |
| Oil 6 + 10% HFO-1233yd(Z) | >120 |
| Oil 6 + 15% HFO-1233yd(Z) | >120 |
| Oil 6 + 20% HFO-1233yd(Z) | >120 |

TABLE 32
Flash point of Lubrizol EVOGEN TM1150 (Oil
7) with various HFO-1233yd(Z) composition

| Oil 6 and HFO-1233yd(Z) composition | Flash point [° C.] |
|---|---|
| Oil 6 | 160 |
| Oil 7 + 5% HFO-1233yd(Z) | >160 |
| Oil 7 + 10% HFO-1233yd(Z) | >160 |
| Oil 7 + 15% HFO-1233yd(Z) | >160 |
| Oil 7 + 20% HFO-1233yd(Z) | >160 |

Here, the reference base fluid of Oil 1 is based upon a polyolefin oil (i.e., PAO), such as Spectra Syn PAO2, the reference base fluid of oil 2 is based upon a paraffinic oil, such as Shell GTL E5 TM 410, and the reference base fluid of oil 3 is based upon a polyolefin oil (i.e., PAO) such as and AMP COOL AC-110, the refence base oil 4 is based upon a polyol ester oil POE such as BVA RPOE14-15 (Oil 4), the refence base oil 5 is based upon Lubrizol EVOGEN TM1070, the reference base oil 6 is based upon Lubrizol EVOGEN TM1100 and the reference base oil 7 is based upon Lubrizol EVOGEN TM1100. It has been surprising found that, with the addition of the between 5 wt. % and 20 wt. % HFO-1233yd(Z), the flash point, although lower than the reference oil alone, is acceptably high at or above 100° C. 120° C., or 160° C., indicating that the heat transfer compositions including HFO-1233yd(Z) avoids flashing at operational temperatures and are suitable for low temperature BTMS applications.

i. Normal Boiling Point

Another important performance characteristic of a BTMS coolant fluid is normal boiling point. The normal boiling point is the temperature at which a liquid's vapor pressure equals atmospheric pressure (1 atm or 101.3 kPa), causing it to boil under standard conditions. As relating to BTMSs, if the normal boiling point of the working fluid is below 55° C., such as when the circulation pump engages, the vapor pressure of the working fluid will be greater than 1 bar, which can cause cavitation and pump circulation issues.

It has been surprisingly found that the addition of HFO-1233yd(Z) to a base fluid results in an acceptably high boiling points, such as above the 55° C. threshold, and in some cases, above 80° C. as shown below in Tables 33, 34, and 35 below:

TABLE 33
Boiling point of Exxon Spectra Syn PAO2 (Oil
1) with various HFO-1233yd(Z) composition

| Oil 1 and HFO-1233yd(Z) composition | Boiling point [° C.] |
|---|---|
| Oil 1 | 310 |
| Oil 1 + 5% HFO-1233yd(Z) | >101 |
| Oil 1 + 10% HFO-1233yd(Z) | 90.3 |
| Oil 1 + 15% HFO-1233yd(Z) | 77 |
| Oil 1 + 20% HFO-1233yd(Z) | 69 |

TABLE 34
Boiling point of Shell GTL E5 TM 410 (Oil
2) with various HFO-1233yd(Z) composition

| Oil 2 and HFO-1233yd(Z) composition | Boiling point [° C.] |
|---|---|
| Oil 2 | ~300 |
| Oil 2 + 5% HFO-1233yd(Z) | >110 |
| Oil 2 + 10% HFO-1233yd(Z) | 91 |
| Oil 2 + 15% HFO-1233yd(Z) | 69 |

TABLE 35
Boiling point of Ampcool AC-110 (Oil
3) with HFO-1233yd(Z) composition

| Oil 3 and HFO-1233yd(Z) composition | Boiling point [° C.] |
|---|---|
| Oil 3 | >350 |
| Oil 3 + 10% HFO-1233yd(Z) | 86 |

Here, the reference base fluid of Oil 1 is based upon a polyolefin oil (i.e., PAO), such as Spectra Syn PAO2, the reference base fluid of oil 2 is based upon a paraffinic oil, such as Shell GTL E5 TM 410, and the reference base fluid of oil 3 is based upon a polyolefin oil (i.e., PAO) such as and AMP COOL AC-110, and reference base fluid 4 is based upon a polyol ester oil POE such as BVA RPOE14-15 (Oil 4).

It has been surprisingly found that, with the addition of the between 5 wt. % and 20 wt. % HFO-1233yd(Z), the boiling point of the heat transfer composition maintains a boiling point above 55° C., thus avoiding the cavitation/circulation issues described previously, and indicates that the heat transfer composition is particularly suited to BTMS applications.

Specifically, as relating to the PAO oil 1, the boiling point of each of the 5 wt. %, 10 wt. %, 15 wt. %, and 20 wt. % HFO-1233yd(Z) heat transfer compositions is acceptably high, at 101° C., 90° C., 77° C., and 69° C. respectively. Similarly, the boiling point of the heat transfer compositions of oil 2 and each of 5 wt. %, 10 wt. %, and 15 wt. % HFO-1233yd(Z) was also acceptably high at 110° C., 91° C., and 69° C. respectively. Finally, the boiling point of the heat transfer compositions of oil 3 and 10 wt. % HFO-1233yd(Z) was also acceptably high at 86° C.

Therefore, the boiling point of the heat transfer composition of the present invention may be as little as about 69° C., or 77° C., or as high as 90° C. or 101° C., or between any of the foregoing values used as endpoints, such as 69° C. to 101° C. for a polyolefin oil (e.g., Spectra Syn PAO2) base composition, as little as 69° C. or 91° C., or as high as 101° C., or between any of the foregoing values used as endpoints, such as 69° C. to 101° C. for a paraffinic oil (e.g., Shell GTL E5 TM 410) base composition, and/or about 86° C. for a polyolefin oil (PAO) (e.g., s Ampcool AC-110) base composition.

j. Miscibility/Single Liquid Phase

Miscibility of the additive in the coolant is another important consideration of the heat transfer composition, and particularly, for immersion type cooling methods. Here, miscibility of a refrigerant, such as the HFO-1233yd(Z) blend refers to the ability of the additive (e.g., the refrigerant) to mix uniformly within the coolant fluid without separating into distinct phases. In other words, miscibility directly measures if the cheat transfer composition maintains a single liquid phase during operation. This property is important because it affects the overall stability of the BTMS system, where a single liquid phase provides assurance that the fluid will not separate during normal operation.

Here, each the HFO-1233yd(Z) of each heat transfer composition has been found to be acceptably miscible through the full range of heat transfer compositions of HFO-1233yd(Z) concentrations (e.g., (e.g. between 5 wt. % and 20 wt. % HFO-1233yd(Z)) and within each of the base composition of: (1) polyolefin oil (e.g., Spectra Syn PAO2) base composition, (2) a paraffinic oil (e.g., Shell GTL E5 TM 410) base composition, (3) a polyolefin oil (PAO) (e.g., Ampcool AC-110) (4) a blended Oil (e.g., EVOGEN TM1070, EVOGEN TM1100, and EVOGEN TM1150) base composition at temperatures as low as −30° C. or 0° C. to as high as 30° C. to 60° C., or between any of these values used as endpoints, such as −30° C. to 60° C. Miscibility is determined based upon ASHRAE 218-2019. Therefore, the heat transfer composition is stable across the full range of operation conditions and for each base coolant fluid.

k. Non-PFAS

The heat transfer compositions contemplated herein may be regarded as Non-PFAS heat transfer compositions. Specifically, HFO-1233yd(Z) is considered to be PFAS free (also referred to herein as Non-PFAS). PFAS-free, with regards to a heat transfer composition, means that such a composition contains substantially no Per- and Polyfluoroalkyl Substances, which are chemicals known for their persistence in the environment and potential health risks. Being PFAS-free ensures the fluid is more environmentally friendly, avoiding long-term pollution and complying with growing regulatory restrictions on PFAS. More particularly, non-Pfas and/or PFAS free means that the substance contains less than 5 wt. % of PFAS compounds.

Here, HFO-1233yd(Z) is PFAS-free. Therefore, the HFO-1233yd(Z) may be added to a PFAS-free base fluid when forming the heat transfer composition, resulting in a PFAS-free heat transfer composition. For instance, PFAS-free base fluids include PAO polyalphaolefin) oils, PVE (polyvinyl ether) oils, POE (polyol ester) oils, paraffinic oils, mineral oils, PAG (polyalkylene glycol) oils, silicone oils, and the like, and combinations/blends thereof. Therefore, each of foregoing heat transfer compositions described previously are regarded as PFAS-free, since both the HFO-1233yd(Z) and the base fluid are PFAS free, and serve as a green heat transfer composition.

l. Low GWP:

The heat transfer compositions contemplated herein may be regarded as low GWP heat transfer compositions. Specifically, HFO-1233yd(Z) is considered to be low GWP refrigerant, with a GWP of 1, far less than the 150 GWP limit established to be low GWP. When paired with a low GWP base fluid, such as PAO polyalphaolefin) oils, PVE (polyvinyl ether) oils, POE (polyol ester) oils, paraffinic oils, mineral oils, PAG (polyalkylene glycol) oils, silicon oils, and blends thereof, the resulting heat transfer composition has a GWP of less than 150, and therefore, be deemed low GWP. Therefore, heat transfer compositions of the present disclosure are also low GWP.

### EXAMPLES

Each of examples 1-12 were prepared and performed as based upon the described experimental procedures, and with explicit reference to documentation [1]-[3] as follows: [1] Seeton, C. J. (2009). Carbon dioxide-lubricant two-phase flow patterns in small horizontal wetted wall channels: The effects of refrigerant/lubricant thermophysical properties. University of Illinois at Urbana-Champaign; [2] Engineering Sciences Data Unit (1973) Convective Heat Transfer During Crossflow of Fluids Over Plain Tube Banks, ESDU Data Item No. 7303J, London, November; and [3] Thome, J. R. (1983). Book review: heat exchanger design handbook. AIAA Journal, 21(11), 1608-1608, the appropriate sections of which, and as known in the art, are expressly incorporated herein.

### Example 1: Different Oils and their Viscosities

The Kinematic viscosity, as determined by ASTM D7483-21, of various base fluids in the temperature range of range of −20° C. to 60° C. is shown in Table 30.

TABLE 36
Kinematic viscosity of different oils at different temperatures

| | Kinematic viscosity of different oils [cSt] | | | | | | |
|---|---|---|---|---|---|---|---|
| | PAO | Paraffinic | | | | | |
| | Exxon | Shell GTL | | POE | | | |
| | Spectra | E5 | PAO | BVA | Blended | Blended | Blended |
| Temperature | Syn | TM | Ampcool | POE- | EVOGEN | EVOGEN | EVOGEN |
| [° C.] | PAO2 | 410 | AC-110 | 15 | TM1070 | TM1100 | TM1150 |
| −20 | 57 | 174 | 122 | 295 | 6.536 | 9.234 | 49.993 |
| 0 | 19 | 48.2 | 41.1 | 70.5 | | | |
| 20 | 8.8 | 19.1 | 16.1 | 25.4 | | | |
| 40 | 5.0 | 9.8 | 8.1 | 12 | | | |
| 60 | 3.2 | 5.8 | 4.8 | 6.8 | | | |

Kinematic viscosity is measured using a PVT (Pressure/Viscosity/Temperature) test rig consisting of a variable speed pump, oscillating piston liquid viscometers, flow meter, bulk fluid reservoir, pressure transducer, balance, pressure relief containment vessel, and an environmental chamber. The test rig can measure liquid and vapor temperature, pressure, density, viscosity, and mass flow for refrigerant, oils, and mixtures of refrigerant and oil. Further details on the experimental testing can be found in [1].

The high kinematic viscosity of the oils at low temperatures is not considered to be acceptable for battery cooling application, especially when operating at low ambient conditions due to the following reasons.

### Example 2: Miscibility Measurement

Miscibility test setup comprises a thermal chamber, stainless-steel pressure cells for different compositions of refrigerant and oil samples, control cell with a temperature sensor. Miscibility is studied by mixing known concentrations of refrigerant and oil in the stainless-steel pressure cells, which is kept inside a temperature-controlled thermal chamber. The miscibility tests are performed between the temperature range of −30° C. to 60° C. or until a phase separation is observed. Miscibility is determined based upon ASHRAE 218-2019.

Miscibility results of different oils (e.g., oils 1-4) with HFO-1233yd(Z) between −30° C. to 60° C. with varying concentrations of HFO-1233yd(Z) are shown in Tables 37-40. All different types of oils were miscible with up to 20 wt. % HFO-1233yd(Z) between −30° C. to 60° C.

Additionally, each of oils 5, 6, and 7 are tested in accordance with the same procedure, and are miscible across the same −30° C. to 60° C. temperature range and with up to 20 wt. % HFO-1233yd(Z), as shown in tables 41-43.

The complete miscibility of all oils is a highly unexpected but desirable result.

TABLE 37
Miscibility results of Exxon Spectra Syn PAO2 (Oil 1) at different
temperatures with various HFO-1233yd(Z) composition

| | Miscibility results | | | |
|---|---|---|---|---|
| | Oil 1 + | Oil 1 + | Oil 1 + | Oil 1 + |
| Temperature | 5% HFO- | 10% HFO- | 15% HFO- | 20% HFO- |
| [° C.] | 1233yd(Z) | 1233yd(Z) | 1233yd(Z) | 1233yd(Z) |
| −30 | Miscible | Miscible | Miscible | Miscible |
| 0 | Miscible | Miscible | Miscible | Miscible |
| 30 | Miscible | Miscible | Miscible | Miscible |
| 60 | Miscible | Miscible | Miscible | Miscible |

TABLE 38
Miscibility results of Shell GTL E5 TM 410 (Oil 2) at different
temperatures with various HFO-1233yd(Z) composition

| | Miscibility results | | | |
|---|---|---|---|---|
| | Oil 2 + | Oil 2 + | Oil 2 + | Oil 2 + |
| Temperature | 5% HFO- | 10% HFO- | 15% HFO- | 20% HFO- |
| [° C.] | 1233yd(Z) | 1233yd(Z) | 1233yd(Z) | 1233yd(Z) |
| −30 | Miscible | Miscible | Miscible | Miscible |
| 0 | Miscible | Miscible | Miscible | Miscible |
| 30 | Miscible | Miscible | Miscible | Miscible |
| 60 | Miscible | Miscible | Miscible | Miscible |

TABLE 39
Miscibility results of Ampcool AC-110 (Oil 3) at different
temperatures with various HFO-1233yd(Z) composition

| | Miscibility results | | | |
|---|---|---|---|---|
| | Oil 3 + | Oil 3 + | Oil 3 + | Oil 3 + |
| Temperature | 5% HFO- | 10% HFO- | 15% HFO- | 20% HFO- |
| [° C.] | 1233yd(Z) | 1233yd(Z) | 1233yd(Z) | 1233yd(Z) |
| −30 | Miscible | Miscible | Miscible | Miscible |
| 0 | Miscible | Miscible | Miscible | Miscible |
| 30 | Miscible | Miscible | Miscible | Miscible |
| 60 | Miscible | Miscible | Miscible | Miscible |

TABLE 40
Miscibility results of BVA POE-15 (Oil 4) at different
temperatures with various HFO-1233yd(Z) composition

| | Miscibility results | | | |
|---|---|---|---|---|
| | Oil 4 + | Oil 4 + | Oil 4 + | Oil 4 + |
| Temperature | 5% HFO- | 10% HFO- | 15% HFO- | 20% HFO- |
| [° C.] | 1233yd(Z) | 1233yd(Z) | 1233yd(Z) | 1233yd(Z) |
| −30 | Miscible | Miscible | Miscible | Miscible |
| 0 | Miscible | Miscible | Miscible | Miscible |
| 30 | Miscible | Miscible | Miscible | Miscible |
| 60 | Miscible | Miscible | Miscible | Miscible |

TABLE 41
Miscibility results of EVOGEN TM1070 (Oil 5) at different
temperatures with various HFO-1233yd(Z) composition

| | Miscibility results | | | |
|---|---|---|---|---|
| | Oil 5 + | Oil 5 + | Oil 5 + | Oil 5 + |
| Temperature | 5% HFO- | 10% HFO- | 15% HFO- | 20% HFO- |
| [° C.] | 1233yd(Z) | 1233yd(Z) | 1233yd(Z) | 1233yd(Z) |
| −30 | Miscible | Miscible | Miscible | Miscible |
| 0 | Miscible | Miscible | Miscible | Miscible |
| 30 | Miscible | Miscible | Miscible | Miscible |
| 60 | Miscible | Miscible | Miscible | Miscible |

TABLE 42
Miscibility results of EVOGEN TM1100 (Oil-6) at different
temperatures with various HFO-1233yd(Z) composition

| | Miscibility results | | | |
|---|---|---|---|---|
| | Oil 6 + | Oil 6 + | Oil 6 + | Oil 6 + |
| Temperature | 5% HFO- | 10% HFO- | 15% HFO- | 20% HFO- |
| [° C.] | 1233yd(Z) | 1233yd(Z) | 1233yd(Z) | 1233yd(Z) |
| −30 | Miscible | Miscible | Miscible | Miscible |
| 0 | Miscible | Miscible | Miscible | Miscible |
| 30 | Miscible | Miscible | Miscible | Miscible |
| 60 | Miscible | Miscible | Miscible | Miscible |
| 60 | Miscible | Miscible | Miscible | Miscible |

ABLE 43
Miscibility results of EVOGEN TM1150 (Oil-7) at different
temperatures with various HFO-1233yd(Z) composition

| | Miscibility results | | | |
|---|---|---|---|---|
| | Oil 7 + | Oil 7 + | Oil 7 + | Oil 7 + |
| Temperature | 5% HFO- | 10% HFO- | 15% HFO- | 20% HFO- |
| [° C.] | 1233yd(Z) | 1233yd(Z) | 1233yd(Z) | 1233yd(Z) |
| −30 | Miscible | Miscible | Miscible | Miscible |
| 0 | Miscible | Miscible | Miscible | Miscible |
| 30 | Miscible | Miscible | Miscible | Miscible |
| 60 | Miscible | Miscible | Miscible | Miscible |
| 60 | Miscible | Miscible | Miscible | Miscible |

### Example 3: Kinematic Viscosity of Oils and HFO-1233yd(Z) Mixtures

Example 1 was repeated regarding oils 1 through 4, except that the starting composition was essentially base oil with up to 20% HFO-1233yd(Z). Kinematic viscosity was calculated based upon ASTM D7483-21 for each of Oils 1-4 in combination with HFO-1233yd(Z) and are presented in Tables 41, 43, and 45 below. Corresponding kinematic viscosity reduction vs the base oil is shown in each of Tables 42, 44 and 46, respectively.

Additionally, the same procedure is repeated for Oils 5, 6, and 7, and comparative viscosity reductions are shown in tables 47-49 below.

TABLE 44
Kinematic viscosity of Exxon Spectra Syn PAO2 (Oil 1) at different
temperatures with various HFO-1233yd(Z) composition

| | Kinematic viscosity [cSt] | | | |
|---|---|---|---|---|
| | Oil 1 + | Oil 1 + | Oil 1 + | Oil 1 + |
| Temperature | 5% HFO- | 10% HFO- | 15% HFO- | 20% HFO- |
| [° C.] | 1233yd(Z) | 1233yd(Z) | 1233yd(Z) | 1233yd(Z) |
| −20 | 40 | 27.4 | 21.2 | 16.2 |
| 0 | 15.0 | 11.1 | 9.0 | 7.2 |
| 20 | 7.3 | 5.6 | 4.8 | 3.9 |
| 40 | 4.2 | 3.3 | 2.9 | 2.4 |
| 60 | 2.6 | 2.2 | 1.9 | 1.8 |

TABLE 42
Kinematic viscosity reduction of Exxon Spectra Syn
PAO2 (Oil 1) at different temperatures with the
addition of various HFO-1233yd(Z) compositions.

| | | % Reduction in Kinematic viscosity [cSt] | | | |
|---|---|---|---|---|---|
| Temper- | | Oil 1 + | Oil 1 + | Oil 1 + | Oil 1 + |
| ature | Oil 1 | 5% HFO- | 10% HFO- | 15% HFO- | 20% HFO- |
| [° C.] | [cSt] | 1233yd(Z) | 1233yd(Z) | 1233yd(Z) | 1233yd(Z) |
| −20 | 57 | 30 | 52 | 63 | 72 |
| 0 | 19 | 21 | 42 | 53 | 62 |
| 20 | 8.8 | 17 | 36 | 45 | 56 |
| 40 | 5 | 16 | 34 | 42 | 52 |
| 60 | 3.2 | 19 | 31 | 41 | 44 |

TABLE 43
Kinematic viscosity of Shell GTL E5 TM 410 (Oil 2) at different
temperatures with various HFO-1233yd(Z) composition

| | Kinematic viscosity [cSt] | | | |
|---|---|---|---|---|
| | Oil 2 + | Oil 2 + | Oil 2 + | Oil 2 + |
| Temperature | 5% HFO- | 10% HFO- | 15% HFO- | 20% HFO- |
| [° C.] | 1233yd(Z) | 1233yd(Z) | 1233yd(Z) | 1233yd(Z) |
| −20 | 108 | 80 | 50.9 | 41.1 |
| 0 | 32.7 | 26.1 | 18.0 | 15.9 |
| 20 | 14.1 | 11.6 | 8.4 | 7.3 |
| 40 | 7.0 | 6.0 | 4.5 | 3.9 |
| 60 | 3.9 | 3.5 | 2.5 | 2.4 |

TABLE 44
Kinematic viscosity reduction of Shell GTL E5 TM
410 (Oil 2) at different temperatures with the
addition of various HFO-1233yd(Z) compositions.

| | | % Reduction in Kinematic viscosity [cSt] | | | |
|---|---|---|---|---|---|
| Temper- | | Oil 2 + | Oil 2 + | Oil 2 + | Oil 2 + |
| ature | Oil 2 | 5% HFO- | 10% HFO- | 15% HFO- | 20% HFO- |
| [° C.] | [cSt] | 1233yd(Z) | 1233yd(Z) | 1233yd(Z) | 1233yd(Z) |
| −20 | 174 | 38 | 54 | 71 | 76 |
| 0 | 48.2 | 32 | 46 | 63 | 67 |
| 20 | 19.1 | 26 | 39 | 56 | 62 |
| 40 | 9.8 | 29 | 39 | 54 | 60 |
| 60 | 5.8 | 33 | 40 | 57 | 59 |

TABLE 45
Kinematic viscosity of Ampcool AC-110 (Oil 3) at different
temperatures with various HFO-1233yd(Z) composition

| | Kinematic viscosity [cSt] |
|---|---|
| Temperature [° C.] | Oil 3 + 10% HFO-1233yd(Z) |
| −20 | 56.7 |
| 0 | 21.0 |
| 20 | 9.1 |
| 40 | 4.8 |

TABLE 46
Kinematic viscosity reduction of Ampcool AC-110 (Oil 3) at different
temperatures with the addition of 5% HFO-1233yd(Z).

| | | % Reduction in |
|---|---|---|
| | | Kinematic viscosity |
| | | [cSt] |
| Temperature | Oil 3 | Oil 2 + 5% HFO- |
| [° C.] | [cSt] | 1233yd(Z) |
| −20 | 122 | 54 |
| 0 | 41.1 | 49 |
| 20 | 16.1 | 43 |
| 40 | 8.1 | 41 |

TABLE 47
Kinematic viscosity reduction of EVOGEN TM1070 (Oil-5) at −20°
C. with the addition of various HFO-1233yd(Z) compositions.

| | | % Reduction in Kinematic viscosity [cSt] | | | |
|---|---|---|---|---|---|
| Temper- | | Oil 5 + | Oil 5 + | Oil 5 + | Oil 5 + |
| ature | Oil 5 | 5% HFO- | 10% HFO- | 15% HFO- | 20% HFO- |
| [° C.] | [cSt] | 1233yd(Z) | 1233yd(Z) | 1233yd(Z) | 1233yd(Z) |
| −20 | 6.5 | >30 | >30 | >30 | >30 |

TABLE 48
Kinematic viscosity reduction of EVOGEN TM1100 (Oil-6) at −20°
C. with the addition of various HFO-1233yd(Z) compositions.

| | | % Reduction in Kinematic viscosity [cSt] | | | |
|---|---|---|---|---|---|
| Temper- | | Oil 6 + | Oil 6 + | Oil 6 + | Oil 6 + |
| ature | Oil 6 | 5% HFO- | 10% HFO- | 15% HFO- | 20% HFO- |
| [° C.] | [cSt] | 1233yd(Z) | 1233yd(Z) | 1233yd(Z) | 1233yd(Z) |
| −20 | 9.2 | >30 | >30 | >30 | >30 |

TABLE 49
Kinematic viscosity reduction of EVOGEN TM1150 (Oil-7) at −20°
C. with the addition of various HFO-1233yd(Z) compositions.

| | | % Reduction in Kinematic viscosity [cSt] | | | |
|---|---|---|---|---|---|
| Temper- | | Oil 7 + | Oil 7 + | Oil 7 + | Oil 7 + |
| ature | Oil 7 | 5% HFO- | 10% HFO- | 15% HFO- | 20% HFO- |
| [° C.] | [cSt] | 1233yd(Z) | 1233yd(Z) | 1233yd(Z) | 1233yd(Z) |
| −20 | 9.2 | >30 | >30 | >30 | >30 |

The decrease in kinematic viscosity with the addition of HFO-1233yd(Z) for all the different oils especially at low temperatures is unexpected but highly desirable due to the following reasons.

Increase in heat transfer coefficient: The heat transfer coefficient is calculated considering the equal temperature rise of the fluid between the inlet and outlet of the battery bank. The heat transfer coefficient was calculated using the staggered tube flow correlations from [2] at 20° C. and −20° C. for Oil 1 and Oil 1+10% HFO-1233yd(Z). At −20° C., the heat transfer coefficient of Oil 1+10% HFO-1233yd(Z) is higher by 16% when compared to the heat transfer coefficient of Oil 1 at −20° C. At 20° C., the heat transfer coefficient of Oil 1+10% HFO-1233yd(Z) is higher by 12% when compared to the heat transfer coefficient of Oil 1 at 20° C.

Decrease in pumping power: The pumping power is calculated considering the equal temperature rise of the fluid between the inlet and outlet of the battery bank. Pumping power is calculated using the staggered tube flow correlations from [3] at 20° C. and −20° C. for Oil 1 and Oil 1+10% HFO-1233yd(Z). At −20° C., the pumping power required for Oil 1+10% HFO-1233yd(Z) is lower by 25% when compared to the pumping power required for Oil 1 at −20° C. At 20° C., the pumping power required for Oil 1+10% HFO-1233yd(Z) is lower by 8% when compared to the pumping power required for Oil 1 at 20° C.

The increase in heat transfer coefficient improves the thermal management of the battery leading to increased reliability. A smaller pump with lower parasitic power consumption can be used due to a decrease in pumping power requirement, which also benefits the range of the EV.

### Example 4: Liquid Density Measurement when Adding HFO-1233yd(Z)

Example 1 was repeated except that the starting composition was base oil with up to 20% HFO-1233yd(Z). The density was measured using the PVT test rig described in Example 1. Liquid density was calculated based upon ASTM D4052-22. Liquid densities are indicated in tables 38-40 below.

TABLE 50
Liquid density of Exxon Spectra Syn PAO2 (Oil 1) at different
temperatures with various HFO-1233yd(Z) composition

| | Liquid density [g/cc] | | | | |
|---|---|---|---|---|---|
| Temper- | | Oil 1 + | Oil 1 + | Oil 1 + | Oil 1 + |
| ature | | 5% HFO- | 10% HFO- | 15% HFO- | 20% HFO- |
| [° C.] | Oil 1 | 1233yd(Z) | 1233yd(Z) | 1233yd(Z) | 1233yd(Z) |
| −20 | 0.82 | 0.83 | 0.85 | 0.87 | 0.89 |
| 0 | 0.80 | 0.82 | 0.84 | 0.86 | 0.88 |
| 20 | 0.79 | 0.80 | 0.82 | 0.84 | 0.86 |
| 40 | 0.77 | 0.79 | 0.81 | 0.82 | 0.84 |
| 60 | 0.76 | 0.78 | 0.79 | 0.81 | 0.83 |

TABLE 51
Liquid density of Shell GTL E5 TM 410 (Oil 2) at different
temperatures with various HFO-1233yd(Z) composition

| | Liquid density [g/cc] | | | | |
|---|---|---|---|---|---|
| Temper- | | Oil 2 + | Oil 2 + | Oil 2 + | Oil 2 + |
| ature | | 5% HFO- | 10% HFO- | 15% HFO- | 20% HFO- |
| [° C.] | Oil 2 | 1233yd(Z) | 1233yd(Z) | 1233yd(Z) | 1233yd(Z) |
| −20 | 0.83 | 0.85 | 0.86 | 0.89 | 0.90 |
| 0 | 0.82 | 0.84 | 0.85 | 0.87 | 0.88 |
| 20 | 0.81 | 0.82 | 0.84 | 0.86 | 0.87 |
| 40 | 0.79 | 0.81 | 0.82 | 0.84 | 0.85 |
| 60 | 0.78 | 0.80 | 0.81 | 0.83 | 0.84 |

TABLE 52
Liquid density of Ampcool AC-110 (Oil 3) at different
temperatures with various HFO-1233yd(Z) composition

| | |
|---|---|
| Temperature | Liquid density [g/cc] |

| [° C.] | Oil 3 | Oil 3 + 10% HFO-1233yd(Z) |
|---|---|---|
| −15 | 0.83 | 0.86 |
| 0 | 0.82 | 0.85 |
| 20 | 0.80 | 0.84 |
| 40 | 0.79 | 0.82 |

### Example 5: Figure of Merit (FOM) Estimation

To evaluate the performance of a pumped single-phase cooling system, the following Figure of Merit (FOM) was derived. FOM was calculated for different oils with up to 20% HFO-1233yd(Z) and compared with the base oil FOM calculated at 20° C. and shown in Tables 53, 54, and 55. FOM incorporates each of the heat transfer coefficient, pumping power, and liquid density measurement/values as discussed previously.

$$FOM = \frac{Heat transfer coefficient}{P u mping power \times Density}$$

High FOM of the oil with up to 20% HFO-1233yd(Z) at both 20° C. and −20° C. compared to base oil is highly desirable but unexpected.

TABLE 53
FOM of Exxon Spectra Syn PAO2 (Oil 1) at different
temperatures with various HFO-1233yd(Z) composition

| | FOM [%] | | | | |
|---|---|---|---|---|---|
| Temper- | | Oil 1 + | Oil 1 + | Oil 1 + | Oil 1 + |
| ature | | 5% HFO- | 10% HFO- | 15% HFO- | 20% HFO- |
| [° C.] | Oil 1 | 1233yd(Z) | 1233yd(Z) | 1233yd(Z) | 1233yd(Z) |
| 20 | 100% | 108% | 117% | 118% | 122% |
| −20 | 28% | 34% | 42% | 46% | 51% |

TABLE 54
FOM of Shell GTL E5 TM 410 (Oil 2) at different temperatures
with various HFO-1233yd(Z) composition

| | FOM [%] | | | | |
|---|---|---|---|---|---|
| Temper- | | Oil 2 + | Oil 2 + | Oil 2 + | Oil 2 + 20% |
| ature | | 5% HFO- | 10% HFO- | 15% HFO- | HFO- |
| [° C.] | Oil 2 | 1233yd(Z) | 1233yd(Z) | 1233yd(Z) | 1233yd(Z) |
| 20 | 100% | 115% | 118% | 148% | 153% |
| −20 | 22% | 30% | 35% | 43% | 47% |

TABLE 55
FOM of Ampcool AC-110 (Oil 3) at different temperatures
with various HFO-1233yd(Z) composition

| | |
|---|---|
| Temperature | Kinematic viscosity [cSt] |

| [° C.] | Oil 3 | Oil 3 + 10% HFO-1233yd(Z) |
|---|---|---|
| 20 | 100% | 130% |
| −20 | 25% | 37% |

### Example 6: Vapor Pressure of Working Fluid

The vapor pressure of Exxon Spectra Syn PAO2 oil (Oil 1) with 10% HFO-1233zd(E) and Exxon Spectra Syn PAO2 oil (Oil 1) with 10% HFO-1233yd(Z) is shown in Table 44. The vapor pressure of Shell GTL E5 TM 410 (Oil 2) with 10% HFO-1233yd(Z) and Ampcool AC-110 (Oil 3) with 10% HFO-1233yd(Z) is shown in Table 45. Vapor pressure was calculated based upon ASTM D5191-22 (2022).

The oil can easily reach 55° C. under idle conditions. When the pump starts and if the vapor pressure of the working fluid is greater than 1 bar, it can lead to cavitation and pump circulation issues.

Operation with high subcooling is a highly desirable attribute which is possible with Exxon Spectra Syn PAO2 (Oil 1) with 10% HFO-1233yd(Z).

10% HFO-1233yd(Z) in both Shell GTL E5 TM 410 and Ampcool AC-110 oil has a vapor pressure of <1 bar at a temperature up to 80° C., which is a highly desirable but unexpected result.

TABLE 56
Vapor pressure of Exxon Spectra Syn PAO2 oil (Oil 1) with
10% HFO-1233zd(E) and Exxon Spectra Syn PAO2 oil (Oil
1) with 10% HFO-1233yd(Z) at different temperatures

Vapor pressure [bar]

| Temperature | Oil 1 + 10% | Oil 1 + 10% |
|---|---|---|
| [° C.] | HFO-1233zd(E) | HFO-1233yd(Z) |
| 30 | 0.58 | 0.24 |
| 53.7 | 1 | 0.40 |
| 90.3 | 1.65 | 1 |

TABLE 57
Vapor pressure of Shell GTL E5 TM 410 (Oil 2) with
10% HFO-1233yd(Z) and Ampcool AC-110 (Oil 3) with
10% HFO-1233yd(Z) at different temperatures

Vapor pressure [bar]

| Temperature | Oil 2 + 10% | Oil 3 + 10% |
|---|---|---|
| [° C.] | HFO-1233yd(Z) | HFO-1233yd(Z) |
| 30 | 0.25 | 0.15 |
| 86 | 1 | 0.92 |
| 91 | 1.07 | 1 |

### Example 7: Addition of Nano Particles can Improve Heat Transfer Coefficient

The heat transfer coefficient of Exxon Spectra Syn PAO2 (Oil 1), Exxon Spectra Syn PAO2 oil (Oil 1)+2% (by volume) CuO nano particles, Exxon Spectra Syn PAO2 (Oil 1) with 10% HFO-1233yd(Z) and Exxon Spectra Syn PAO2 (Oil 1) with 10% HFO-1233yd(Z)+2% (by volume) CuO nano particles at 20° C. is shown in Table 46. The largest increase in heat transfer coefficient was observed when 10% HFO-1233yd(Z) and 2% (by volume) CuO nano particles were added to Exxon Spectra Syn PAO2 oil (Oil 1). This increase in heat transfer coefficient is highly desirable but unexpected.

TABLE 58
Heat transfer coefficient of Exxon Spectra Syn PAO2 (Oil 1),
Exxon Spectra Syn PAO2 oil (Oil 1) + 2% (by volume)
CuO nano particles, Exxon Spectra Syn PAO2 (Oil 1) with 10%
HFO-1233yd(Z) and Exxon Spectra Syn PAO2 (Oil 1) with 10%
HFO-1233yd(Z) + 2% (by volume) CuO nano particles at 20° C.

| | Heat transfer coefficient [%] | | | |
|---|---|---|---|---|
| | | Oil 1 + | | |
| | | 2% (by | | Oil 1 + 10% HFO- |
| | | volume) | Oil 1 + | 1233yd(Z) + |
| Temperature | | CuO nano | 10% HFO- | 2% (by volume) |
| [° C.] | Oil 1 | particles | 1233yd(Z) | CuO nano particles |
| 20 | 100% | 100% | 112% | 114% |

### Example 8: Heat Transfer Coefficient

The heat transfer coefficient is calculated considering the equal temperature rise of the fluid between the inlet and outlet of the battery bank. The heat transfer coefficient was calculated using the staggered tube flow correlations from [2] at 20° C. and −20° C. for Oil 1 and Oil 1+10% HFO-1233yd(Z). At −20° C., the heat transfer coefficient of Oil 1+10% HFO-1233yd(Z) is higher by 16% when compared to the heat transfer coefficient of Oil 1 at −20° C. At 20° C., the heat transfer coefficient of Oil 1+10% HFO-1233yd(Z) is higher by 12% when compared to the heat transfer coefficient of Oil 1 at 20° C.

The Heat transfer coefficient is estimated considering the same volumetric flow rate, and using a staggered tube flow correlations from [2], at both 20° C. and −20° C., as illustrated in Tables 59-61 below.

As represented below in tables 47, 48, and 49, the heat transfer coefficient with the addition of HFO-1233yd(Z) is at least as high as the base fluid. The increase in heat transfer coefficient improves the thermal management of the battery leading to increased reliability. A smaller pump with lower parasitic power consumption can be used due to a decrease in pumping power requirement, which also benefits the range of the EV.

TABLE 59
Heat transfer coefficient of Exxon Spectra Syn PAO2 (Oil 1) at
different temperatures with various HFO-1233yd(Z) composition

| | Heat transfer coefficient [%] | | | | |
|---|---|---|---|---|---|
| Temper- | | Oil 1 + | Oil 1 + | Oil 1 + | Oil 1 + |
| ature | | 5% HFO- | 10% HFO- | 15% HFO- | 20% HFO- |
| [° C.] | Oil 1 | 1233yd(Z) | 1233yd(Z) | 1233yd(Z) | 1233yd(Z) |
| 20 | 100% | 105% | 112% | 117% | 123% |
| −20 | 60% | 63% | 70% | 75% | 80% |

TABLE 60
Heat transfer coefficient of Shell GTL E5 TM 410 (Oil 2) at
different temperatures with various HFO-1233yd(Z) composition

| | Heat transfer coefficient [%] | | | | |
|---|---|---|---|---|---|
| Temper- | | Oil 2 + | Oil 2 + | Oil 2 + | Oil 2 + |
| ature | | 5% HFO- | 10% HFO- | 15% HFO- | 20% HFO- |
| [° C.] | Oil 2 | 1233yd(Z) | 1233yd(Z) | 1233yd(Z) | 1233yd(Z) |
| 20 | 100% | 108% | 114% | 124% | 129% |
| −20 | 74% | 75% | 75% | 74% | 77% |

TABLE 61
Heat transfer coefficient of Ampcool AC-110 (Oil 3) at different
temperatures with various HFO-1233yd(Z) composition

| | |
|---|---|
| Temperature | Heat transfer coefficient [%] |

| [° C.] | Oil 3 | Oil 3 + 10% HFO-1233yd(Z) |
|---|---|---|
| 20 | 100% | 114% |
| −20 | 68% | 69% |

### Example 9: Pumping Power

Decrease in pumping power: The pumping power is calculated considering the equal temperature rise of the fluid between the inlet and outlet of the battery bank. Pumping power is calculated using the staggered tube flow correlations from [3] at 20° C. and −20° C. for Oil 1 and Oil 1+10% HFO-1233yd(Z). At −20° C., the pumping power required for Oil 1+10% HFO-1233yd(Z) is lower by 25% when compared to the pumping power required for Oil 1 at −20° C. At 20° C., the pumping power required for Oil 1+10% HFO-1233yd(Z) is lower by 8% when compared to the pumping power required for Oil 1 at 20° C.

The pumping power with the addition of HFO-1233yd(Z) is lower compared to the base fluid as shown in tables 62, 63, and 64. This reduction in pumping power is significantly higher at −20° C. than 20° C.

TABLE 62
Pumping power of Exxon Spectra Syn PAO2 (Oil 1) at different
temperatures with various HFO-1233yd(Z) composition

| | Pumping power [%] | | | | |
|---|---|---|---|---|---|
| Temper- | | Oil 1 + | Oil 1 + | Oil 1 + | Oil 1 + |
| ature | | 5% HFO- | 10% HFO- | 15% HFO- | 20% HFO- |
| [° C.] | Oil 1 | 1233yd(Z) | 1233yd(Z) | 1233yd(Z) | 1233yd(Z) |
| 20 | 100% | 90% | 92% | 93% | 93% |
| −20 | 205% | 176% | 154% | 145% | 139% |

TABLE 63
Pumping power of Shell GTL E5 TM 410 (Oil 2) at different
temperatures with various HFO-1233yd(Z) composition

| | Pumping power [%] | | | | |
|---|---|---|---|---|---|
| Temper- | | Oil 2 + | Oil 2 + | Oil 2 + | Oil 2 + |
| ature | | 5% HFO- | 10% HFO- | 15% HFO- | 20% HFO- |
| [° C.] | Oil 2 | 1233yd(Z) | 1233yd(Z) | 1233yd(Z) | 1233yd(Z) |
| 20 | 100% | 92% | 93% | 79% | 78% |
| −20 | 331% | 244% | 203% | 156% | 148% |

TABLE 64
Pumping power of Ampcool AC-110 (Oil 3) at different
temperatures with various HFO-1233yd(Z) composition

| | |
|---|---|
| Temperature | Pumping power [%] |

| [° C.] | Oil 3 | Oil 3 + 10% HFO-1233yd(Z) |
|---|---|---|
| 20 | 100% | 84% |
| −20 | 262% | 173% |

### Example 10: Normal Boiling Point Measurement

Normal Boiling point of Exxon Spectra Syn PAO2 (Oil 1), Shell GTL E5 TM 410 (Oil 2) and Ampcool AC-110 (Oil 3) with HFO-1233yd(Z), are shown in Tables 65, 66, 67, and 68 respectively. Normal boiling point is calculated as based upon ASTM D5191-22 (2022).

Boiling point of Exxon Spectra Syn PAO2 (Oil 1) with HFO-1233zd(E) is shown in Table 56. The oil can easily reach 55° C. under idle conditions. When the pump starts and if the boiling point of the working fluid is below 55° C., the vapor pressure of the working fluid will be greater than 1 bar and it can lead to cavitation and pump circulation issues.

10% HFO-1233yd(Z) in Exxon Spectra Syn PAO2 (Oil 1), Shell GTL E5 TM 410 (Oil 2) and Ampcool AC-110 oil (Oil 3) have a boiling point greater than 80° C., which is a highly desirable but unexpected result.

TABLE 65
Boiling point of Exxon Spectra Syn PAO2 (Oil
1) with various HFO-1233yd(Z) composition

| | Boiling |
|---|---|
| Oil 1 and HFO-1233yd(Z) composition | point [° C.] |
| Oil 1 | 310 |
| Oil 1 + 5% HFO-1233yd(Z) | >101 |
| Oil 1 + 10% HFO-1233yd(Z) | 90.3 |
| Oil 1 + 15% HFO-1233yd(Z) | 77 |
| Oil 1 + 20% HFO-1233yd(Z) | 69 |

TABLE 66
Boiling point of Shell GTL E5 TM 410 (Oil
2) with various HFO-1233yd(Z) composition

| | Boiling |
|---|---|
| Oil 2 and HFO-1233yd(Z) composition | point [° C.] |
| Oil 2 | ~300 |
| Oil 2 + 5% HFO-1233yd(Z) | >110 |
| Oil 2 + 10% HFO-1233yd(Z) | 91 |
| Oil 2 + 15% HFO-1233yd(Z) | 69 |
| Oil 2 + 20% HFO-1233yd(Z) | 50.4 |

TABLE 67
Boiling point of Ampcool AC-110 (Oil
3) with HFO-1233yd(Z) composition

| | Boiling |
|---|---|
| Oil 3 and HFO-1233yd(Z) composition | point [° C.] |
| Oil 3 | >350 |
| Oil 3 + 10% HFO-1233yd(Z) | 86 |

TABLE 68
Boiling point of Exxon Spectra Syn PAO2
(Oil 1) with HFO-1233zd(E) composition

| | Boiling |
|---|---|
| Oil 1 and HFO-1233zd(E) composition | point [° C.] |
| Oil 1 | 310 |
| Oil 1 + 10% HFO-1233zd(E) | 53.7 |

### Example 11: Pour Point Measurement

The pour point of Exxon Spectra Syn PAO2 (Oil 1), Shell GTL E5 TM 410 (Oil 2), Ampcool AC-110 (Oil 3) and BVA RPOE14-15 (Oil 4) with HFO-1233yd(Z) are shown in Tables 69-72, respectively.

5% HFO-1233yd(Z) in Exxon Spectra Syn PAO2 (Oil 1), Shell GTL E5 TM 410 (Oil 2), Ampcool AC-110 (Oil 3) and BVA RPOE14-15 (Oil 4) have a pour point below −38° C., which is a highly desirable but unexpected result.

TABLE 69
Pour point of Exxon Spectra Syn PAO2 (Oil
1) with various HFO-1233yd(Z) composition

| | Pour |
|---|---|
| Oil 1 and HFO-1233yd(Z) composition | point [° C.] |
| Oil 1 | −66 |
| Oil 1 + 5% HFO-1233yd(Z) | <−38 ± 3 |
| Oil 1 + 10% HFO-1233yd(Z) | <−38 ± 3 |
| Oil 1 + 15% HFO-1233yd(Z) | <−38 ± 3 |
| Oil 1 + 20% HFO-1233yd(Z) | <−38 ± 3 |

TABLE 70
Pour point of Shell GTL E5 TM 410 (Oil 2)
with various HFO-1233yd(Z) composition

| | Pour |
|---|---|
| Oil 2 and HFO-1233yd(Z) composition | point [° C.] |
| Oil 2 | −60 |
| Oil 2 + 5% HFO-1233yd(Z) | <−38 ± 3 |
| Oil 2 + 10% HFO-1233yd(Z) | <−38 ± 3 |
| Oil 2 + 15% HFO-1233yd(Z) | <−38 ± 3 |
| Oil 2 + 20% HFO-1233yd(Z) | <−38 ± 3 |

TABLE 71
Boiling point of Ampcool AC-110 (Oil 3)
with various HFO-1233yd(Z) composition

| | Pour |
|---|---|
| Oil 3 and HFO-1233yd(Z) composition | point [° C.] |
| Oil 3 | −57 |
| Oil 3 + 5% HFO-1233yd(Z) | <−38 ± 3 |
| Oil 3 + 10% HFO-1233yd(Z) | <−38 ± 3 |
| Oil 3 + 15% HFO-1233yd(Z) | <−38 ± 3 |
| Oil 3 + 20% HFO-1233yd(Z) | <−38 ± 3 |

TABLE 72
Boiling point of BVA RPOE14-15 (Oil 4)
with various HFO-1233yd(Z) composition

| | Pour |
|---|---|
| Oil 4 and HFO-1233yd(Z) composition | point [° C.] |
| Oil 4 | −57 |
| Oil 4 + 5% HFO-1233yd(Z) | <−38 ± 3 |
| Oil 4 + 10% HFO-1233yd(Z) | <−38 ± 3 |
| Oil 4 + 15% HFO-1233yd(Z) | <−38 ± 3 |
| Oil 4 + 20% HFO-1233yd(Z) | <−38 ± 3 |

### Example 12: Flash Point Measurement

The Flash point of Exxon Spectra Syn PAO2 (Oil 1), Shell GTL E5 TM 410 (Oil 2), Ampcool AC-110 (Oil 3), BVA RPOE14-15 (Oil 4), Lubrizol EVOGEN TM1070 (Oil 5), Lubrizol EVOGEN TM1100 (Oil 6), and Lubrizol EVOGEN TM1110 (Oil 6) with HFO-1233yd(Z) are shown in Tables 72-78, respectively. Flash point is calculated based upon ASTM D3828-16a (2021).

5% HFO-1233yd(Z) in Exxon Spectra Syn PAO2 (Oil 1), Shell GTL E5 TM 410 (Oil 2), Ampcool AC-110 (Oil 3) and BVA RPOE14-15 (Oil 4) have a flash point above 120° C., which is a highly desirable but unexpected result.

TABLE 72
Flash point of Exxon Spectra Syn PAO2
(Oil 1) with various HFO-1233yd(Z)

| | Flash |
|---|---|
| Oil 1 and HFO-1233yd(Z) composition | point [° C.] |
| Oil 1 | 191 |
| Oil 1 + 5% HFO-1233yd(Z) | >120 |
| Oil 1 + 10% HFO-1233yd(Z) | >120 |
| Oil 1 + 15% HFO-1233yd(Z) | >120 |
| Oil 1 + 20% HFO-1233yd(Z) | >120 |

TABLE 73
Flash point of Shell GTL E5 TM 410 (Oil 2) with various HFO-
1233yd(Z) composition Oil 2 and HFO-1233yd(Z) composition

| | Flash |
|---|---|
| Oil 2 and HFO-1233yd(Z) composition | point [° C.] |
| Oil 2 | 157 |
| Oil 2 + 5% HFO-1233yd(Z) | >120 |
| Oil 2 + 10% HFO-1233yd(Z) | >120 |
| Oil 2 + 15% HFO-1233yd(Z) | >120 |
| Oil 2 + 20% HFO-1233yd(Z) | >120 |

TABLE 74
Flash point of Ampcool AC-110 (Oil 3)
with various HFO-1233yd(Z) composition

| | Flash |
|---|---|
| Oil 3 and HFO-1233yd(Z) composition | point [° C.] |
| Oil 3 | 193 |
| Oil 3 + 5% HFO-1233yd(Z) | >120 |
| Oil 3 + 10% HFO-1233yd(Z) | >120 |
| Oil 3 + 15% HFO-1233yd(Z) | >120 |
| Oil 3 + 20% HFO-1233yd(Z) | >120 |

TABLE 75
Flash point of BVA RPOE14-15 (Oil 4) with
various HFO-1233yd(Z) composition

| | Flash |
|---|---|
| Oil 4 and HFO-1233yd(Z) composition | point [° C.] |
| Oil 4 | 240 |
| Oil 4 + 5% HFO-1233yd(Z) | >120 |
| Oil 4 + 10% HFO-1233yd(Z) | >120 |
| Oil 4 + 15% HFO-1233yd(Z) | >120 |
| Oil 4 + 20% HFO-1233yd(Z) | >120 |

TABLE 76
Flash point of Lubrizol EVOGEN TM1070 (Oil
5) with various HFO-1233yd(Z) composition

| | Flash |
|---|---|
| Oil 5 and HFO-1233yd(Z) composition | point [° C.] |
| Oil 5 | 78 |
| Oil 5 + 5% HFO-1233yd(Z) | >100 |
| Oil 5 + 10% HFO-1233yd(Z) | >100 |
| Oil 5 + 15% HFO-1233yd(Z) | >100 |
| Oil 5 + 20% HFO-1233yd(Z) | >100 |

TABLE 77
Flash point of Lubrizol EVOGEN TM1100
(Oil 6) with various HFO-1233yd(Z)

| | Flash |
|---|---|
| Oil 6 and HFO-1233yd(Z) composition | point [° C.] |
| Oil 6 | 100 |
| Oil 6 + 5% HFO-1233yd(Z) | >120 |
| Oil 6 + 10% HFO-1233yd(Z) | >120 |
| Oil 6 + 15% HFO-1233yd(Z) | >120 |
| Oil 6 + 20% HFO-1233yd(Z) | >120 |

TABLE 78
Flash point of Lubrizol EVOGEN TM1150 (Oil
7) with various HFO-1233yd(Z) composition

| | Flash |
|---|---|
| Oil 7 and HFO-1233yd(Z) composition | point [° C.] |
| Oil 7 | 160 |
| Oil 7 + 5% HFO-1233yd(Z) | >160 |
| Oil 7 + 10% HFO-1233yd(Z) | >160 |
| Oil 7 + 15% HFO-1233yd(Z) | >160 |
| Oil 7 + 20% HFO-1233yd(Z) | >160 |

### Example 13: Additional PAO, Ester-Based, and Paraffinic-Based Base Fluids

Various additional specific base fluids of the families identified in Example 1 (i.e., polyalphaolefin (PAO); polyol ester (POE); and 3) Paraffinic), as identified in table 65 below, are prepared including between 5 wt. % and 20 wt. % of cis-1-chloro-2,3,3-trifluoropropene (HFO-1233yd(Z)) to form the heat transfer composition. Each additional heat transfer composition is tested in a tested in accordance with each of Examples 2-12 described previously, and results substantially similar to those identified in Examples 2-12 for each respective family are observed.

TABLE 79
Additional PAO, Ester-based, Paraffinic and Base Fluid Materials

| Polyalphaolefin (PAO) | Ester-based Base fluids | Paraffinic |
|---|---|---|
| Base Fluid | (e.g., Polyol Ester (POE)) | Base Fluid |
| ExxonMobil Data | Cargill Priolube EF | Exxon Isopar L |
| Center Immersion | 3221 | |
| Fluid 3150 (EM DC | | |
| 3150) | | |
| ExxonMobil Data | Chemtura EVEREST | Exxon Isopar M |
| Center Immersion | 10 AW | |
| Fluid 3151 (EM DC | | |
| 3151) | | |
| ExxonMobil Data | Chemtura EVEREST | Exxsol D80 |
| Center Immersion | 15 | |
| Fluid 3152 (EM DC | | |
| 3152) | | |
| Exxon SpectraSyn | Exxon Mobil EAL | Shell Immersion |
| MaX 3.5 | Arctic Series 15 | Cooling Fluid S5 |
| | | X |
| Exxon SpectraSyn 4 | M&I Materials | Shell Immersion |
| | MIVOLT-DF7 | Cooling Fluid S3 |
| | | X |
| Exxon SpectraSyn 5 | | Paratherm LR |
| Exxon SpectraSyn 6 | | |
| Exxon SpectraSyn 8 | | |
| Exxon SpectraSyn 10 | | |
| Chevron Synfluid | | |
| PAO 2 cSt | | |
| Chevron Synfluid | | |
| PAO 4 cSt | | |
| Chevron Synfluid | | |
| PAO 2.5 cSt | | |
| Fuchs Renolin | | |
| FECC 7 | | |
| Fuchs Renolin | | |
| FECC 5 Synth | | |
| INEOS Oligomers | | |
| DuraSyn 162 PAO | | |
| RB Products RB | | |
| PAO 2 cSt | | |
| Polybut + Kemat | | |
| PAO 2 | | |
| Castrol ON EV | | |
| Thermal Fluid | | |
| Lubline LubPAO 2 | | |

### Example 1: Polyvinyl Esters (PVE) Based Base Fluid

Heat transfer composition including a polyvinyl esters (PVE) base fluid, and between 5 wt. % and 20 wt. % of cis-1-chloro-2,3,3-trifluoropropene (HFO-1233yd(Z)) (e.g., 5 wt. %, 10 wt. %, 15 wt. %, 20 wt. %, and 25 wt. %) are prepared. Each of Examples 2-12 are repeated with the heat transfer composition including the polyvinyl esters (PVE) base fluid, and results substantially similar to those identified in Examples 2-12 are observed.

### Example 15: Polyalkylene Glycol (PAG) Based Base Fluid

Heat transfer composition including a polyalkylene glycol (PAG) base fluid and between 5 wt. % and 20 wt. % of cis-1-chloro-2,3,3-trifluoropropene (HFO-1233yd(Z)) (e.g., 5 wt. %, 10 wt. %, 15 wt. %, 20 wt. %, and 25 wt. %) are prepared. Each of Examples 2-12 are repeated with the heat transfer composition including the polyalkylene glycol (PAG) base fluid, and results substantially similar to those identified in Examples 2-12 are observed.

### Example 16: Mineral Oil Based Base Fluid

Heat transfer composition including a mineral oil base fluid and between 5 wt. % and 20 wt. % of cis-1-chloro-2,3,3-trifluoropropene (HFO-1233yd(Z)) (e.g., 5 wt. %, 10 wt. %, 15 wt. %, 20 wt. %, and 25 wt. %) are prepared. Each of Examples 2-12 are repeated with the heat transfer composition including the mineral oil base fluid, and results substantially similar to those identified in Examples 2-12 are observed.

### Example 17: Silicone-based Base Fluid

Heat transfer composition including a silicone-based base fluid, such as DOW DOWSIL ICL-1000 Fluid, and between 5 wt. % and 20 wt. % of cis-1-chloro-2,3,3-trifluoropropene (HFO-1233yd(Z)) (e.g., 5 wt. %, 10 wt. %, 15 wt. %, 20 wt. %, and 25 wt. %) are prepared. Each of Examples 2-12 are repeated with the heat transfer composition including the silicone-based base fluid, and results substantially similar to those identified in Examples 2-12 are observed.

### Example 18: Blended Oil Base Fluid

Heat transfer composition including blended oils, such as EVOGEN TM1070, EVOGEN TM1100, and EVOGEN TM1110, and between 5 wt. % and 20 wt. % of cis-1-chloro-2,3,3-trifluoropropene (HFO-1233yd(Z)) (e.g., 5 wt. %, 10 wt. %, 15 wt. %, 20 wt. %, and 25 wt. %) are prepared. Each of Examples 2-12 are repeated with the heat transfer composition including the blended oil base fluid, and results substantially similar to those identified in Examples 2-12 are observed.

### Example 19: Naphthenic Base Fluid

Heat transfer composition including Naphthenic base fluids, and between 5 wt. % and 20 wt. % of cis-1-chloro-2,3,3-trifluoropropene (HFO-1233yd(Z)) (e.g., 5 wt. %, 10 wt. %, 15 wt. %, 20 wt. %, and 25 wt. %) are prepared. Each of Examples 2-12 are repeated with the heat transfer composition including the blended oil base fluid, and results substantially similar to those identified in Examples 2-12 are observed.

### Example 20: Isoparaffinic Base Fluid

_Heat transfer composition including Isoparaffinic base fluids, and between 5 wt. % and 20 wt. % of cis-1-chloro-2,3,3-trifluoropropene (HFO-1233yd(Z)) (e.g., 5 wt. %, 10 wt. %, 15 wt. %, 20 wt. %, and 25 wt. %) are prepared. Each of Examples 2-12 are repeated with the heat transfer composition including the blended oil base fluid, and results substantially similar to those identified in Examples 2-12 are observed.

### Example 21: Cycloparaffinic Base Fluid

Heat transfer composition including Cycloparaffinic base fluids, and between 5 wt. % and 20 wt. % of cis-1-chloro-2,3,3-trifluoropropene (HFO-1233yd(Z)) (e.g., 5 wt. %, 10 wt. %, 15 wt. %, 20 wt. %, and 25 wt. %) are prepared. Each of Examples 2-12 are repeated with the heat transfer composition including the blended oil base fluid, and results substantially similar to those identified in Examples 2-12 are observed.

### Example 22: Singe Phase (Sensible Heat) Immersion Cooling in Battery Applications Using Each of Base Fluid A1-20; B1-20; C1-20; and D1-20

Batteries of electric vehicles develop heat during operation when charging and discharging. The typical design of vehicle batteries differs between three types: cylindrical cells, pouch cells and prismatic cells. All three types have different considerations in terms of heat transfer due to their shape. Extensive heat generation during charging and discharging of the cells can lead to an increase in temperature that can cause decreasing performance and reduced battery lifetime.

Base fluids A1-20; B1-20; C1-20; and D1-20 preferably have low base constants and high dielectric strength, and are non-flammable fluids which allow for direct cooling of the battery cells that are immersed in each of Base fluid A1-20; B1-20; C1-20; and D1-20.

The present example considers a battery module that consists of 1792 cylindrical battery cells of 18650 type. In one case the battery module is cooled by a 50/50 mixture of water/glycol in a flat tube heat exchanger that is on contact with the battery cells. In the other case the cells are immersed in each of Base fluid A1-20; B1-20; C1-20; and D1-20, as well as the alternative fluids of the additional fluids of Examples 14 through 21 i.e., are in direct contact with the fluid. The waste heat for the battery module is 8750W that is evenly distributed over the total number of cells. The assumptions and operating conditions are listed in Table E3A1 and Table E3A2.

TABLE 80

| | | | Base fluid A1- |
|---|---|---|---|
| | | | 20; B1-20; C1- |
| | | | 20; and D1-20/ |
| | | Water/ | Examples |
| Parameter | Unit | Glycol | 134-21 |
| Battery diameter | [mm] | 18.5 | 18.5 |
| Battery gap | [mm] | 3.8 | 1.5 |
| Battery height | [mm] | 65 | |
| Number of batteries | [—] | 1792 | |
| Battery mass | [g] | 49 | |
| Battery specific heat | [J/kgK] | 830 | |
| Total battery module waste heat | [W] | 8750 | |
| Fluid flow rate | [kg/s] | 0.1 | |
| Initial module temperature | [° C.] | 30 | |
| Fluid inlet temperature | [° C.] | 10 | |
| Cooling channel height | [mm] | 30 | n/a |
| Cooling channel width | [mm] | 2.8 | n/a |
| Heat exchanger flat tube | [mm] | 0.5 | n/a |
| wall thickness | | | |
| Heat exchanger flat tube | [W/mK] | 3 | n/a |
| thermal conductivity | | | |
| Heat exchanger flat tube | [—] | 0.0003 | n/a |
| relative surface roughness | | | |

TABLE 81

| | |
|---|---|
| Minimum cell | Maximum cell |
| temperature [° C.] | temperatures [° C.] |

| | | Base fluid | | Base fluid |
|---|---|---|---|---|
| | Water/ | A1-20; B1- | Water/ | A1-20; B1- |
| | Glycol | 20; C1-20; | Glycol | 20; C1-20; |
| Time | 50/50 | D1-20 | 50/50 | D1-20 |
| 0 | 30.0 | 30.0 | 30.0 | 30.0 |
| 100 | 35.8 | 10-40 | 36.8 | 30-40 |
| 200 | 40.3 | 10-40 | 42.0 | 30-40 |
| 300 | 43.6 | 10-45 | 46.0 | 30-45 |
| 400 | 46.1 | 10-45 | 49.2 | 30-50 |
| 500 | 48.0 | 10-45 | 51.7 | 30-50 |
| 600 | 49.5 | 10-50 | 53.6 | 30-55 |
| 700 | 50.5 | 10-50 | 55.1 | 30-55 |
| 800 | 51.4 | 10-50 | 56.3 | 30-55 |
| 900 | 52.0 | 10-50 | 57.2 | 30-55 |

### Example 23: Heat Transfer Compositions as a Coolant Fluid

BTMS circuits according to each of FIGS. 1 and 2 are constructed. The heat transfer compositions identified in Examples 1-12, as well as the alternative/additional compositions described in relation to Examples 13-121 are tested as heat transfer fluids contained within an EV battery cooling circuit of the battery coolant circuit, such as battery cooling circuit 102 of FIGS. 1 and 2. Each heat transfer composition is found to exhibit the same performance as identified in each of examples 1-12 during normal operation. Therefore, each heat transfer composition identified herein functions as a heat transfer composition in a BTMS system.

### Example 24: Thermal Runaway Prevention

BTMS circuits according to FIGS. 1 and 2 are constructed. The heat transfer compositions identified in Examples 1-12, as well as the alternative/additional compositions described in relation to Examples 13-21 are tested as heat transfer fluids contained within an EV battery cooling circuit of the battery coolant circuit, such as battery cooling circuit 102 of FIGS. 1 and 2. In this case, a thermal runaway scenario is imposed on battery cooling circuit 102, where the EV battery is purposefully overheated (e.g., mimicking a rapid charge scenario). Each of the base fluids of Examples 1-12, as well as the alternative/additional compositions described in relation to Examples 13-17 prevent thermal runaway from occurring, by limiting the maximum temperature of the battery to a point below the thermal runaway temperature threshold. Therefore, each heat transfer composition identified herein functions as a heat transfer composition in a BTMS system to prevent thermal runaway.

### Example 25: Single Phase Electrochemical Cell Cooling Using Each of Base Fluid A1-20; B1-20; C1-20; and D1-20, as Well as Additional Base Fluids

Example 18 is repeated, except the cooling is applied to one or more electrochemical cell(s) using each of Base fluid A1-20; B1-20; C1-20; and D1-20, as well as the alternative/additional compositions described in relation to Examples 13-21. Effective and advantageous cooling is achieved by direct contact comprising at least partial immersion of the electrochemical cell(s) is each of Base fluid A1-20; B1-20; C1-20; and D1-20, as well as the alternative/additional compositions described in relation to Examples 13-21. The electrochemical cell(s) are cooled with each of Base fluid A1-20; B1-20; C1-20; and D1-20; and D1-20, as well as the alternative/additional compositions described in relation to Examples 13-21 which absorb the heat. The electrochemical cell(s) operate effectively, efficiently, safely and reliably while at least partially immersed in each of base fluid A1-20; B1-20; C1-20; and D1-20, as well as the alternative/additional compositions described in relation to Examples 13-2, and the electrochemical cell(s) are kept in the most desired operating temperature while performing its functions.

### Example 26: Single Phase Fuel Cell Cooling Using Each of Base Fluid A1-20; B1-20; C1-20; And D1-20, as Well as Additional Base Fluids

Example 18 is repeated, except the cooling is applied to one or more fuel cell(s) using each of Base fluid A1-20; B1-20; C1-20; and D1-20, as well as the alternative/additional compositions described in relation to Examples 13-21. Effective and advantageous cooling is achieved by direct contact comprising at least partial immersion of the fuel cell(s) is each of Base fluid A1-20; B1-20; C1-20; and D1-20, as well as the alternative/additional compositions described in relation to Examples 13-21. The fuel cell(s) are cooled with each of Base fluid A1-20; B1-20; C1-20; and D1-20, as well as the alternative/additional compositions described in relation to Examples 13-21. which absorb the heat. The fuel cell(s) operate effectively, efficiently, safely and reliably while at least partially immersed in each of base fluid A1-20; B1-20; C1-20; and D1-20, as well as the alternative/additional compositions described in relation to Examples 13-21, and the fuel cell(s) are kept in the most desired operating temperature while performing its functions.

### Example 27: Datacenter Servers and Computing Equipment Cooling

Data center servers and the computing equipment produces significant heat due to their processing power. Data center thermal management is essential for equipment reliability, energy efficiency, preventing data loss, performance optimization, safety, cost, operational efficiency, and minimizing environmental impact. Efficient thermal management ensures that individual electronic components operate within their optimal temperature ranges, also optimizing component-level energy consumption. As component temperatures rise, so does their internal resistance, which can decrease performance or increase the overall power consumption. Undercooling of components can lead to a massive increase in computational energy consumption. Example 18 is repeated except the cooling is applied to data center servers and computing equipment using each of base fluid A1-20; B1-20; C1-20; and D1-20, as well as the alternative/additional compositions described in relation to Examples 13-21. The data center servers and computing equipment operate effectively, efficiently, safely and reliably while at least partially immersed in each of base fluid A1-20; B1-20; C1-20; and D1-20, as well as the alternative/additional compositions described in relation to Examples 13-21, and they are kept in the most desired operating temperature while performing its functions.

### Example 28: High-Performance Computing Cooling

A high-performance computing system can process data and perform complex calculations at high speeds. An example of a high-performance computing system is a supercomputer. This high-performance computing equipment use powerful processors which generate a significant amount of heat, and without effective cooling, these components can overheat, leading to performance degradation, system instability, and even hardware failure. Proper cooling ensures optimal performance and reliability by maintaining stable operating temperatures. Example 18 is repeated except the cooling is applied to high-performance computing equipment using each of base fluid A1-20; B1-20; C1-20; and D1-20 as well as the alternative/additional compositions described in relation to Examples 13-21. The high-performance computing system operates effectively, efficiently, safely and reliably while at least partially immersed in each of base fluid A1-20; B1-20; C1-20; and D1-20, as well as the alternative/additional compositions described in relation to Examples 13-21, and it is kept in the most desired operating temperature while performing its functions.

### Example 29: Cryptocurrency Mining Rig Cooling

A cryptocurrency mining rig is a custom-build PC designed specifically for the process of mining cryptocurrencies like Bitcoin, where it uses powerful graphics processing units (GPUs) to solve complex mathematical equations and verify transactions on the blockchain, earning rewards in the form of cryptocurrency for its efforts. These cryptocurrency mining rigs generate a significant amount of heat due to the intensive computational processes involved. Efficient cooling systems are essential to maintain optimal operating conditions for mining hardware. Improper or insufficient cooling can lead to overheating which in turn causes an increased electricity consumption, lower computational efficiency, and reduced lifespan of the mining rig. Example 18 is repeated except the cooling is applied to high-performance computing equipment using each of base fluid A1-20; B1-20; C1-20; and D1-20, as well as the alternative/additional compositions described in relation to Examples 13-21. The cryptocurrency mining rig operates effectively, efficiently, safely and reliably while at least partially immersed in each of base fluid A1-20; B1-20; C1-20; and D1-20, as well as the alternative/additional compositions described in relation to Examples 13-21, and it is kept in the most desired operating temperature while performing its functions.

### Example 30: Mass Transit Electronics Cooling

Mass transit is a system that moves many people at once, typically within urban areas, using vehicles like buses and trains. Mass transit use several electronics such as communications, audio/visual, power electronics and computing devices. Additionally, they might also be using battery packs to power these electronics and electrical motors. All these equipment including the battery packs and power electronics needs good thermal management to ensure efficient functioning. Example 18 is repeated except the cooling is applied to mass transit electronics as well as the battery packs using each of base fluid A1-20; B1-20; C1-20; and D1-20, as well as the alternative/additional compositions described in relation to Examples 13-21. The mass transit electronics, batteries and power electronics operate effectively, efficiently, safely and reliably while at least partially immersed in each of base fluid A1-20; B1-20; C1-20; and D1-20, as well as the alternative/additional compositions described in relation to Examples 13-21, and they are kept in the most desired operating temperature while performing its functions.

### Example 31: EV Vehicle Electric Motors, Electronic Motor Controllers Cooling

Electric vehicles use electric motors to power the vehicle instead of an internal combustion engine. Common types of electric motors used in electric vehicles include brushless DC motors and permanent magnet synchronous motors. The electric vehicle controller is the electronics package that operates between the batteries and the motor to control the electric vehicle speed and acceleration. Both the electric motors, electronic motor controllers as well as the battery packs used to power the various equipment generate heat during their operation and efficient cooling system is important for their operation. Example 18 is repeated except the cooling is applied to electric vehicles motors, motor controllers and the battery packs using each of base fluid A1-20; B1-20; C1-20; and D1-20, as well as the alternative/additional compositions described in relation to Examples 13-21. The electric vehicles motors, motor controllers and the battery packs operate effectively, efficiently, safely and reliably while at least partially immersed in each of base fluid A1-20; B1-20; C1-20; and D1-20, as well as the alternative/additional compositions described in relation to Examples 13-21, and they are kept in the most desired operating temperature while performing its functions.

### Example 32: Electric Aircraft Electronic Thermal Management

An electric aircraft is an aircraft powered by electricity. Electric aircraft reduce the environmental effects of aviation, providing zero emissions and quieter flights. Electricity may be supplied by a variety of methods, such as batteries, ultracapacitors and fuel cells. Additionally, the electric aircraft have electric motors which drive propellers or turbines. These batteries, ultracapacitors, fuel cells and electric motors generate heat and thus require proper thermal management. Example 18 is repeated except the cooling is applied to electric aircraft electronic, batteries, ultracapacitors, fuel cells and electric motors using each of base fluid A1-20; B1-20; C1-20; and D1-20, as well as the alternative/additional compositions described in relation to Examples 13-21. The electric aircraft electronic, batteries, ultracapacitors, fuel cells and electric motors operate effectively, efficiently, safely and reliably while at least partially immersed in each of base fluid A1-20; B1-20; C1-20; and D1-20 as well as the alternative/additional compositions described in relation to Examples 13-21, and they are kept in the most desired operating temperature while performing its functions.

### Example 33: Light Commercial, Medium and Heavy-Duty Vehicles Thermal Management

Light commercial vehicles are typically used for everyday commercial tasks. Examples include small delivery vans, pickup trucks, and cargo vans. They are ideal for light hauling and urban deliveries. Medium duty trucks are designed for more demanding commercial applications. This category includes larger box trucks, utility trucks, and delivery trucks. They offer greater payload capacity and are accordingly used for more substantial deliveries and vocational purposes. Heavy duty trucks are essential for long-haul transport and handling extremely heavy loads, making them crucial for industries requiring substantial hauling capacity. They include tractor-trailers, dump trucks, and large refuse trucks. All these commercial vehicles can either be powered by an internal combustion engine or electric motors. Additionally, they might also have battery packs to power several electronics and electrical motors. In either case, the electric motors and the battery packs used to power these motors in electric vehicles and the electronics used in internal combustion vehicles generate heat during their operation and proper thermal management is needed for efficient and safe functioning. Example 18 is repeated except the base fluid A1-20; B1-20; C1-20; and D1-20, as well as the alternative/additional compositions described in relation to Examples 13-21 are used for light commercial, medium and heavy-duty vehicles thermal management. The light commercial, medium and heavy-duty vehicles operate effectively, efficiently, safely and reliably when their thermal management system at least partially involves immersion cooling in each of base fluid A1-20; B1-20; C1-20; and D1-20, as well as the alternative/additional compositions described in relation to Examples 13-21.

### Example 34: Offroad, High-Performance and Heavy Construction Vehicle Thermal Management

Off-road vehicles are motorized vehicles designed to travel on unpaved surfaces, such as trails, forest roads, and other low-traction surfaces. A high-performance vehicle is a car that has superior speed, acceleration, handling, and overall driving experience. They are often called performance cars or sports cars. Heavy construction vehicles are heavy-duty machines used to perform construction tasks, such as digging, grading, and transporting materials. All these vehicles can either be powered by an internal combustion engine or electric motors. Additionally, they might also have battery packs to power several electronics and electrical motors. In either case, the electric motors and the battery packs used to power these motors in electric vehicles and the electronics used in internal combustion vehicles generate heat during their operation and proper thermal management is needed for efficient and safe functioning. Example 18 is repeated except the base fluid A1-20; B1-20; C1-20; and D1-20, as well as the alternative/additional compositions described in relation to Examples 13-21 are used for offroad, high-performance and heavy construction vehicle thermal management. The offroad, high-performance and heavy construction vehicles operate effectively, efficiently, safely and reliably when their thermal management system at least partially involves immersion cooling in each of base fluid A1-20; B1-20; C1-20; and D1-20, as well as the alternative/additional compositions described in relation to Examples 13-21.

ASPECTS
Aspect 1 is a heat transfer composition comprising from about 5 wt. % to about 20 wt. % of cis-1-chloro-2,3,3-trifluoropropene (HFO-1233yd(Z)) and from about 80 wt. % to about 95 wt. % of at least one base fluid, as based upon the total weight of the cis-1-chloro-2,3,3-trifluoropropene (HFO-1233yd(Z)) and the base fluid, the heat transfer composition having a kinematic viscosity reduction of at least 30% at −20° C. as compared to the base fluid alone, as determined by D7483-21.
Aspect 2 is a heat transfer composition consisting essentially of from about 5 wt. % to about 20 wt. % of cis-1-chloro-2,3,3-trifluoropropene (HFO-1233yd(Z)) and from about 80 wt. % to about 95 wt. % of at least one base fluid, as based upon the total weight of the cis-1-chloro-2,3,3-trifluoropropene (HFO-1233yd(Z)) and the base fluid, the heat transfer composition having a kinematic viscosity at least 30% less than the base fluid alone, as determined by ASTM D7483-21.
Aspect 3 is a heat transfer composition consisting from about 5 wt. % to about 20 wt. % of cis-1-chloro-2,3,3-trifluoropropene (HFO-1233yd(Z)) and trans-1-chloro-2,3,3-trifluoropropene (HFO-1233yd(E)) and from about 80 wt. % to about 95 wt. % of at least one base fluid, as based upon the total weight of the cis-1-chloro-2,3,3-trifluoropropene (HFO-1233yd(Z)), trans-1-chloro-2,3,3-trifluoropropene (HFO-1233yd(E)), and the base fluid.
Aspect 4 is the heat transfer composition of any one of aspects 1 through 3, wherein the heat transfer composition comprises no more than 5 wt. % of any additional components.
Aspect 5 is the heat transfer composition of any one of aspects 1 through wherein the base fluid has a kinematic viscosity greater than 5 cSt as measured at −20° C., as determined by ASTM D7483-21.
Aspect 6 is the heat transfer composition of any one of aspects 1 through 5, wherein the base fluid comprises a polyalphaolefin (PAO), a paraffinic oil, a polyvinyl ester (PVE), a polyol ester (POE), polyalkylene glycol (PAG), or a mineral oil, or blends thereof.
Aspect 7 is the heat transfer composition of any one of aspects 1 through 6, wherein the heat transfer composition has a kinematic viscosity no less than 30% less than the base fluid alone, as determined by ASTM D7483-21.
Aspect 8 is the heat transfer composition of any one of aspects 1 through 7, wherein the heat transfer composition has a heat transfer coefficient (K) of no less than 3% more than the base fluid alone.
Aspect 9 is the heat transfer composition of any one of aspects 1 through 8, wherein the heat transfer composition has a liquid density of no more than 1% greater than the base fluid alone, as determined by ASTM D4052-22.
Aspect 10 is the heat transfer composition of any one of aspects 1 through 9, wherein the heat transfer composition has a pour point below −38° C., as determined by ASTM D97-17b (2022).
Aspect 11 is the heat transfer composition of any one of aspects 1 through 10, wherein the heat transfer composition has a vapor pressure of no more than 1 bar at 90° C., as determined by ASTM D5191-22 (2022).
Aspect 12 is the heat transfer composition of any one of aspects 1 through 11, wherein the heat transfer composition has a flash point of at least 120° C., as determined by ASTM D3828-16a (2021).
Aspect 13 is the heat transfer composition of any one of aspects 1 through 12, wherein the heat transfer composition has a normal boiling point greater than 80° C., as determined by ASTM D5191-22 (2022).
Aspect 14 is the heat transfer composition of any one of aspects 1 through 13, wherein the heat transfer composition is in a single liquid phase between at a temperature of 90° C. or less, as determined by ASTM D5191-22 (2022).
Aspect 15 is the heat transfer composition of any one of aspects 1 through 14, wherein the cis-1-chloro-2,3,3-trifluoropropene (HFO-1233yd(Z)) is miscible in the base fluid in a temperature range between about −30° C. to about 60° C., as determined by ASHRAE 218-2019.
Aspect 16 is the heat transfer composition of any one of aspects 1 through 15, wherein the heat transfer composition has a pumping power or at least 25% less than the base fluid alone.
Aspect 17 is the heat transfer composition of any one of aspects 1 through 15, wherein the heat transfer composition contains less than 5 wt. % of PFAS compounds.
Aspect 18 is the heat transfer composition of any one of aspects 1 through 17, wherein the heat transfer composition has less than a 150 GWP value.
Aspect 19 is the heat transfer composition of any one of claims 1 through 4, wherein the at least one base fluid comprises a polyalphaolefin (PAO).
Aspect 20 is the heat transfer composition according to aspect 19, wherein the heat transfer composition has a kinematic viscosity at least 30% less than the base fluid alone, as determined by ASTM D7483-21.
Aspect 21 is the heat transfer composition according to either of aspects 19 or 20, wherein the heat transfer composition has a liquid density of no more than 10% greater than the base fluid alone, as determined by ASTM D4052-22.
Aspect 22 is the heat transfer composition according to any one of aspects 19 through 21, wherein the cis-1-chloro-2,3,3-trifluoropropene (HFO-1233yd(Z)) is miscible in the base fluid in a temperature range between about −30° C. to about 60° C., as determined by ASHRAE 218-2019.
Aspect 23 is the heat transfer composition according to any one of aspects 1 through 4, wherein the at least one base fluid comprises a paraffinic oil.
Aspect 24 is the heat transfer composition of aspect 23, wherein the heat transfer composition has a kinematic viscosity at least 25% less than the base fluid alone, as determined by ASTM D7483-21.
Aspect 25 is the heat transfer composition of either one of aspects 24 or 2, wherein the heat transfer composition has a liquid density of no more than 9% greater than the base fluid alone, as determined by ASTM D4052-22.
Aspect 26 is the heat transfer composition of any one of aspects 24 through 25, wherein the cis-1-chloro-2,3,3-trifluoropropene (HFO-1233yd(Z)) is miscible in the base fluid in a temperature range between about −30° C. to about 60° C., as determined by ASHRAE 218-2019.
Aspect 27 is a method of transferring heat in an electric vehicle battery comprising: providing a heat transfer composition according to any one of aspects 1 through 25; immersing the battery in the heat transfer composition; and during operation, transferring heat between the immersed battery and the heat transfer composition.
Aspect 28 is a system for transferring heat from an electric vehicle (EV) comprising a battery coolant circuit and a secondary fluid circuit, the battery coolant circuit circulating a heat transfer composition comprising from about 5 wt. % to about 20 wt. % of cis-1-chloro-2,3,3 trifluoropropene (HFO-1233yd(Z)) and from about 80 wt. % to about 95 wt. % of a base fluid, as based upon the total weight of the cis-1-chloro-2,3,3-trifluoropropene (HFO-1233yd(Z)), wherein the heat transfer composition has a viscosity reduction of at least 30% at −20° C. as compared to the base fluid alone, as determined by D7483-21.
Aspect 29 a system for transferring heat from an electric vehicle (EV) comprising: a battery coolant circuit comprising: an EV battery; a battery coolant pump; a battery coolant heater; an external heat exchanger; a 3-way valve; and a battery coolant cooler, wherein the battery coolant pump circulates a heat transfer fluid though a fluid loop hydraulically coupling each of the EV battery, the battery coolant pump, the battery coolant heater, the external heat exchanger, the 3-way valve, and the batter coolant cooler; the heat transfer fluid comprises a heat transfer composition comprising from about 5 wt. % to about 20 wt. % of cis-1-chloro-2,3,3-trifluoropropene (HFO-1233yd(Z)) and from about 80 wt. % to about 95 wt. % of a base fluid, as based upon the total weight of the cis-1-chloro-2,3,3-trifluoropropene (HFO-1233yd(Z)) and the base fluid; and the heat transfer composition having a viscosity reduction of at least 30% at −20° C. as compared to the base fluid alone, as determined by D7483-21.
Aspect 30 is a system for transferring heat from an electric vehicle (EV) comprising: a primary coolant circuit comprising: an EV battery; a battery coolant pump; a battery coolant heater; a secondary fluid heat exchanger; a 3-way valve; and a battery coolant cooler; and a secondary fluid circuit comprising: an external heat exchanger, and a secondary fluid pump, wherein the battery coolant pump circulates a heat transfer fluid though a fluid loop hydraulically coupling each of the EV battery, the battery coolant pump, the battery coolant heater, a first side of a secondary fluid heat exchanger, the 3-way valve, and the batter coolant cooler; the heat transfer fluid comprises a heat transfer composition comprising from about 5 wt. % to about 20 wt. % of cis-1-chloro-2,3,3-trifluoropropene (HFO-1233yd(Z)) and from about 80 wt. % to about 95 wt. % of a base fluid as based upon the total weight of the cis-1-chloro-2,3,3-trifluoropropene (HFO-1233yd(Z)) and the base fluid; the heat transfer composition having a viscosity reduction of at least 30% at −20° C. as compared to the base fluid alone, as determined by D7483-21; the secondary fluid pump circulates a secondary fluid though a fluid loop hydraulically coupling each of the external heat exchanger, the secondary fluid pump, and a second side of the secondary fluid heat exchanger; and the heat transfer fluid exchanger thermal energy with the secondary fluid within the secondary fluid heat exchanger, physically isolating the primary coolant circuit from the external heat exchanger.
Aspect 31 is the systems of any one of Aspects 27-29, wherein the battery coolant cooler exchanger thermal energy with a vapor compression circuit.
Aspect 32 is the heat transfer composition of any one of Aspects 1 through 1-31, wherein the flash point of the heat transfer composition is at least 100° C., as determined by ASTM D3828-16a (2021).

What is claimed is:

1. A heat transfer composition comprising from about 5 wt. % to about 20 wt. % of cis-1-chloro-2,3,3-trifluoropropene (HFO-1233yd(Z)) and from about 80 wt. % to about 95 wt. % of at least one base fluid, as based upon the total weight of the cis-1-chloro-2,3,3-trifluoropropene (HFO-1233yd(Z)) and the base fluid, the heat transfer composition having a kinematic viscosity at least 30% less than the base fluid alone at −20° C., as determined by ASTM D7483-21.

2. The heat transfer composition of claim 1, consisting essentially of from about 5 wt. % to about 20 wt. % of cis-1-chloro-2,3,3-trifluoropropene (HFO-1233yd(Z)) and from about 80 wt. % to about 95 wt. % of at least one base fluid, as based upon the total weight of the cis-1-chloro-2,3,3-trifluoropropene (HFO-1233yd(Z)) and the base fluid.

3. The heat transfer composition of claim 1, consisting of from about 5 wt. % to about 20 wt. % of cis-1-chloro-2,3,3-trifluoropropene (HFO-1233yd(Z)) and trans-1-chloro-2,3,3-trifluoropropene (HFO-1233yd(E)) and from about 80 wt. % to about 95 wt. % of at least one base fluid, as based upon the total weight of the cis-1-chloro-2,3,3-trifluoropropene (HFO-1233yd(Z)), trans-1-chloro-2,3,3-trifluoropropene (HFO-1233yd(E)), and the base fluid.

4. The heat transfer composition of claim 1, wherein the heat transfer composition further comprises trans-1-chloro-2,3,3-trifluoropropene (HFO-1233yd(E)) from about 1 wt. % to about 10 wt. %, as based upon the cis-1-chloro-2,3,3-trifluoropropene (HFO-1233yd(Z)) and the trans-1-chloro-2,3,3-trifluoropropene (HFO-1233yd(E)).

5. The heat transfer composition of claim 1, wherein the base fluid has a kinematic viscosity greater than 5 cSt at −20° C., as determined by ASTM D7483-21.

6. The heat transfer composition of claim 1, wherein the at least one base fluid comprises a polyalphaolefin (PAO).

7. The heat transfer composition of claim 6, wherein the heat transfer composition has a liquid density of no more than 10% greater than the base fluid alone, as determined by ASTM D4052-22.

8. The heat transfer composition of claim 1, wherein the cis-1-chloro-2,3,3-trifluoropropene (HFO-1233yd(Z)) is miscible in the base fluid in a temperature range between about −30° C. to about 60° C., as determined by ASHRAE 218-2019.

9. The heat transfer composition of claim 1, wherein the at least one base fluid comprises one of a polyalphaolefin (PAO), a paraffinic oil, a polyvinyl ester (PVE), a polyol ester (POE), polyalkylene glycol (PAG), a mineral oil, or a silicone oil, or blends thereof.

10. The heat transfer composition of claim 9, wherein the heat transfer composition has a liquid density of no more than 9% greater than the base fluid alone, as determined by ASTM D4052-22.

11. The heat transfer composition of claim 9, wherein the cis-1-chloro-2,3,3-trifluoropropene (HFO-1233yd(Z)) is miscible in the base fluid in a temperature range between about −30° C. to about 60° C., as determined by ASHRAE 218-2019.

12. The heat transfer composition of claim 1, wherein the heat transfer composition contains less than 5 wt. % of PFAS compounds.

13. The heat transfer composition of claim 1, wherein the heat transfer composition has less than a 150 GWP value.

14. The heat transfer composition of claim 1, wherein the flash point of the heat transfer composition is at least 100° C., as determined by ASTM D3828-16a (2021).
